(19) United States
(12) Patent Application Publication
(10) Pub. No.: US 2014/0180829 A1
(43) Pub. Date: Jun. 26, 2014

(54) Advertising Platform

(71) Applicant: Dennoo Inc., Palo Alto, CA (US)

(72) Inventor: Shigeto Umeda, Palo Alto, CA (US)

(21) Appl. No.: 14/023,376

(22) Filed: Sep. 10, 2013

Related U.S. Application Data
(63) Continuation of application No. PCT/US2013/037018, filed on Apr. 17, 2013.
Application No. PCT/US2013/037018 is a continuation of application No. PCT/US2013/031792, filed on Mar. 14, 2013.
Application No. PCT/US2013/031792 is a continuation of application No. 13/698,037, filed on Feb. 28, 2013.
Application No. 13/698,037 is a continuation of application No. 13/653,394, filed on Oct. 16, 2012.
Application No. 13/653,394 is a continuation of application No. 13/609,146, filed on Sep. 10, 2012.
Application No. 13/609,146 is a continuation of application No. 13/605,915, filed on Sep. 6, 2012.
Application No. 13/605,915 is a continuation of application No. 13/570,831, filed on Aug. 9, 2012.
Application No. 13/570,831 is a continuation of application No. 13/540,538, filed on Jul. 2, 2012.
Application No. 13/540,538 is a continuation of application No. 13/540,528, filed on Jul. 2, 2012.
Application No. 13/540,528 is a continuation of application No. 13/478,020, filed on May 22, 2012.
Application No. 13/478,020 is a continuation of application No. 13/477,981, filed on May 22, 2012.
Application No. 13/540,528 is a continuation-in-part of application No. 13/324,325, filed on Dec. 13, 2011, now Pat. No. 8,694,373.
(60) Provisional application No. 61/785,765, filed on Mar. 14, 2013.
(60) Provisional application No. 61/699,143, filed on Sep. 10, 2012.
(60) Provisional application No. 61/730,456, filed on Nov. 27, 2012.
(60) Provisional application No. 61/708,560, filed on Oct. 1, 2012.
(60) Provisional application No. 61/635,819, filed on Apr. 19, 2012.
(60) Provisional application No. 61/615,834, filed on Mar. 26, 2012.
(60) Provisional application No. 61/600,380, filed on Feb. 17, 2012.
(60) Provisional application No. 61/568,594, filed on Dec. 8, 2011.
(60) Provisional application No. 61/540,164, filed on Sep. 28, 2011.

(30) Foreign Application Priority Data
Sep. 9, 2011 (JP) 2011-197718

(51) Int. Cl. G06Q 30/02

(52) U.S. Cl. CPC G06Q 30/0273
USPC 705/14.69

(57) ABSTRACT

Introduced is a method for presenting online advertisements. In one embodiment, the systems and methods described herein improve efficiency and efficacy of Internet based advertisements. Efficiency is improved by making advertisements relevant to the user, decreasing loss or waste in advertisement space and increasing opportunity for the publisher; and displaying advertisements only for an appropriate duration and charging advertisers according to the user's exposure to the displayed advertisement.

### CROSS-REFERENCE TO RELATED APPLICATION

This application claims the benefit of International Application No. PCT/US13/37018 filed Apr. 17, 2013, entitled “AN ADVERTISEMENT PLATFORM WITH NOVEL COST MODELS”; U.S. patent application Ser. No. 13/698,037 filed Feb. 28, 2013, entitled “ADVERTISEMENT DISPLAY UI AND ADVERTISEMENT SYSTEM”; U.S. patent application Ser. No. 13/653,394 filed Oct. 16, 2012, entitled “METHOD AND SYSTEM FOR SERVING ADVERTISEMENTS BASED ON VISIBILITY OF AD-FRAMES”; U.S. patent application Ser. No. 13/609,146 filed on Sep. 10, 2012, entitled “METHODS AND SYSTEMS FOR BIDDING AND ACQUIRING ADVERTISEMENT IMPRESSIONS”; U.S. patent application Ser. No. 13/605,915 filed on Sep. 6, 2012, entitled “METHODS AND SYSTEMS FOR ACQUIRING ADVERTISEMENT IMPRESSIONS”; U.S. patent application Ser. No. 13/570,831 filed on Aug. 9, 2012, entitled “METHODS AND SYSTEMS FOR TIME-VARIABLE CPS BASED ON USER INTERACTION WITH ADVERTISEMENT”; U.S. patent application Ser. No. 13/540,528 filed on Jul. 2, 2012, entitled “METHODS AND SYSTEMS FOR AN INTEGRATED AD CAMPAIGN IN SOCIAL MEDIA”; U.S. patent application Ser. No. 13/540,538 filed on Jul. 2, 2012, entitled “METHODS AND SYSTEMS FOR TRACKING AD RELEVANCY USING USER INTERACTION”; U.S. patent application Ser. No. 13/477,981 filed on May 22, 2012, entitled “METHODS AND SYSTEMS FOR PROCESSING AND DISPLAYING ADVERTISEMENTS OF VARIABLE LENGTHS”; U.S. patent application Ser. No. 13/478,020 filed on May 22, 2012, entitled “METHODS AND SYSTEMS FOR BIDDING AND DISPLAYING ADVERTISEMENTS UTILIZING VARIOUS COST MODELS”; 61/699,143, filed Sep. 10, 2012, entitled “ADVERTISING PLATFORM”; 61/708,560, filed Oct. 1, 2012, entitled “METHODS AND SYSTEMS FOR MEASURING EFFECTIVENESS OF A USER CLICK TO AN ADVERTISER”; 61/730,456, filed Nov. 27, 2012, entitled “METHODS AND SYSTEMS FOR MEASURING EFFECTIVENESS OF A USER CLICK TO AN ADVERTISER”; 61/785,765, filed Mar. 14, 2013, entitled “SYSTEMS AND METHODS FOR IMPLEMENTING AN ADVERTISEMENT PLATFORM WITH NOVEL COST MODELS”; and all of which are incorporated herein by reference for all purposes in their entirety.

### FIELD

The present invention generally relates to methods and systems for processing and displaying advertisements. Such processing and displaying an advertisement may include, for example, determining ad spots that are visible or at least a substantial portion of the ad spots that are visible for a pre-defined duration, and serving advertisements in those ad spots.

### BACKGROUND

Advertising in the field of e-commerce comprises several different types and modes of advertising, such as, for example, search based advertising, branding advertising, etc. One of two main types of advertising mechanisms or e-commerce based advertisements is the “Direct Response Advertisement,” such as Cost-Per-Click (CPC) in which cost accrues for clicks, or Cost-per-Action (CPA) in which cost accrues in the event of a particular action or conversion. The other major type of e-commerce based advertisement is “branding advertisement” in which cost accrues not based on clicks, actions or effectiveness, but based on the number of “impressions,” usually in lots of one thousand impressions, or Cost-per-Mille (CPM). An online advertisement impression is a single appearance of an advertisement on a web page. Each time an advertisement loads onto a user's screen, the ad server may count that loading as one impression.

Typically, advertisements are purchased and sold on cost per impression basis, regardless on which ad spot/slot/frame the advertisements are displayed to the end user. However, not all ad spots deliver the same impact or effect on advertisement. Some of the ad spots may not even be in the visible area of the web page. For example, an ad spot may be in bottom of the web page, which is outside the initial viewable area and is visible only when the user scrolls down to the bottom of the web page. Such ad impressions may not be effective since the ads may not even be viewed by the users. However, the advertisers are still charged for the impressions delivered. Accordingly, not all the ad impressions return the same return on investment (ROI).

Further, in the world of internet and e-commerce, advertisements may be displayed to the users over and over regardless of whether or not the user feels that an advertisement is interesting, relevant and engaging to them. That is, current advertising systems deliver ads regardless of whether or not they are effective. Such techniques do not fetch a good ROI for the advertiser.

### BRIEF DESCRIPTION OF DRAWINGS

These and other objects, features and characteristics of the present invention will become more apparent to those skilled in the art from a study of the following detailed description in conjunction with the appended claims and drawings, all of which form a part of this specification. In the drawings:

FIG. 1 provides a brief, general description of a representative environment in which the invention can be implemented;

FIG. 2 is a block diagram illustrating an exemplary architecture of a platform server;

FIG. 3 provides a brief, general description of a representative environment in which an embodiment of the invention can be implemented;

FIG. 4A is a block diagram illustrating a system for presenting advertisement spots to an auction;

FIG. 4B provides an illustrative sequence of actions performed by the publisher, the web browser, and the SSP to identify the ad spots that are possibly visible to the user;

FIG. 4C provides an example of a webpage with ad slot that is monitored by zones around the ad slot;

FIG. 4D provides an example of a website being viewed by a user with web browser;

FIG. 5 is a flow diagram of a process for presenting ad spots to an auction;

FIG. 6 is a flow diagram of a process for measuring effectiveness of an ad creative;

FIG. 7 is a block diagram illustrating the measurement of a user's attention to various content areas displayed across a web page;

FIGS. 8A and 8B is a flow chart of a method that can be utilized by the system to measure viewable time for an ad content displayed in a given impression on a given web page;

FIG. 8C provides a flow chart of a method that can utilized to measure Owned Media Viewable Time (OMVT);

FIG. 9A illustrates the various ad ecosystem participants in a general environment the user is interacting with when the user is online;

FIG. 9B illustrates the interaction between the various participants when the pricing models are implemented by the third party ad server;

FIG. 9C illustrates the interaction between the various participants when the pricing models are implemented by the SSP;

FIG. 9D illustrates the interaction between the various participants when the pricing models are implemented by the DSP;

FIGS. 10A, 10B, 10C, and 10D provide a process overview of implementing a multi-ad serving method incorporating viewable time concept;

FIG. 10E a method for measuring a user's mouse rollovers to assess the engagement of the user and charge the advertisers accordingly;

FIG. 10F a method for measuring a user's sound on/off actions to assess the engagement of the user and charge the advertisers accordingly;

FIG. 10G a method for measuring a user's clicks to assess the engagement of the user and charge the advertisers accordingly;

FIG. 10H a method for measuring a user's facebook Likes to assess the engagement of the user and charge the advertisers accordingly;

FIG. 11A shows a process diagram for a use case where one ad is delivered across two pages;

FIG. 11B shows another sequence diagram for a use case where one ad that was delivered in a first ad slot (also referred to as “ad rectangle”) was later served in a second ad slot as the user scrolled away from first ad slot;

FIG. 12A provides a comparison between GRP of TV ad campaign and the eGRP of an online ad campaign;

FIG. 12B provides a general overview of a system that can be used to estimate the eGRP achieved by an ad campaign;

FIG. 12C provides a general overview of a system that can be used to predict an eGRP that can be achieved for a given ad spend;

FIG. 12D provides an illustrative method that can be utilized to estimate eGRP achieved by an ad campaign;

FIG. 12E provides an illustrative method that can be utilized to predict possible eGRP that can achieved for an ad campaign based on a given bid amount;

FIG. 12F provides a method that can be utilized to determine the cost for achieving a desired eGRP for an ad campaign;

FIG. 12G provides examples of computed eGRP based on various parameters described above;

FIG. 13A provides a general environment where the CPXs based bidding can be implemented using an RTB;

FIG. 13B provides a method that can be utilized to implement CPXs (or any other pricing model based bidding) based bidding in a RTB;

FIG. 13C provides a method for converting CPC based bids into CPXs (or CPS) based bids;

FIG. 14 illustrates the probability of obtaining the number of impressions necessary to obtain more than “T” seconds of viewable time; and

FIG. 15 is a high-level block diagram showing an example of the architecture for a computer system.

The headings provided herein are for convenience only and do not necessarily affect the scope or meaning of the claimed invention.

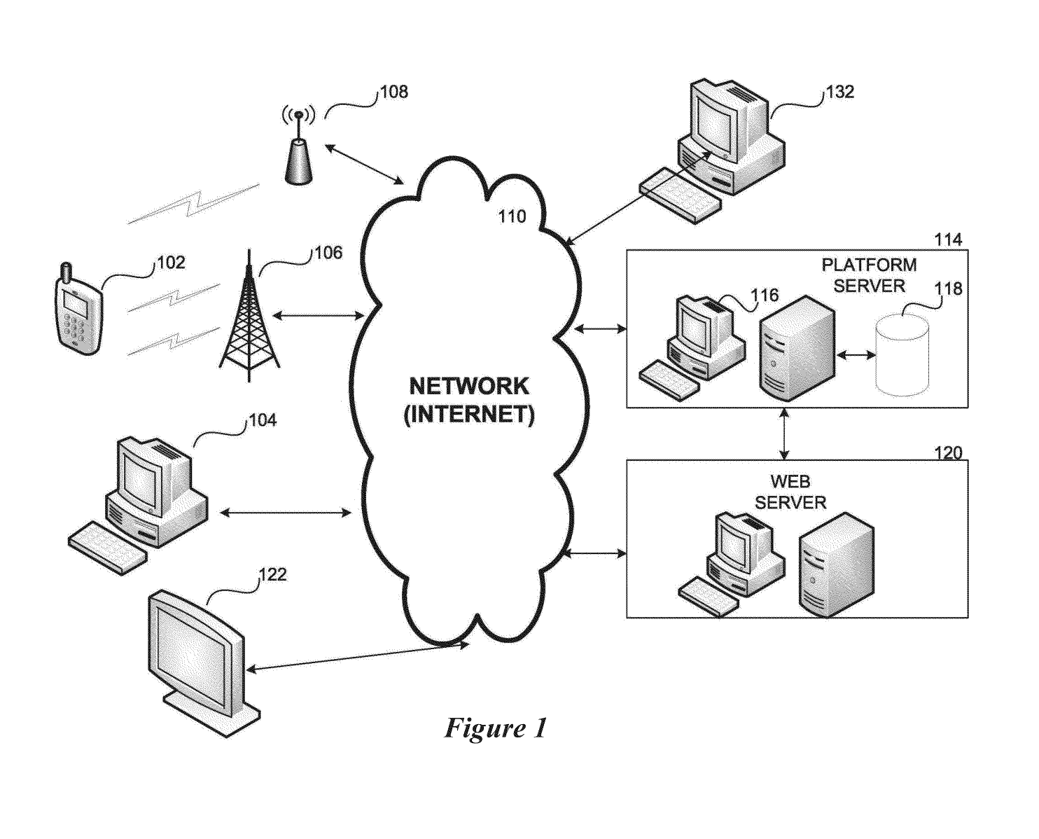

In the drawings, the same reference numbers and any acronyms identify elements or acts with the same or similar structure or functionality for ease of understanding and convenience. To easily identify the discussion of any particular element or act, the most significant digit or digits in a reference number refer to the Figure number in which that element is first introduced (e.g., element 114 is first introduced and discussed with respect to FIG. 1).

### DETAILED DESCRIPTION

Various examples of the invention will now be described. The following description provides specific details for a thorough understanding and enabling description of these examples. One skilled in the relevant art will understand, however, that the invention may be practiced without many of these details. Likewise, one skilled in the relevant art will also understand that the invention can include many other obvious features not described in detail herein. Additionally, some well-known structures or functions may not be shown or described in detail below, so as to avoid unnecessarily obscuring the relevant description.

The terminology used below is to be interpreted in its broadest reasonable manner, even though it is being used in conjunction with a detailed description of certain specific examples of the invention. Indeed, certain terms may even be emphasized below; however, any terminology intended to be interpreted in any restricted manner will be overtly and specifically defined as such in this Detailed Description section. Note that references in this specification to “an embodiment,” “one embodiment,” or the like mean that the particular feature, structure, or characteristic being described is included in at least one embodiment of the present invention. Occurrences of such phrases in this specification do not necessarily all refer to the same embodiment.

FIG. 1 and the following discussion provide a brief, general description of a representative environment in which the invention can be implemented. Although not required, aspects of the invention may be described below in the general context of computer-executable instructions, such as routines executed by a general-purpose data processing device (e.g., a server computer or a personal computer). Those skilled in the relevant art will appreciate that the invention can be practiced with other communications, data processing, or computer system configurations, including: wireless devices, Internet appliances, hand-held devices (including personal digital assistants (PDAs)), wearable computers, all manner of cellular or mobile phones, multi-processor systems, microprocessor-based or programmable consumer electronics, set-top boxes, network PCs, mini-computers, mainframe computers, and the like. Indeed, the terms “computer,” “server,” and the like are used interchangeably herein, and may refer to any of the above devices and systems.

While aspects of the invention, such as certain functions, are described as being performed exclusively on a single device, the invention can also be practiced in distributed environments where functions or modules are shared among disparate processing devices. The disparate processing devices are linked through a communications network, such as a Local Area Network (LAN), Wide Area Network (WAN), or the Internet. In a distributed computing environment, program modules may be located in both local and remote memory storage devices.

Aspects of the invention may be stored or distributed on tangible computer-readable media, including magnetically or optically readable computer discs, hard-wired or preprogrammed chips (e.g., EEPROM semiconductor chips), nanotechnology memory, biological memory, or other data storage media. Alternatively, computer implemented instructions, data structures, screen displays, and other data related to the invention may be distributed over the Internet or over other networks (including wireless networks), on a propagated signal on a propagation medium (e.g., an electromagnetic wave(s), a sound wave, etc.) over a period of time. In some implementations, the data may be provided on any analog or digital network (packet switched, circuit switched, or other scheme).

As shown in FIG. 1, a user may use a personal computing device (e.g., a phone 102, a personal computer 104, etc.) to communicate with a network and/or view displays communicated via the network 110. The term “phone,” as used herein, may be a cell phone, a personal digital assistant (PDA), a portable email device (e.g., a Blackberry®), a portable media player (e.g., an IPod Touch®), or any other device having communication capability to connect to the network. In one example, the phone 102 connects using one or more cellular transceivers or base station antennas 106 (in cellular implementations), access points, terminal adapters, routers or modems 108 (in IP-based telecommunications implementations), or combinations of the foregoing (in converged network embodiments). In some instances, one or more users may also use an electronic display 132 (e.g., an electronic overhead display, an electronic billboard display, etc.) to view information communicated via the network. In the context of this description, information communicated may include, for example, advertisements displayed either by themselves or advertisements displayed in conjunction with web pages or other online media a user may be watching/experiencing. Concepts behind display of such advertisements will be explained in further detail in the following sections.

In some instances, the network 110 is the Internet, allowing the phone 102 (with, for example, WiFi capability), the personal computer 104, or the electronic display 122 to access content offered via various servers (e.g., web server 120) connected via the network. In some instances, especially where the phone 102 is used to access web content through the network 110 (e.g., when a 3G or an LTE service of the phone 102 is used to connect to the network 110), the network 110 may be any type of cellular, IP-based or converged telecommunications network, including but not limited to Global System for Mobile Communications (GSM), Time Division Multiple Access (TDMA), Code Division Multiple Access (CDMA), Orthogonal Frequency Division Multiple Access (OFDM), General Packet Radio Service (GPRS), Enhanced Data GSM Environment (EDGE), Advanced Mobile Phone System (AMPS), Worldwide Interoperability for Microwave Access (WiMAX), Universal Mobile Telecommunications System (UMTS), Evolution-Data Optimized (EVDO), Long Term Evolution (LTE), Ultra Mobile Broadband (UMB), Voice over Internet Protocol (VoIP), Unlicensed Mobile Access (UMA), etc.

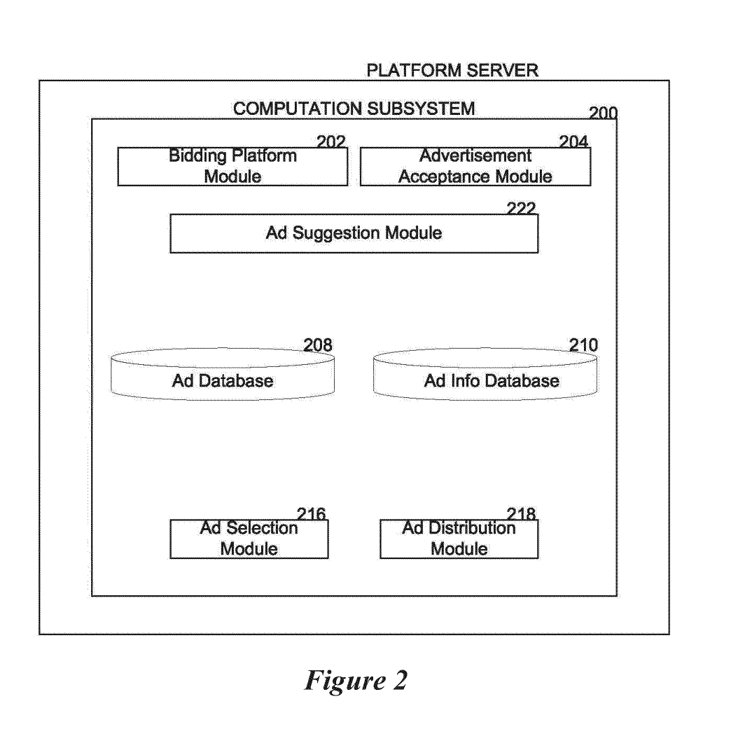

In some instances, a user uses one of the computing devices (e.g., the phone 102, the personal computer 104, etc.) to connect to a platform server 114 through the network 110. In one embodiment, the platform server 114 comprises a server computer 116 coupled to a local database 118. The term “platform server” as indicated herein, refers to an individual or multiple server stations or other computing apparatus. In one embodiment, the platform server is a web server capable of hosting a website and storing content (e.g., various webpages) that is associated with the website. In some embodiments, the platform server is separate from a web server, but communicates with a web server to provide, manage, and/or control content generated by the web server. In general, the platform server 114 includes various modules (either implemented as software or in hardware) that allow for advertising information to be collected from advertisers wishing to strategically engage in an advertising campaign, and to coordinate and relay ensuing advertisements to end systems. In embodiments, the platform server may independently coordinate the processing and eventual display of advertisements. In embodiments, as will be explained in the example of FIG. 2, the platform server may offer interfaces (e.g., APIs) to existing advertising network platforms to coordinate one or more specific advertising activities (e.g., providing abilities for bidding, providing campaign conversion modules, etc.) as will be explained in further detail below. As will also be explained in further detail herein, the administration server 114 incorporates one or more functional units to achieve each of the above discussed functionalities.

As shown in FIG. 1, in some embodiments, the personal computing devices and the administration server 114 are connected through the network 110 to one or more web servers (e.g., web server 120). Each web server corresponds to a computing station that enables a website provider, for example, to provide web content (e.g., web pages) that can be accessed by the personal computing devices through the network 110.

An platform server, as defined herein, could be a separate server offering the service described herein to, for example, one or more website providers. In other examples, the administration server could by itself be a website provider that also runs a service that accomplishes the techniques described herein. Additional examples of implementing an administration server, as understood by a person of ordinary skill in the art, are equally suitable for implementing the techniques described herein.

In the context of the systems described herein, in one embodiment, the platform server is implemented as a search system that enables advertisement display measures, allowing one or more advertisements to be shown either simultaneously or at various discrete timings based on advertisement data obtained through the network (e.g., from an advertising client 132). The platform server 114 may then communicate the advertisement to an advertisement display system (e.g., the user's personal computing device) in which the individual advertisements are shown for a predetermined length of time or according to variables established by the advertising client.

Consider an exemplary scenario where distinct advertisements x1, x2, x3, . . . xp are to be shown to the user as processed and output by the platform server 114. These advertisements are predetermined to be displayed for lengths of t1, t2, t3, . . . tp. However, this does mean that that the advertisement to be shown is also predetermined. For example, if a user browses and views the internet using a PC, various advertisements may be shown for various situations, and the techniques described herein includes the case in which these advertisements are shown and sustained for a predetermined length of time.

An advertisement, as described herein, includes without limitation movies, still images, banners, animated pictures, etc. As processed by the platform server, such advertisements are shown for a period and such periods may be predetermined, for example, by the advertiser. In cases where the advertisement is a movie, either the length of the prepared movie or the play time designated by the advertiser will be the display time for the advertisement. In cases where the advertisement is a still image, the display time will be the time designated by the advertiser.

The “display” of an advertisement refers to display of an advertisement that can be substantial or meaningful. For example, on a web screen, if the user scrolls down on the screen, it is preferable that the advertisement scrolls alongside to fit the screen on which it is displayed. However, if the above method is not possible and the user scrolls the screen to the extent that the advertisement is no longer visible on the screen displayed, the advertisement should be stopped, and the time that the advertisement had been played should be recorded (at least for the purpose of computing cost per second of display of the advertisement, as will be explained further below). When the advertisement returns to display on the screen, the advertisement should be resumed, and the total playing time will be recorded at the end of the advertisement or at the time of the next stop.

The judgment of “whether the advertisement is displayed or not” can, for example, be that if a certain proportion of the advertisement is not shown within the screen, the advertisement can be considered to be “not displayed on the screen”. Here, a “certain proportion” can refer to a proportion at which substantial viewing of the advertisement can be deemed to be difficult, for example at a proportion of 50% or more. However, more than 50% is merely an example, and the proportion need not be limited to 50% or more. For example, the advertisement display can be divided into a major portion (e.g. the portion where the product or service name to be advertised is shown) and a minor portion, and when the major portion is shown on the screen, it may be judged that the advertisement is displayed on the screen.

The techniques discussed herein include a bidding system that allows an advertiser to place a bid for a certain spot and duration of advertisement. As illustrated with respect to FIG. 2, the platform server 114, in some embodiments, may include a bidding platform module 202 to enable the bidding operations. In the way of an example, the bidding platform module may present an appropriate GUI to the advertising client 132 to enable the advertiser to make appropriate selections and provide input. These are then taken in by the bidding platform module 202 for further processing and assessing for bidding.

In situations where the advertiser is aware of the display length beforehand, in embodiments, the advertiser may use bidding as the method of advertisement display time sales (“purchase” from the advertisers' perspective) in order to determine the order of precedence when displaying the advertisement(s). In other words, the amount of advertisement that can be displayed within an advertising space is generally finite. In addition, for web screens, if there is more than one advertisement that can be shown on the same advertisement space, the order in which the advertisements are placed becomes important. Specifically, when displaying advertisements on a specific advertisement space or for specific keywords, an input is made (e.g., in the form of a bid) for the maximum cost/price that the advertiser can bear for that particular combination of duration and order. It is evident that the order or precedence will be higher when this cost/price is higher.

### Cost Per Second (CPS) Based Technology

In at least some embodiments as disclosed herein, the length of time that an advertisement will be shown will vary not only according to the advertisement itself, but also according to secondary factors (e.g., keywords, search relevance, etc.). For example, when publishing an advertisement on a search result page, conventionally, bids are placed for a certain keyword A, and the advertisement to be displayed with higher priority is determined and fixed according to this price. On the other hand, for this invention, comparisons are not made according to the price per display (or impression) of an advertisement, but by the bid on the price per unit of time, or Cost per Second (CPS). Bids can be placed directly through CPS, or the cost per advertisement can be used as the unit of bid, and divided by the number of seconds of advertisement display in order to calculate the CPS to compare prices between various advertisements.

For example, assume that there exist two advertisement spaces (F1 and F2) on a search result page for a certain keyword A, and that the advertisement effect of advertisement space F1 excels that of advertisement space F2. If advertiser D1 bids for price P1, advertiser D2 bids for price P2, advertiser D3 bids for price P3 and P1>P2>P3, conventionally, advertiser D1 won advertisement space F1, advertiser D2 won advertisement space F2 and advertiser D3 could not win an advertisement space. As a result, the publisher/media can only utilize two advertisement spaces (and lose revenue from advertiser D3), and advertiser D3 would lose the opportunity to advertise.

However, using technology introduced herein, for example, the publisher/media can sell the two advertisement spaces (F1 and F2) separately at the time of the bid. For example, for advertisement space F1, advertiser D1 bids for a CPS price P1, advertiser D2 bids for a CPS price P2, advertiser D3 bids for a CPS price P3 and P1>P2>P3, the advertisement display time for F1 can be sold to advertiser D1, advertiser D2 and advertiser D3 in the respective order.

Additionally, if the total time that the advertisements are played for each advertisers D1, D2 and D3 are T1, T2 and T3, respectively, in simple terms, the publisher/media receives an advertising revenue of P1×T1+P2×T2+P3×T3 (in reality, if the displayable time exceeds T1+T2+T3, the order of priority will be determined as D1>D2>D3. Additionally, the order of priority can be changed according to other factors such as the time in the day, etc.). As a result, the publisher/media can utilize their advertisement space with higher efficiency, and each advertiser will be able to display advertisements with higher efficacy. In other words, if each advertisers' advertisement (assuming that each had one type of advertisement) has a display length of t1, t2 and t3 per advertisement, each advertiser will be able to publish T1/t1, T2/t2 and T3/t3 advertisements respectively (assuming that there is no upper limit to the display time). For the user, the amount of information received would be greater than the conventional cases in which one advertisement is shown repeatedly. However, it should be noted that the above example is a highly simplified version. Alternately, a better system may be one that incorporates a display method in which the price determination method is consistent with that in the conventional market.

As offered by the CPS technology introduced herein, the advertisement billing is based on CPS×Seconds Displayed. In embodiments, the cost charged to the advertiser is based on the actual display time. This is because the purchase of the advertisement space is not for an entire unit based of a single display, but for the price/cost per second of an advertisement that will be shown only for a certain time length. The “actual display time” should ideally be the “time that the user is actually watching.” The actual display time may be measured using techniques as understood by people of ordinary skill in the art at the time of this application. However, in systems where constraints are present due to, for example, cost and facilities, the realistic time measurement used can be the “time that the advertisement is shown on the screen”. In other words, the advertisement display time will be measured as the “period in which the advertisement is displayed on the screen”.

Illustration of Ecosystem Utilizing CPS Scheme within Conventional Market

The following section discloses the CPS based advertising platform, where various types of bidding schemes, including bidding schemes based on conventional parameters may be accepted and conversion schema applied to allow for interoperability. When the advertiser is bidding by CPM, the system disclosed herein converts this bid into CPS. In conventional systems, if an advertiser bids by CPM, the price per 1000 page views was constant regardless of the number of clicks. In the system devised by this invention, advertisement slots are not sold by page views (PVs). In the CPS methodology, the entire user session becomes a single unit ad slot, dissected finely into seconds. Sessions are tailored to the exact needs of advertisers. Page views no longer matter, and the flexibility, efficiency and effectiveness of advertisements improve significantly. When using advertisements of variable lengths such as those devised by the techniques described herein, the switching of advertisements are based not on page transition but on time.

Media publishers generally request ad placement requests through Ad networks. In the conventional internet ad market, the ad slot inventory is sold in units of page views, where the advertisers, for e.g., pay eCPM per page view. In order to enable CPS based advertisement platform to work with the conventional platform, the page view market needs to be converted to sessions. In this embodiment, the session length is estimated based on previously achieved average viewable time (AVT) for a given ad inventory. By placing monitoring tags in each of the publisher's media, the Ad network and in turn a DSP (or any other participants of the ad ecosystem) can monitor both the number of page views and a total user engagement time measured for previously placed ads to compute the AVT.

Here, AVT, or the average viewable time is defined as the sum of all ad view lengths (AVL) on the media (i.e. total user engagement time measured for previously placed ads on the media) divided by the total number of page views (PV) on the media. The equation for AVT measurement is below in eq. 31:

$$AVT = \frac{\sum AVL}{PV} \qquad ( 31 )$$

Based on the above equations, eCPS may also be written as shown below in eq. 32:

$$eCPS = eCPM \times \frac{AVL}{AAL} \qquad ( 32 )$$

With the above equations, accordingly, eCPM value may then be converted to an eCPS value. As described above, based on the AVT, DSP can now compute the eCPS for the media requesting ad placement. Using the conventional eCPM valuation and the DSP computed eCPS ad valuation, DSP can identify media publishers who are undervalued in the current ad market. Media publishers who have a lower eCPM than eCPS can thus expect better valuation by treating ad slots as CPS based sessions instead of conventional page views based scheme.

Accordingly, in embodiments, advertisements are shown for a certain periods of time. In other words, the advertisements displayed will have a designated order or priority, and more than one advertisement may be shown continuously in a loop. The order, precedence, and length of running such advertisements may be based on a variety of factors. Such factors may be accounted for, for example, through the bidding platform offered in conjunction with the platform server. An example of such a factor may be an order of priority (e.g. time of the day). When such a factor is introduced, it is not known under which conditions the advertisement should be displayed for higher effectiveness. One way to overcome this issue would be to play the advertisements in varying orders with equal likeliness. When this is the case, a statistically significant sample size will be chosen, and various orders will be tested for this sample. The index when evaluating the effectiveness can be, for example, Seconds per Click (SPC), or the number of seconds necessary until the user clicks the advertisement. Analyzing that information over, for example, the time of day such events occur, statistical information may be collected to determine order of priority and corresponding bid value for placing advertisements on the web screens. Using these results, the advertisements can be shown in the order of this index.

The explanation illustrated an example of a case in which advertisements are shown on a search result page, but it is understood that the techniques discussed herein may be applied to a variety of other advertisement types as well. For example, the techniques introduced herein include a novel online advertisement concept where direct response advertisement and branding advertisement are both combined (the product of the two is taken). Correspondingly, there are two main types of advertisement sales: (1) the CPS (cost per second) mode of advertisement sales (as discussed above); and (2) the product of CPS and Cost per Click (CPC), which would be CPS×CPC. CPS is the price per second of advertisement display, and CPC is the cost that the advertiser bears when a user clicks on an advertisement while watching an advertisement and jumps to a website designated by the advertiser. In order to determine the order of priority of advertisement display, the prices of advertisements (e.g., as placed in bid values) are compared, but in an exemplary scenario, a value in which both the CPS and the CPC are included may also be considered in assessing relevance and priority of the bidders. As indicated here, N=CPS×CPC may be a simple case for accounting the CPS and CPC elements jointly, but it is understood that other conversion formulas where the two elements may be effectively considered may also be used.

In embodiments, the platform server 114 includes logic for the purposes of determination of the two types of cost determination and to identify targets and correlation between the two types. In embodiments, and as illustrated in FIG. 2, the platform server may include one or more of the following modules, each being implemented either in hardware, software, or firmware, or a combination thereof: an advertisement (or ad) suggestion module 222 to make determinations and provide according suggestions as to the type, content, duration, etc. of advertisements to be placed on various publishers' sites. The logic incorporated in this module may include, for example, algorithms to identify significance, meaning, context, relevance, etc. of a particular website and accordingly identify relevant advertisements. Further, the platform server 114 may include an advertisement accepting means 204 for accepting advertisements uploaded by advertising clients 132. In embodiments, the platform server 114 may also include advertisement memory 208 for storing advertisements received from advertisers and advertisement information memory 210 for storing information related to advertisements (e.g., relevance information, order or priority information, etc.). In some instances, the modules may further include an ad selection module 216 and an ad distribution module 218 that are configured respectively to select an appropriate ad and to transmit the ad to a predetermined web screen based on determinations made by the platform server.

In embodiments, these include means that are accessible online by the advertiser. Each component/module identified above may be implemented as discrete software or hardware units or a combination thereof. In embodiments, for example, the advertisement space suggestion module to suggest advertisements for publishing on advertisements spaces and the advertisement bidding means can be combined into or be coupled to a web server 120. In embodiments, the structure of the platform may include, for example (in the case of displaying advertisements in a search result page), a GUI to suggest a page in which the keywords used for the search, the various attributes of the user to which the advertisement is desired to be displayed (gender, age, region, profession, educational background, hobbies, etc), the preferred time of the day to display the advertisement can be entered, etc. According to these entered inputs, the price per unit of time for purchasing the advertisement space and the entry field for purchasing the advertisement space (or an entry page) will be then be displayed. For the suggested advertisement space, the advertiser inputs (e.g., through the bidding platform) the desired price per unit of time to purchase the advertisement space, and the number of advertisement spaces to purchase. However, in embodiments, the purchasing of advertisement space can be for the total length of time that the advertisement will be displayed.

In embodiments, the advertisement information memory 210 and the advertisement data memory 212 to store the advertisement itself may include, for example, advertisement information database means to store information related to the advertisement and an advertisement data database means respectively to store the advertisement itself.

Returning back to the illustration of FIG. 1, the process of utilizing the platform server to process and display advertisements is now explained with respect to two scenarios: (1) when the advertisement is returned to a user viewing the advertisement in a web screen; (2) when the advertisement is displayed to multiple users over an electronic display instrument (e.g., an electronic bill board).

As illustrated in FIG. 1, when the advertiser accesses the bidding platform module of the platform server 114, the system, for example, suggests an entry field for the desired conditions regarding the advertisement display. The advertiser 132 inputs the desired conditions accordingly. In response, the platform server 114 may request entry of an advertisement. The received advertisement and advertisement information is then stored in the advertisement video database and the advertisement information database by the advertisement reception device. In embodiments, the information stored in the advertisement video database and the information stored in the advertisement information database are related and attributed by an advertisement ID that is unique to each advertisement. In embodiments, when the advertisement information is transmitted to a display device, the related information may also be attributed by the advertisement ID.

In the first scenario, the user typically has an advertisement display device that is loaded into the web browser (e.g., a widget within a web page, etc.). At this time, in order to display advertisements that match the user's interests, information regarding the page shown and user IDs are sent to the advertisement selection device of the platform server. An advertisement selection module 216 selects the advertisement(s) to be displayed based on the received information and the advertisement data stored in the advertisement information database. The advertisement selection module 216 selects the advertisements to be shown, and the advertisement ID of the advertisement to be shown will be sent to the advertisement screening device (e.g., the user's computer).

After receiving one or more advertisement IDs from the advertisement selection module 216, the advertisement transmitting or distribution module 218 sends one or more advertisements continuously to the advertisement display device. The advertisement screening device displays the advertisement to the user upon reception. For videos, the display time is generally determined by the length that the video advertisement is played. For still images, the display time is determined by the time designated by the advertiser.

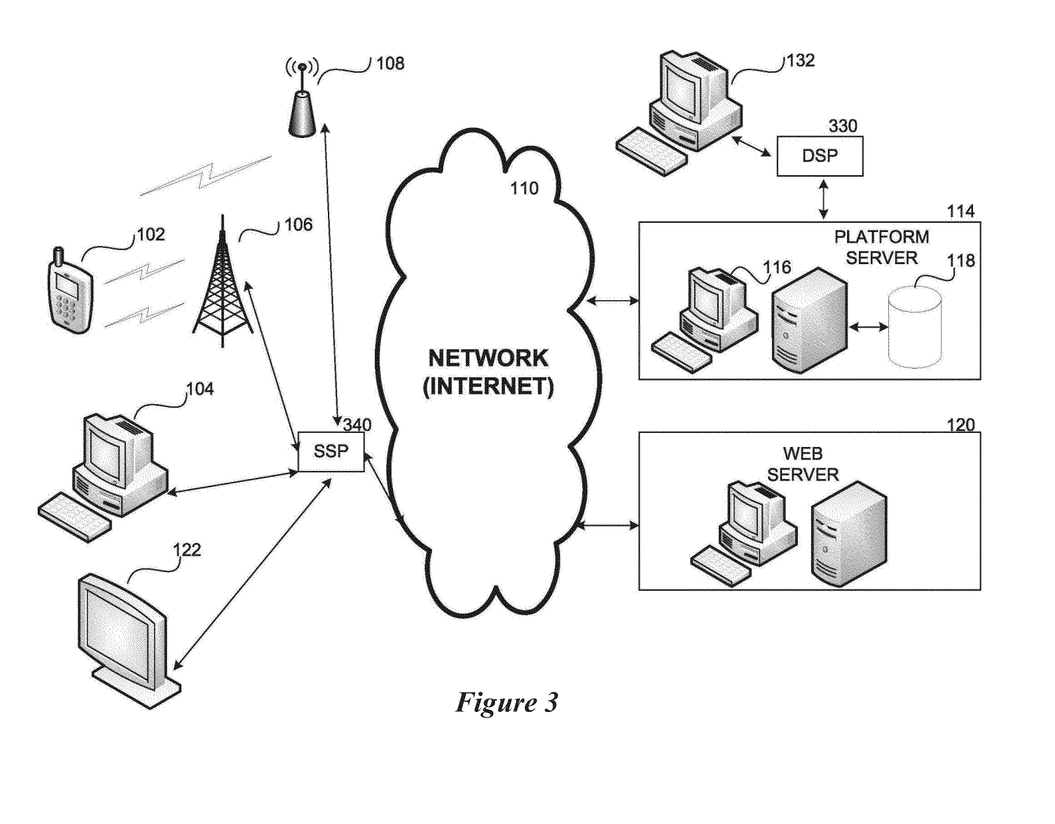

FIG. 3 illustrates the second scenario, where the advertisement display device with which the user watches advertisements is not equipped on the browser, but rather a device that is connected to the internet, such as on an LCD display for street advertising (e.g., device 122). In this scenario, the advertisement display device is not equipped on a web browser, so information as to the basis of selecting the advertisement to display may not exist. In such cases, the advertisement display device does not send out information for advertisement selection, but instead just display the advertisements continuously in a predetermined order. However, for example, if a digital signage device is located in various stores and locations, it is possible that conditions for selecting the advertisement, such as showing it on a device in a ramen noodle store in the shopping quarters from 5 PM to 11 PM, are specified and the advertisements are shown accordingly. In such cases, the advertisement that best matches such conditions may be selected. For videos, the display time is generally determined by the length that the video advertisement is played. For still images, the display time is determined by the time designated by the advertiser

A third scenario of processing and displaying advertisements in accordance with the techniques discussed herein is illustrated with reference to FIG. 3. In this example, the publishing of advertisements and the displaying on the advertisement viewing device are carried out not directly between the advertiser and the user, but by using interfaces to a Demand Side Platform (DSP) 330 and a Supply Side Platform (SSP) 340. The composition of this exemplary embodiment constitutes an advertisement exchange that can incorporate the present teachings with conventional advertising exchanges.

In embodiments, either the DSP, SSP or both may be included. The composition can be either through a connection with the DSP, a composition with a direct connection to the advertiser, or a combination thereof. Similarly, the composition can be either through a connection with the SSP, a composition with a direct connection to the user, or a combination. Other similar combinations of one or more DSPs and SSPs, as may be contemplated by a person of ordinary skill in the art, may also be used as alternate or variants of the above discussed composition.

In this example, when the advertisement is sent by the advertiser, it is stored in the DSP, which acts as the mediator on the advertiser's side. The DSP then selects an advertisement exchange (not shown) from among the advertisement exchanges, and the advertisement is published. In order for the device devised by this invention to receive the advertisement, a bid to determine the price of the advertisement is received from the advertiser through the DSP.

On the other hand, on the user's side, the advertisement is received not directly from the device devised by this advertisement, but from the SSP, and the advertisement is shown. After receiving the advertisement display request from the user, the SSP selects one or more advertisement exchanges to receive advertisements from, and requests for advertisements. At this time, the system (advertisement exchange) devised by this invention, which has received the advertisement request, also receives information necessary to select the advertisement that best matches the user, and according to this information, chooses the best-match advertisement from the displayable advertisements, sending the advertisement to the SSP. After receiving the advertisement, the SSP sends the advertisement to the user, and the user watches the advertisement.

In embodiments, with such a composition, the advertising side can increase the effectiveness of their advertisement by widening the array of media/publishers to display their advertisements on. The results in quantifiable advantages on both sides of the spectrum—on the media/publisher side that will show advertisements, revenue for advertisement spaces increases by allowing for selection from a larger number of advertisements the advertisement that best matches the users' interests. From the users' perspective, for similar reasons, advertisements will be chosen from a greater variety, and the users will be able to watch advertisements that match the users' interests.

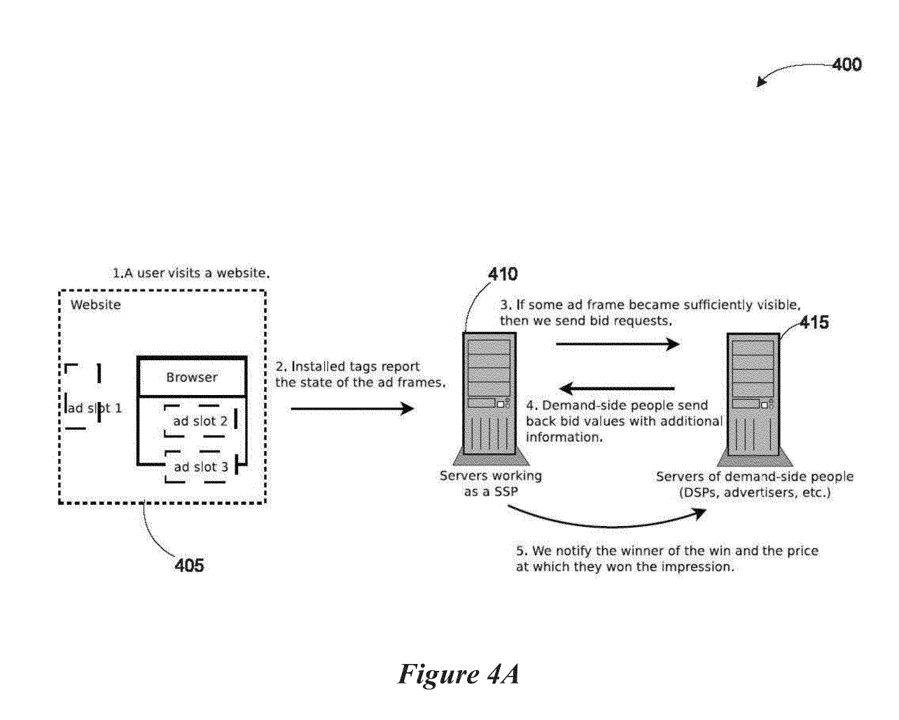

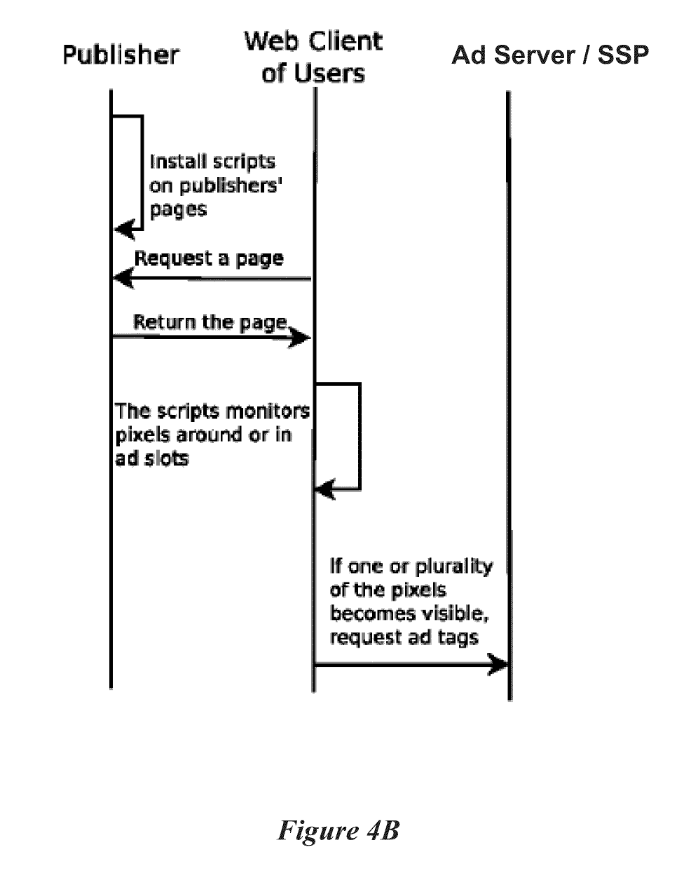

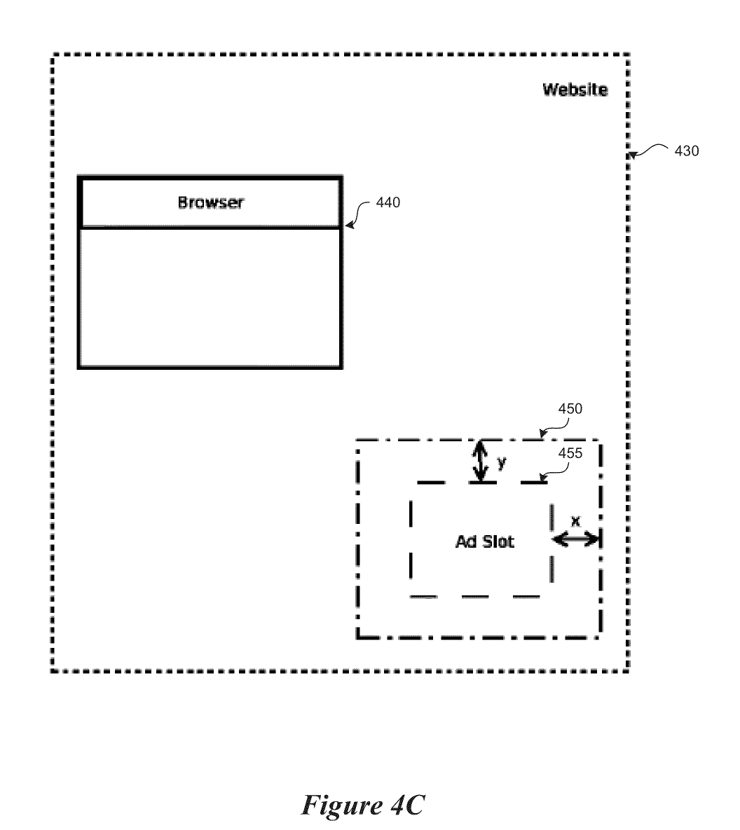

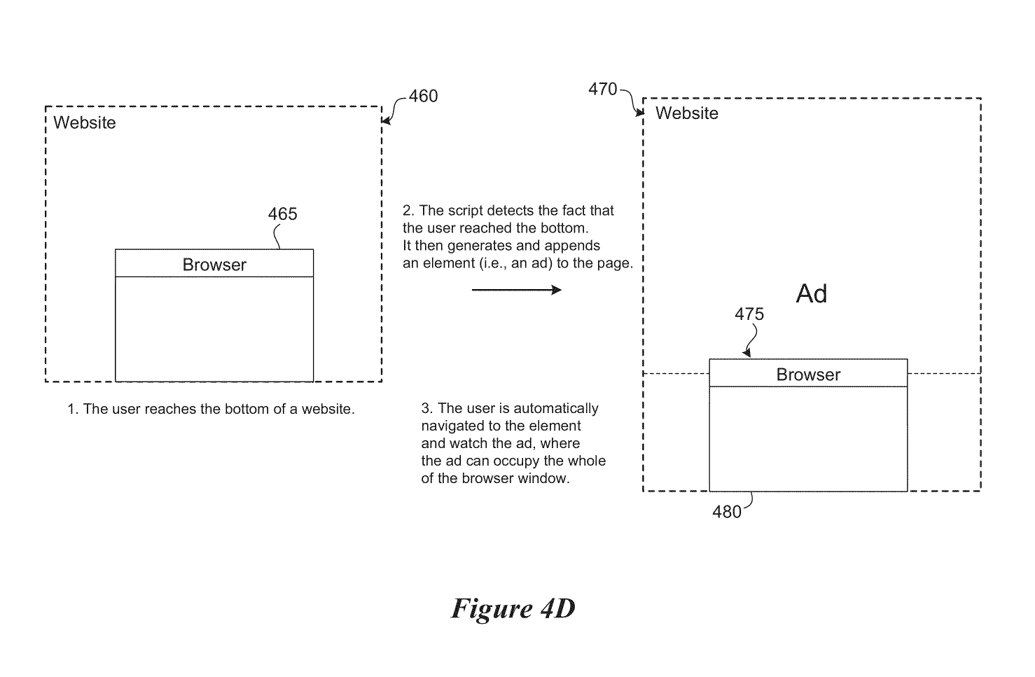

FIG. 4A is a block diagram illustrating a system 400 for presenting ad spots to an auction, according to an embodiment of the disclosed technique. The system 400 includes SSP 410 (similar to SSP 340 of FIG. 3) that identifies the ad spots on a web page 405 and presents them to an auction. The DSP 415 (similar to DSP 330 of FIG. 3), such as advertisers, participate in the auction by bidding for the ad spots. The web page 405 can include any online content that is accessible by a user through, for example, a web browser or any other proprietary applications. The web page 405 includes one or more ad spots and each of the ad spots can render one or more advertisements served by the SSP 410. A user accessing the web page 405 may view the advertisement rendered in the ad spots and perform an action on the advertisements.

The SSP 410 is configured to identify the ad spots that are visible to the user for a predefined duration, and present only those ad spots to the auction. In an embodiment, the SSP 410 identifies those ad spots for which a pre-defined portion of the ad spot, typically a substantial portion, is visible to the user. In an embodiment, the substantial portion could be at least 50% of the ad spot area and pre-defined duration can be at least 100 milliseconds. After the ad spots are determined, the SSP 410 presents the ad spots to the auction and requests the advertisers to place bids for the ad spots. The request may also include a response time indicating a time within which the advertisers have to submit their bids.

In an embodiment, the SSP 410 identifies the ad spots that are visible to the user using scripts that are pre-installed in the web page 405. The web page 405 includes various pre-installed scripts which monitor the web page 405 as it is being viewed by the user through the web browser. The scripts monitor if any of the one or more pixels around a given ad spots (also referred to as the “ad slots”) in the web page 405 become viewable to the user. The script, utilizing the web browser, reports that the ad spots are possibly visible to the user through a request for ad tags (which can be utilized to identify and request ad content as explained later) to SSP 410 (or an ad server).

In response to the bid request from the SSP 410, the advertisers/DSP 415 submits the bids along with the advertisements to be served in the ad spots, to the SSP 410. After receiving the bids from the advertisers, the SSP 410 determines a winning bid based on predefined criteria, such as second-bid auction process described in U.S. patent application Ser. No. 13/609,146, or any other convenient method. The SSP 410 notifies the advertiser regarding the winning price of the impression. Further, the advertisement of the winning advertiser is served in the ad spot. Accordingly, by serving ads in visible ad spots the chances of an ad not being viewed by a user is reduced.

FIG. 4B provides an illustrative sequence of actions performed by the publisher, the web browser, and the SSP 410 to identify the ad spots that are possibly visible to the user. Here, one or more scripts are installed on the publisher's webpage which can be utilized to monitor zones (e.g., zones defined by pixels) around ad slots on the webpage. When a web client of a user requests a webpage, such scripts can be included with the webpage provided to the web client, enabling monitoring of the user actions with respect to the webpage. When the scripts detect any portion of the monitored zone (e.g., one or more pixels of the monitored zone) become visible to the user, the web client is utilized to request ad tags from SSP 410, where the ad tags can be utilized to downloads advertisements that can be shown in the ad slot within the monitored zone.

FIG. 4C provides an example of a webpage 435 with ad slot 455 that is monitored by zones 450 around the ad slot 455. The script monitors the zone 450 around the ad slot 455 defined by the x and y width pixels around the ad slot 455. So, when the zone 450 around the ad slot 455 comes into view on the web browser 440, the monitoring script can inform the SSP 410 that the ad slot 455 is visible to the user. By monitoring such zones around ad slots, the true degree of visibility of an ad slot and in turn its true price can be assessed. For example, if an ad slot is at the bottom of a page, it seldom becomes visible and is usually low-priced. However, since the content of the page usually finishes at the bottom of it, the user's engagement would tend to shift from the content to the ad slot.

In this situation, the true value of this ad slot can be realized and generate higher revenue for the publishers. In some embodiments, the ad slots at the bottom of the page are only auctioned when the user's engagement is towards content at the bottom of the page. By doing so, the publisher of the webpage can demand a higher rate for the increased visibility of the ad slot to the user and still be able to achieve a higher realization even when the ad slot is only auctioned when the user's engagement is towards content at the bottom of the page (and not auctioning the ad slot at a lower rate when the visibility of the ad slot is little or nothing).

In some embodiments, elements (such as a video content) can be dynamically appended to web pages on occasion based on a user's action, by lapse of time, etc. For example, when a user scrolls on a hyperlink for a video, the video can be dynamically appended to the bottom of a currently loaded webpage on the user's web browser, where the user would either be automatically guided to the appended video or be required guided based on some user action. So, such dynamic appending can occur outside the region currently visible to the user. By utilizing monitoring zones in those appended elements, the effectiveness of any ad slots contained in the appended elements on these pages can be enhanced.

In some embodiments, the monitoring zones can be utilized to monitor portions of the webpage irrespective of the content in the monitored portion of the webpage and perform one of many possible actions when any portion of the monitored portion of the webpage becomes visible to the user. For example, a monitoring zone can be attached to the bottom of a webpage, such that when any pixel that falls within the monitoring zone becomes visible to the user, an ad slot can be dynamically appended to the bottom of the webpage, where the ad slot could completely occupy the newly appended portion of the webpage. The user can then seamlessly be attracted to watch any displayed advertisement in the newly appended ad slot.

In another example, the monitored zone can be embedded in the middle of the webpage. As the user scrolls the webpage and any portion of the monitored zone in the middle of the webpage becomes visible, an ad slot can be dynamically generated in a designated portion of the webpage (e.g., within the monitored zone) by replacing the content within the designated portion of the webpage. Here, the ad slot is not appended to the webpage. The webpage size remains the same. Instead, a portion of the content of the webpage can be dynamically altered to accommodate the new ad slot. The ad slot can be sold in an auction similar to the ad slots within the monitored zones. In some embodiments, the content altered can be unaltered (e.g., the missing portion of the content removed to accommodate the new ad slot) and returned to the original form in response to a user action, such as the user closing the newly created ad slot.

FIG. 4D provides an example of a webpage 460 (also referred to as the “website”) being viewed by a user with web browser 465. The webpage contains a monitoring zone (not shown in FIG. 4D) that monitors all the pixels at the bottom of the webpage 460. When the user scrolls the webpage 460 and the bottom pixels within the monitored zone become visible to the user through the web browser 465, 475, the web browser 475 is requested to load an ad slot 480 and append it to monitored zone, i.e. the bottom of the webpage 460, 470. The ad slot can be further auctioned to display advertisements using the various visible ad slot identifying methods discussed above.

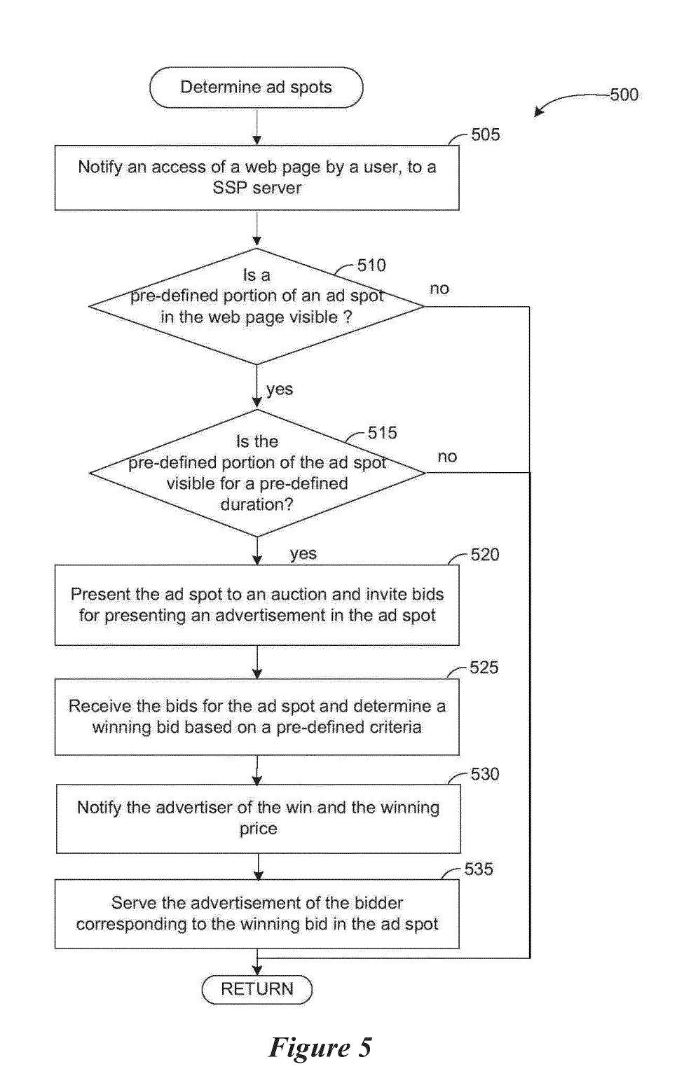

FIG. 5 is a flow diagram of a process 500 for presenting ad spots to an auction, according to an embodiment of the disclosed technique. The process 500 may be executed in a system such as system 400 of FIG. 4A. At step 505, SSP is notified of a user's visit to a web page. At determination step 510, the SSP determines whether a pre-defined portion (substantial portion) of an ad spot was visible. Responsive to a determination that the substantial portion of the ad spot was visible, at determination step 515, the SSP determines whether the substantial portion of the ad spot was visible for a predefined duration.

Responsive to a determination that the ad spot was visible for a predefined duration, at step 520, the SSP presents the ad spot to the advertisers/DSP server in auction and invites the advertisers to submit bids for the ad spot. At step 525, the SSP receives the bids from the advertisers and determines a winning bid based on predefined criteria. At step 530, the SSP notifies the advertiser of the win and the winning price. At step 535, the advertisement of the winning advertiser is served in the ad spot.

In an embodiment, the process 500 is executed for all the ad spots in the web page. Referring back to steps 505-515, a tag, such as an HTML tag, is embedded in the web page to capture data regarding the user's visit to the web page, visibility of the ad spots, the duration of visibility, etc. and send the data to the SSP.

Referring back to step 520, when the SSP sends the request to the advertisers to submit bids for the selected ad spots, the SSP also requests that the bids be placed within a pre-defined time limit, t_{b}. The SSP may specify the time limit to the advertisers either by including it in the request or by any other suitable way.

Referring back to step 525, the advertisers respond to the bid request, by submitting bid values along with additional information, such as the ad to be served in the ad spot if an advertiser wins the bid. Referring back to step 530, the winner and the price is determined using a second-bid auction method, or by other suitable methods.

### Measuring Effectiveness of an Advertisement Creative

A user can respond to an ad creative in a number of ways, for example, by rewinding an audio clip or video clip, enabling sound of the ad, pointing a cursor of a pointing device to a particular portion of the ad, clicking the ad, saving the ad, forwarding the ad via email to other users, sharing the ad with other users, etc. In an embodiment, an ad on which a user performed user action may be considered more effective than the ad on which the users did not perform any user action. Accordingly, the effectiveness of an ad may be measured using various actions performed by the user on the ad.

The effectiveness metric can help the advertisers in creating ad creatives that are more effective and thus, help in obtaining an improved ROI. In an embodiment, the effectiveness of an ad may be measured using an engagement rate of the ad, which summarizes users' overall responsiveness to an ad creative.

Assume, U denotes a set of unique users to whom ad creative c was delivered, and Vᵤ denotes the set of ad impressions that received a response by a user u, where u CU. Assume that each ad impression v, such that v [symbol] Vᵤ, is viewable (as determined by process 500). Further, assume that A denotes a complete set of user response types, such as rewinds, altering sound, mouseover, clicks, saving the ad, forwarding the ad, sharing the ad, etc. A response score Sₐ, where 0<Sₐ (u,v)≦1 of action a [symbol] A, indicates a degree to which user u performed action a on an ad impression v.

Some example user actions and their response scores, (a, Sₐ) for a user u on an ad impression v of an ad creative c include the following:
Mouseover user action
   Sₐ(u, v)=1 If the user pointed a cursor of a pointing device, such as a mouse, over the ad impression for more than t seconds. Time t, is a configurable pre-defined value (for example, 3 seconds).
   Sₐ(u, v)=0, if the above condition is not satisfied.
Altering sound user action
   Sₐ(u,v)=1 If the user turned the volume on or increased the volume on an ad impression.
   Sₐ(u, v)=0 if the above condition is not satisfied.
Rewind user action:
   Sₐ(u,v)=1 If the user rewound the ad impression, in part or full, and watched part of the ad creative more than once,
   Sₐ(u,v)=0 if the above condition is not satisfied.

In an embodiment, the engagement rate of the ad creative may be determined using the following formula (I) as shown below:

$$Engagement Rate = \frac{{\sum }_{u ∈ U} {\sum }_{v ∈ Vu} {\sum }_{a ∈ A} {w}_{a} * {S}_{a} ( u , v ) \text{/} \vert {V}_{u} \vert}{\vert U \vert} \qquad ( 1 )$$

where wₐ is a weight of user action a, and Σa [symbol] A wₐ=1.

In an embodiment, each user action can be given an equal weight by having wₐ=|A|.

The engagement rate metric measures an effectiveness of the ad creative as a ratio of a number of responsive users to a total number of users to whom the ad creative was served. In other embodiments, the engagement rate may be measure using other formulas. In addition to the ad creative, the engagement rate can be used to determine effectiveness of other online content, such as web pages, videos, audios, etc.

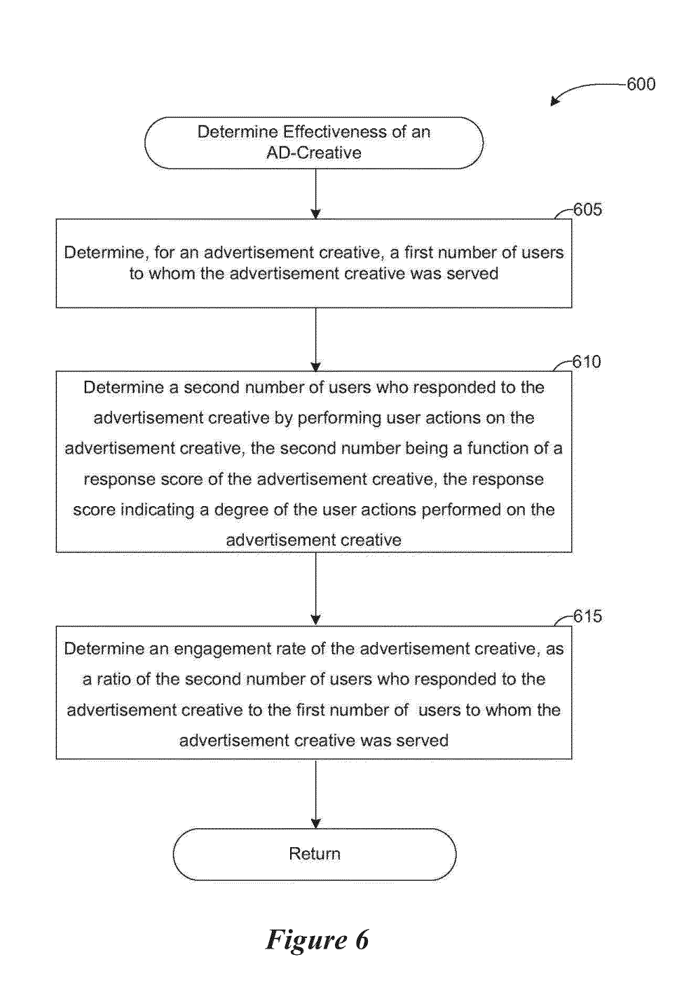

FIG. 6 is a flow diagram of a process 600 for measuring effectiveness of an ad creative, according to an embodiment of the disclosed technique. The process 600 may be executed in a system such as system 400 of FIG. 4A. At step 605, SSP determines a first number of users to whom the ad creative is served. In an embodiment, the first number of users may be measured as a total number ad impressions served. At step 610, the SSP determines a second number of users who responded to the ad creative by performing user action on the ad impression. At step 615, an engagement rate of the ad creative is determined as a ratio of the second number of users who responded to the ad to a first number of users to whom the ad creative was served. The engagement rate provides the effectiveness the ad creative.

Referring back to step 610, the second number of users is determined as a function of a response score of an ad creative. The response score indicates a degree of the user actions performed on the ad impressions of the ad creative. The response score is determined for each type of user action. In another embodiment, the second number of users may be measured as a function of a number of ad impressions on which users performed user actions.

### Measuring Viewable Time of an Advertisement Creative

As explained above, in some instances, a user's level of engagement with an ad create can be gauged by the user's response to the ad creative (also referred to as “ad” or “ad content”). Further, the user's level of engagement may be utilized in determining the ad's effectiveness on the user. In some embodiments, the ad's effectiveness on the user is utilized when determining a cost for displaying the ad to the user. In one instance, the ad's effectiveness on the user is measured as a function of the duration of time the user possibly paid attention to the displayed ad (also referred to as the “measured viewable time” of the displayed ad).

In some embodiments, the user's attention can be measured as a function of the proportion of the displayed ad (or that of any content whose user attention is being gauged) viewable (i.e. visible) to the user through a web client (e.g., a web browser). When the displayed proportion of the ad is below a minimum threshold possibly needed to draw the user's attention to the ad, the user is not likely to have paid any attention to the displayed portion of the ad (i.e. measured viewable time is zero). In one embodiment, the information on the position of the ad content relative to the region of the ad content displayed by the web client is gathered every tₛ seconds. Let h and w be height and width of the content, respectively. Using the position information, ratio rᵥ of size of the viewable part of the ad content to the size of the whole ad content is computed as rᵥ=(Sᵥ)/(h×w), where Sᵥ is the area of the portion of ad content that is being shown on the web client. In one example, the minimum threshold (θᵥ) can be set to 0.5, where only ad content with ratio rᵥ>=θᵥ are considered to have the user's attention.

In some embodiments, the user's attention can be further measured as a function of the visibility (also referred to as the “focus”) of the web client displaying the ad to the user. In one instance, when the web client is not visible to the user, the user can be deemed to be paying little attention to the ad being displayed by the web client (i.e. measured viewable time is zero). For example, a web browser displaying the ad might be blocked from the user's view by the window of another application running on the user's computing device, leading to little user attention to the displayed ad. In another example, a web browser with multiple tabs might simultaneously display multiple web pages but only content displayed in one of the tabs that is actively being viewed by the user is in focus (i.e. visible to the user). If the displayed ad is not in the actively viewed tab, then the user is paying little attention to the displayed ad.

In some embodiments, the user's attention can be further measured as a function of one or more user actions with respect to the web client. In one embodiment, a user's is paying attention to the web client and possibly to the portion of ad content being displayed by the web client when the user performs at least one or more user actions (from a subset of possible user actions that indicate user's interaction with the web client) every tᵤ seconds since the last performed user action (with respect to the web client). In one instance, tᵤ is a predefined threshold value empirically determined such that at least one user action performed every tᵤ seconds show user's continued attention.

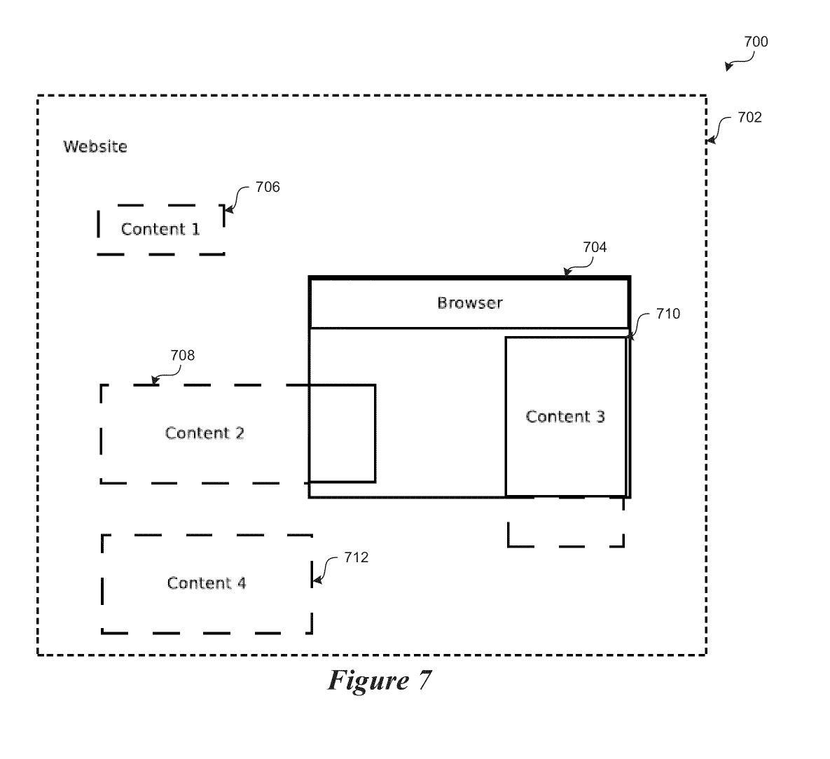

FIG. 7 is a block diagram 700 illustrating the measurement of a user's attention to various content areas 706-712 (e.g., ad slots) displayed across a web page 702, where some of the content areas 708, 710 are displayed to the user through a web browser 704 while the others are not 706, 712. As discussed above, the user's attention can be measured as a function of a proportion of a given content's area displayed to the user, focus of the web browser 704 to the user, and the user actions with respect to the web browser 704. Content of the web page 704 within the web browser 704 are displayed to the user while the content of the web page 704 outside the web browser 704 are not.

Here, content #1 706 and content #4 712 are outside the web browser 704 and therefore no portion of the contents 706, 712 are displayed to the user, thus each garnering little user attention (or zero measured viewable time). On the other hand, content #2 708 and content #3 710 are partially visible to the user. Content #3 710 has a large proportion of the content displayed (possibly exceeding the θᵥ threshold) to the user through the web browser 704 and can garner viewable time when other conditions (if any) for user's attention measurement are met. On the other hand, content #2 708, while displayed partially, has a small proportion of the content displayed (possibly lower than the θᵥ threshold) to the user through the web browser 704 and cannot garner viewable time even when other conditions (if any) for user's attention measurement are met.

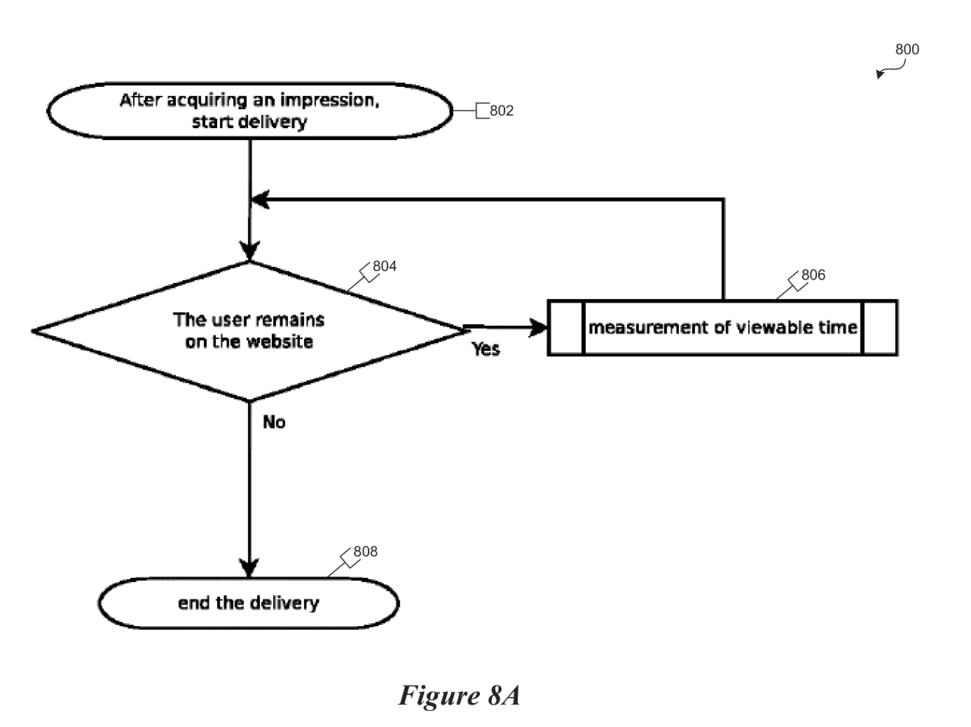

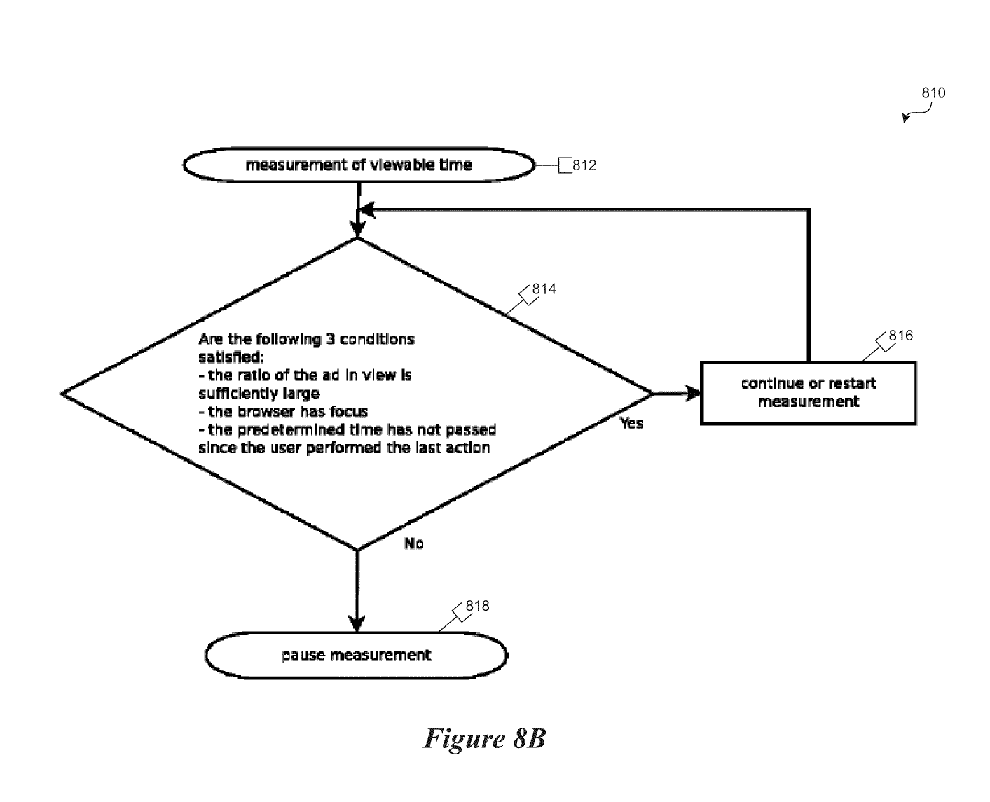

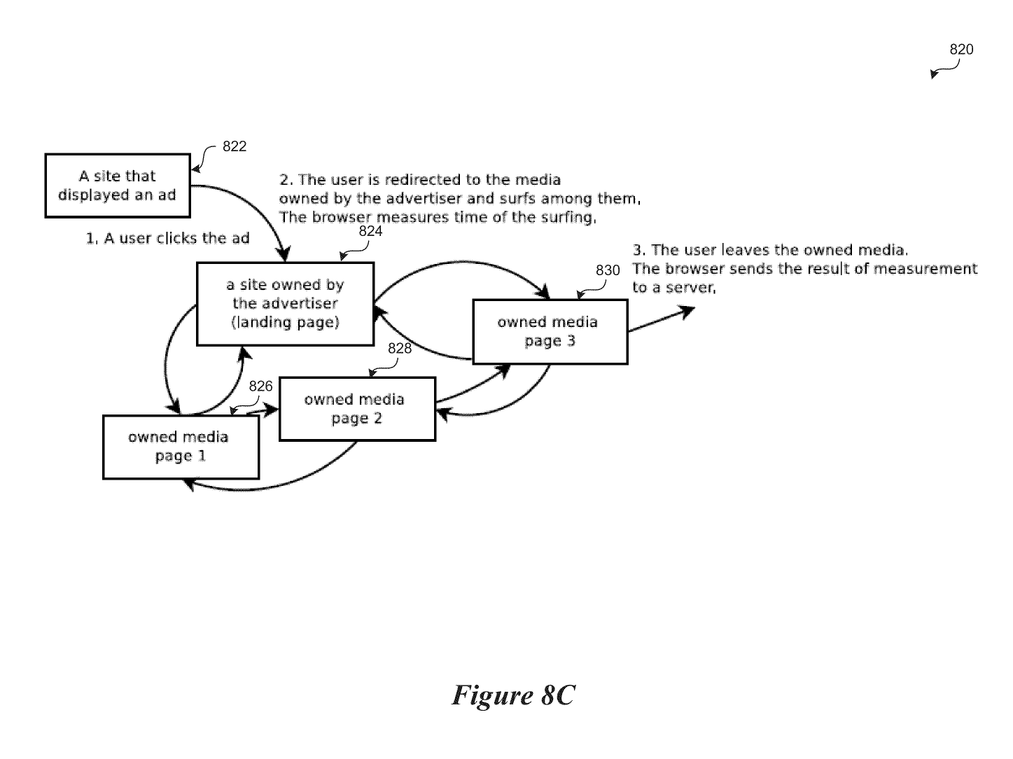

FIG. 8, which includes FIGS. 8A, 8B and 8C, shows a method 800 that can be utilized by the system 415 to measure viewable time for an ad content displayed in a given impression on a given web page (also referred to as a “website”). In step 802 of the method 800, the system 415 starts delivery of the ad content to be displayed to the user through the given impression. In step 804 of the method 800, the system 415 determines whether the user still remains on the given web page with the given impression. The step 804 can be performed using any well known methods, such as determining if at least one of the web pages open in the web page has the same web address as that associated with the given web page. If the user is determined to be still on the web page in step 804, in step 806 of the method 800, the system 415 measures viewable time (i.e. user's attention duration) of the displayed ad content. However, if the user is determined to have left the web page with the impression in step 804, in step 808, the system 415 stops delivery of the ad content to be displayed to the user.

In one embodiment, the system 415 measures viewable time of the displayed ad content using the method 810. In step 812 of the method 810, the system 415 begins measurement of the viewable time of the ad content. In step 814, the system 415 determines if the following three conditions are met: (1) the proportion of a given content's area displayed to the user greater than θᵥ; (2) focus of the web browser to the user; and (3) the user actions with respect to the web browser. If the conditions are met, the system 415 proceeds to step 816 and continues measuring (or starts measuring if its beginning the viewable time measurement process) the duration of time as the ad is being displayed in the given impression. After the lapse of the a predetermined time period, the system 415 again evaluates step 814 to determine if the user's attention is still possibly focused on the ad before continuing to measure viewable time for the ad. If the conditions are met, the system 415 continues to measure viewable time for the displayed ad. However, if the conditions are not met in step 814, the system 415 proceeds to step 818 and pauses measurement of the viewable time. The system 415 determines if the user is still on the web page in step 804 before resuming the measurement of viewable time in step 806.

### Owned Media Viewable Time

As discussed above, a user's level of engagement with an ad create can be utilized when determining a cost for displaying the ad to the user. In one instance, the ad's effectiveness on the user is measured as a function of not only the duration of time the user paid attention to the displayed ad (i.e. the measured viewable time of the displayed ad) but also the duration of the time the user spent on any landing page provided to the user when the displayed ad is clicked by the user.

In the present-day online advertising industry, the billing system charges for one click on an advertisement by a user (capturing both the user engagement with the displayed ad and a potential interest in the advertised product). However, the true value of a click (i.e. the potential interest of the user in the advertised product) can be best measured as the time the user spent on the landing site (associated with the clicked ad) which is owned by the advertiser that further market the product/message in the clicked ad. Such a measured time is defined as owned media viewable time (OMVT), which is the effective amount of time a user spent on the landing site. This enables us to measure the true value of clicks, which has previously been obscure and doubtful. Further, in the following discussions, the OMVT can be considered equivalent of measured viewable time (discussed above) and the various pricing models and systems can be implemented with OMVT when applicable.

FIG. 8C provides an illustration of a method 820 that can utilized to measure OMVT. In the method 820, the landing web page 824 that a user is redirected to after clicking an ad 822 is usually a medium owned by the advertiser. The viewable time is measured with the whole web page 824 as one web content. That is, the viewable time is measured when any portion of the web page 824 is visible in the web browser (as the rᵥ will be equal to 1 given that any content displayed in browser is considered monitored content) and the browser tab showing web page 824 is in focus and attracting a user action (the three conditions discussed above when measuring viewable time for displayed ads).

If one of the conditions above becomes unsatisfied, the measurement of the viewable time is paused. If the conditions are all met after the measurement was paused, the measurement of the viewable time is resumed. Here, owned media viewable time (OMVT) is determined by summing up viewable time of each page in the web site, as below: 1. Let p₀ be the landing page 824 associated with the advertiser of the advertisement (which when clicked lead the user to the landing page 824). Let us further assume the user viewed pages p₁, . . . , pₙ 826-830 during the session (all advertiser owned pages) before leaving the advertiser owned pages, and let t₀, . . . , tₙ be viewable time measured on each page.

In one embodiment, all the web pages associated with a webpage the original landing page is associated with are all considered advertiser owned pages when determining OMVT. For example, if the landing page is a marketing webpage for one of the products (e.g., a weight-lifting machine) sold by the advertiser and the user viewed additional web pages that correspond to one or more other products (e.g., a bench-press table, etc.) sold by the advertiser, then all the pages viewed by the user during the user's visit to the website of the advertiser are considered when measuring OMVT for that user visit.

In embodiments, the user's visit to the one or more pages in the advertiser's website can be contiguous (i.e. all the web pages viewed by the user during a session are associated with the a website of the advertiser or one or more related websites of the advertiser) or be interrupted by the user's visit to one or more other web pages not associated with the advertiser. In the event the user's visit to the one or more pages in the advertiser's website is interrupted by the user's visit to one or more other web pages, an interrupt can be considered an end of the user's session for measurement of OMVT when the interrupted time between the viewing of web pages belonging to the advertiser is exceeded by a predefined minimum time period. In one instance, the predefined minimum time period can be determined by analyzing an exemplary data set to determine the extent of interrupt that results in previously viewed pages having lesser effect on a later viewing of other related pages by the user.

Then, as shown in FIG. 8C, OMVT “T” is defined as T=t₀+ . . . +tₙ, the sum of the viewable time of pages p₁, . . . , pₙ 826-830 associated with the advertiser. Thus, similar to measured viewable time, OMVT is the duration of time in which the owned media had the user's attention.

Ad Serving in Pace with Measurement

As discussed above, the measured viewable time of an ad content displayed to the user can be very effective in gauging the user's attention to the displayed ad content, which can in turn help an advertiser or any interested party assess a potential impact of the displayed ad content on the user more accurately than the existing methods allow.

In one embodiment, when the measurement of viewable time is in progress, the system 415 can infer that the user is possibly paying attention to a displayed ad content (the viewable time is being measured for). Based on the inference, the system 415 can increase the possibility that ads with real-time change (e.g., video ads, game ads, etc.) gets users' attention by serving them in pace with the measurement of viewable time for the ads. For example, in one method, the system 415 starts delivering an ad (e.g., play a video ad) when the measurement the viewable time for the ad is in progress (and not paused). Here, if the ad had already started delivering to the user before it was paused (either by the user or by the system 415 when the user stopped paying attention to the ad), the system 415 can restart it from the paused time point when the measurement the viewable time for the ad progresses again. Further, if the measurement is paused (i.e. when the user stops paying attention to the ad), the ad delivery is paused (e.g., the video ad is paused if playing). Additional details of a method for pausing and playing ads in pace with user attentiveness are disclosed in, for example, commonly-assigned U.S. patent application Ser. No. 13/570,831.

### Pricing Models Based on Measured Viewable Time

As discussed earlier, the measured viewable time captures possible users' attention to a displayed ad, where the viewable time is correlated with the possible extent of the displayed ad's effect on the user. One or more ad pricing models that assess the cost of displaying the ad to the user based on the extent of the effect on the ad on the user (as determined by the measured viewable time) will be very useful to advertisers and other interested parties who wish to determine their ad spending based on measurable results (e.g., the extent of effect on user as a function of the various measured viewable time for the ad).

### CPXs Pricing Model

CPXs (Cost Per Ten thousand seconds) model is a pricing model that calculates the cost for an ad delivery according to the total amount of measured viewable time (also simply referred to as the “viewable time”) achieved during the delivery of the ad. In one embodiment, an advertiser can bid for display of an advertisement in the form a CPXs bid, where the advertiser pays for displaying the ad for 10,000 viewable seconds of the ad to one or more users in one or more ad slots across websites. In some embodiments, based on the CPXs bid, the advertiser is charged for only the actual achieved viewable time for an associated ad.

The following discussion provides a method that can be used to determine an ad delivery cost for the advertiser based on the CPXs cost model. In the method, the total achieved viewable time of the displayed ad is measured (until the one or more users leave the web page with the impression where the ad is displayed) as Tᵥ. The viewable time Tᵥ is then utilized in calculating the cost for the delivery of the ad as C(Tᵥ).

In some embodiments, the C(Tᵥ) is calculated as a function of a cost per second “c” as shown in eq. (2), where the value “c” represents the cost per one viewable second. Here, the cost per second “c” remains fixed for the entire length of the displayed ad and does not temporally change with the ad display.

C(Tᵥ)=“c”×Tᵥ (2)

The cost per second “c” can be established using any well known method including: (1) setting the value of “c”=(CPXs bid value)/10,000; (2) setting the value “c” based on a predetermined value an advertiser of the ad is willing to pay; and (3) the value “c” determined through an auction of the opportunity for ad delivery in a given impression. The method of computing “c” based on an impression cost (e.g., CPM cost) is discussed in detail later.

In some embodiments, the C(Tᵥ) is calculated as a function of a variable cost per second “cᵢ” as shown in eq. (3), where the value “cᵢ” represents the cost per one viewable second over a given time interval (I·t, (1+i)·t) in the duration of ad delivery and “t” represents the length of a fixed duration of time during which the cᵢ remains constant.

$$C ( {T}_{v} ) = {\sum }_{i = 1}^{n} {c}_{i} \cdot t \cdot {1}_{( i \cdot t \leq {T}_{v} \}} \\ where , \\ \begin{matrix}{1}_{\{ i \cdot t \leq {T}_{v} \}} = 1 if i \cdot t \leq {T}_{v} \\ = 0 otherwise\end{matrix} \qquad ( 3 )$$

The cost per second “cᵢ” can be established using any well known method including: (1) a value agreed on with the advertiser through negotiation; (2) a value determined through an auction of the opportunity for ad delivery in the given impression; and (3) a value estimated based on the effectiveness of the ad on the user over each time interval from (I·t) to ((i+1)·t). Additional details of a time-variable cost per second model based on user engagement are disclosed in, for example, commonly-assigned U.S. patent application Ser. No. 13/570,831. In the variable cost per second “cᵢ” model, the ad delivery cost for the advertiser based on the CPXs cost model can be set such that the C(Tᵥ) achieved for 10,000 viewable seconds is equal to the received CPXs bid value.

### CPV Pricing Model

CPV model is a pricing model that can be used to charge an advertiser only when their ad acquires more viewable time than a predetermined duration (say, provided by the advertiser). So, if the ad is not delivered for the predetermined duration, the advertiser incurs no cost for the ad already displayed to the user. The following discussion provides a method that can be utilized to implement the CPV pricing model.

In this method, a predetermined value “T” equal to the amount of guaranteed viewable time for a given ad is set by one of the interested parties, such as the advertiser, the DSP, etc. If an ad does not acquire viewable time more than “T” seconds with an ad delivery (or a series of ad deliveries, using the “ad-follow” method described later), then the advertiser is not charged for any portion of the ad delivery. The method then measures the viewable time Tᵥ achieved from an ad serving (or a series of servings in the “ad-follow” method) of the given ad to a user.

If Tᵥ>T, then the method charges the advertiser an amount for the ad delivery. The amount charged can be determined in several manners including: (1) the amount determined through negotiation with the advertiser; (2) the amount arrived through at an auction of the impression (used to display the ad to the user). The proposed CPV pricing model can be implemented by the SSP, DSP, or any third-party ad server that can be enabled to gather or receive the viewable time for a given ad. Additional details of how the various parties implement the various pricing models are discussed in detail later.

### Bid Value Translation

As discussed earlier, an advertiser can purchase or bid for an impression that can be used to display the advertiser's ad. In some embodiments, the advertisers can bid for impressions utilizing various pricings, such as CPM, CPS, CPXs, CPV, etc. An ad platform, such as DSP or SSP, can convert the received bids into one form of pricing and compare the received bids to determine the highest bid. The ads associated with the highest bid will be displayed to the user. In one instance, the ad platform converts CPS, CPXs, CPV based bids into CPM bids when the ad platform is utilizing CPM as the cost basis when evaluating bids and/or charging for ad delivery. As can be seen from the discussion below, the ad platform can utilize the below method to convert CPM bids to any of the other pricings or between any of the pricing using the CPM as the intermediate cost basis (e.g., CPXs<->CPM<->CPV).

### CPXs<=>CPM Bid Translation

The following discussion illustrates one method of performing the CPXs to CPM (and vice-versa) translation. Let tᵥ denote the expected amount of viewable time achievable for the impression to be acquired in the auction using a bid based on CPM pricing. In one instance, tᵥ can be estimated based on the average achieved viewable time (or other equivalent metric, such as average duration of users' stay on a given webpage) from previous deliveries of one or more ad at one or more web pages similar to the webpage where the impression to be acquired is available. We relate CPXs and CPM with eq. (4) as shown below:

$$CPXs = CPM \cdot \frac{10}{{t}_{v}} \qquad ( 4 )$$

Here, given that in a CPM bid, an advertiser is purchasing a potentially display of the ad for at least tᵥ seconds over 1000 impressions (tᵥ×1000 seconds), the CPXs pricing averages this cost over 10,000 seconds for the given CPM bid price. So, CPXs is CPS×10,000 seconds, where CPS can be estimated as CPM/(tᵥ×1000).

As discussed above, the bid translation can be used to either to evaluate received bids or be used by a publisher to evaluate a pricing model (to charge advertisers by) which provides the best realization for the publisher. For example, using the above disclosed CPXs<=>CPM translation and taking the various ads that are being served to a user in a webpage, the publisher of the webpage can determine the best pricing model (i.e. best realization) to charge the advertisers using the below discussed method.

In the method, let “u” denote a user who visits a webpage “m” owned by a publisher. We further assume that this webpage has one or more ad slots fₘⱼ (j=1, . . . , n). Also, let Aₘⱼ be the set of advertisements which can be delivered to a corresponding ad slot fₘⱼ. Further let l(a) be the required temporal length of ad “a”εAₘⱼ. The demand dₘⱼ of Aₘⱼ for time is given by eq. (5) shown below:

$${d}_{mj} = {\sum }_{a ∈ {A}_{mj}} {w}_{a} \cdot l ( a ) \qquad ( 5 )$$

where, wₐ>0 takes some appropriate value so that Σ_{aεA}_{ₘⱼ} Wₐ=1 holds (e.g., Wₐ=1/|Aₘⱼ| for all aεAₘⱼ).

For a CPM price of Pₘⱼ for fₘⱼ, the CPS price P^{s}ₘⱼ of fₘⱼ is given by

$${p}_{mj}^{s} = \frac{{p}_{mj}}{1000 \cdot {d}_{mj}} \qquad ( 6 )$$

Also, let us assume that the ad slot fₘⱼ has generally achieved an average viewable time of length Tₘⱼ. If Tₘⱼ>dₘⱼ, then the impression can be fully utilized to deliver each advertisement (displayed in that impression) according to their required viewable time. As discussed earlier, CPXs value P^{x}ₘⱼ of fₘⱼ is defined as P^{s}ₘⱼ×10,000 seconds.

In the above described method, a publisher's expected revenue under CPM pricing would simply be

$${p}_{mj} = \frac{{p}_{mj}}{{d}_{mj}} {d}_{mj}$$

per 1000 impression. On the other hand, if the publisher employs CPS pricing, then their expected revenue for displaying 1000 impressions is

$$1000 \times {p}_{mj}^{s} {T}_{mj} = \frac{{p}_{mj}}{{d}_{mj}} {T}_{mj}$$

per 1000 impressions, where the publisher would make a profit if Tₘⱼ>dₘⱼ. The CPS pricing can be easily translated to CPXs pricing as CPS×10000 sec.

Based on the above determined values, a publisher would gain better realization by employing CPS (or CPXs pricing) when Tₘⱼ>dₘⱼ and gain better realization by employing CPM when Tₘⱼ<dₘⱼ (i.e. when ad length display demand is greater than likely achievable viewable time).

### CPV<=>CPM Bid Translation

The following discussion illustrates one method of performing the CPV to CPM (and vice-versa) translation. Let “T” denote the amount of viewable time guaranteed in CPV model for a given ad. For the impression (used to display the ad) being auctioned, gather data associated with the impression. For example, for the impression associated with a top banner ad slot in webpage www.nytimes.com, the impression represents a specific opportunity for a buyer to display their advertisement in the top banner ad slot in www.nytimes.com. The gathered data associated with the impression can include the number of impressions “N” generated for the ad slot over a given period of time (e.g., one day, one week, or one month), the number of those impressions that achieved a viewable time greater than T (“N_{T}”) during the same given period of time, etc.

CPV can then be translated into an equivalent CPM value or vice-versa using eq. (7) (shown below):

$$CPV = \frac{CPM}{1000} \cdot \frac{N}{{N}_{T}} \qquad ( 7 )$$

As discussed above, the ad platform (or publisher) can thus convert any CPS, CPXs, CPV based bids (or pricing) into CPM bids (or pricing) when the ad platform (or the publisher) is utilizing CPM as the cost basis when evaluating bids and/or charging for ad delivery. As should be clear from the discussion above, the ad platform (or publisher) can utilize the above methods to convert CPM bids to any of the other pricings or between any of the pricing using the CPM as the intermediate cost basis (e.g., CPXs->CPM->CPV).

### General Overview of Various Systems Implementing the Pricing Models

The viewable time underlying the various pricing models and the methods to perform evaluation of bids, delivery charges, realization, etc., can be measured and implemented by various participants, including a DSP, a SSP, any third-party ad server, a publisher, etc.

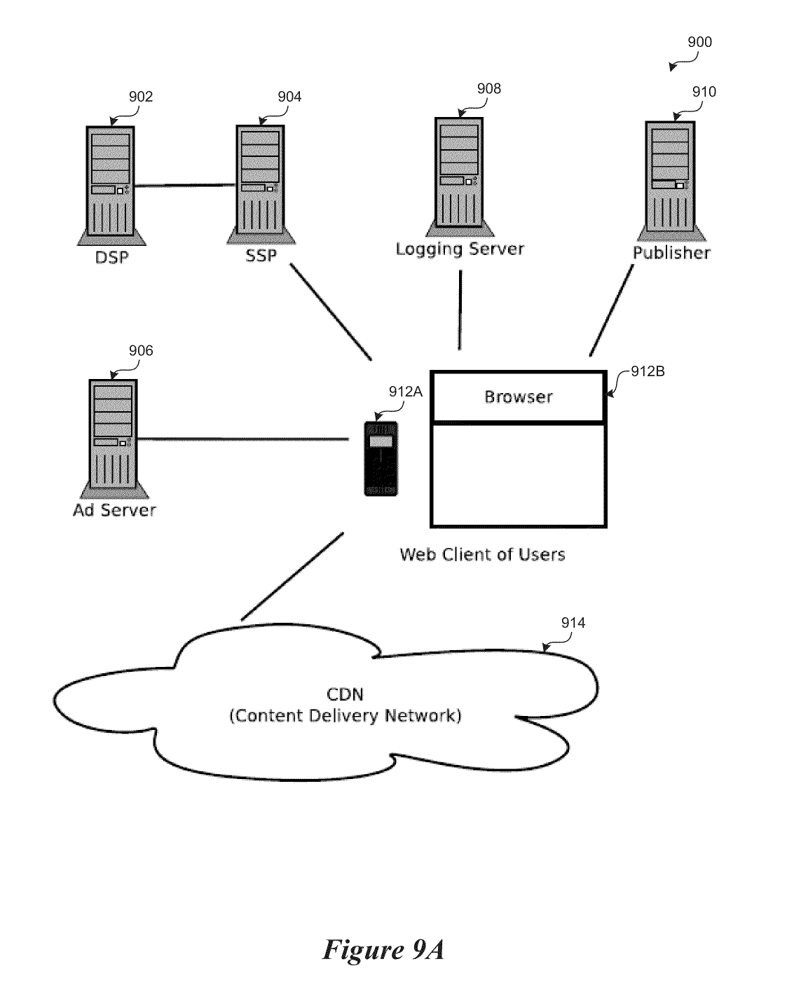

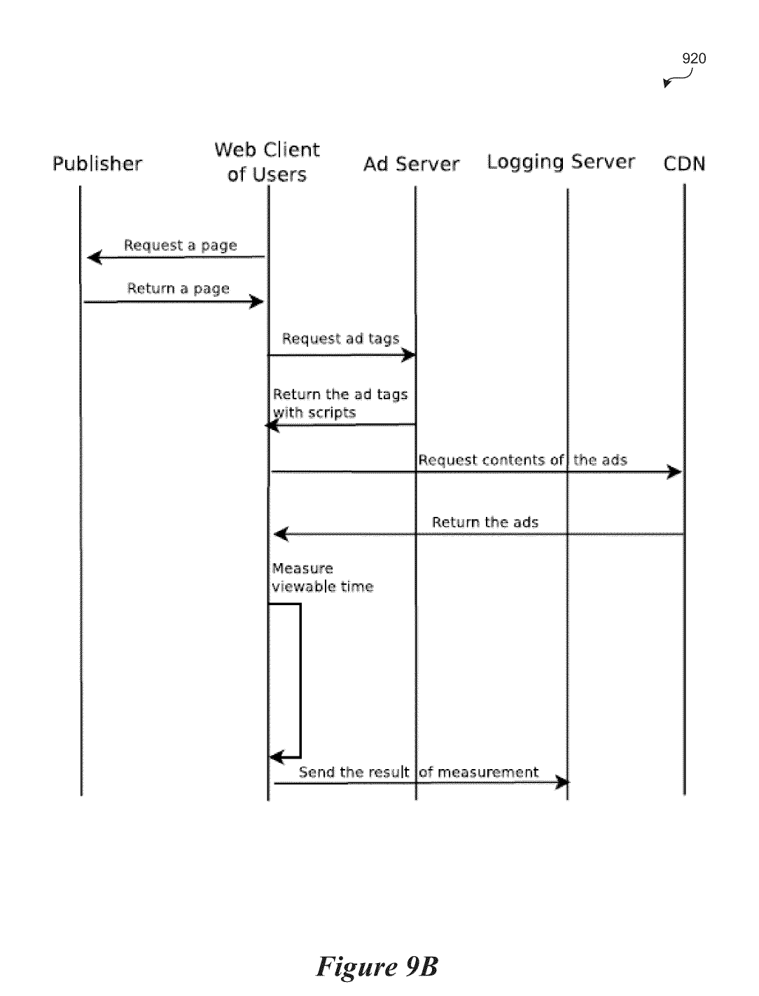

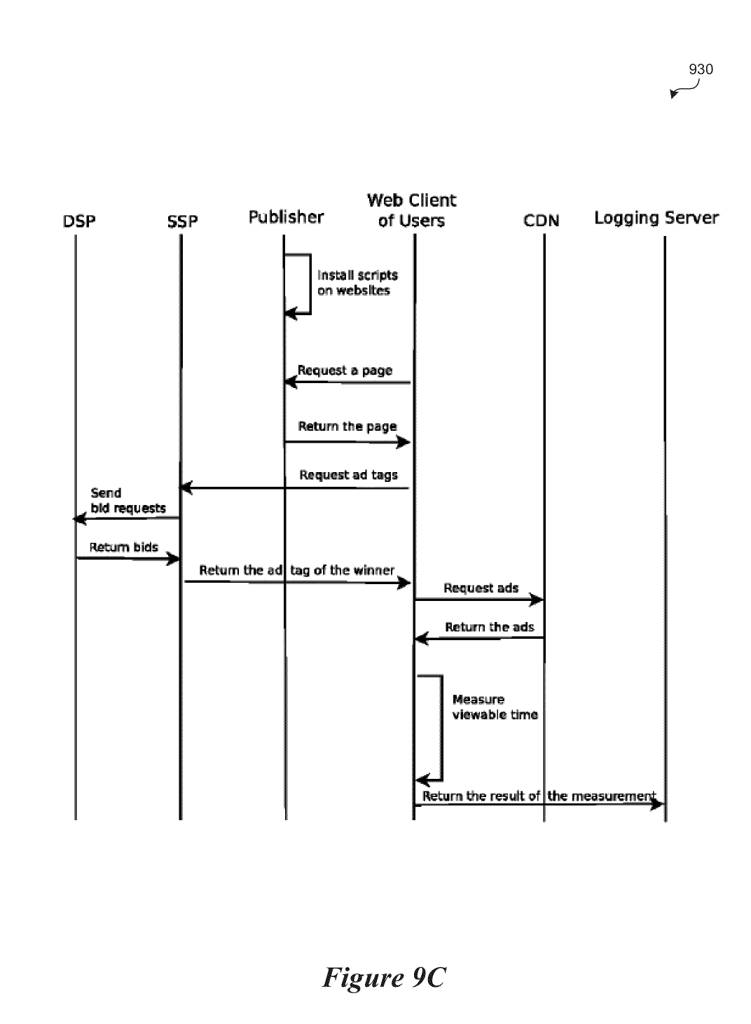

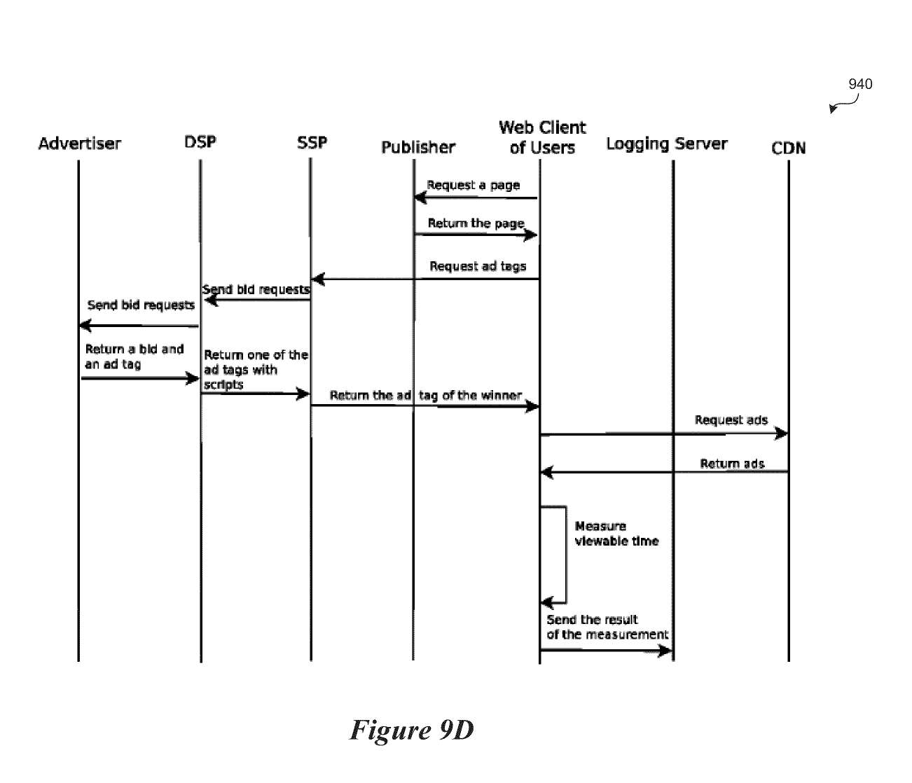

FIG. 9, which includes FIGS. 9A, 9B, 9C and 9D, provides an illustrative example of various methods that can be utilized by the various participants implementing the pricing model.

FIG. 9A illustrates the various participants in a general environment 900 the user is interacting with when the user is engaged in any activities over the internet. In FIG. 9A, the user engages online using a mobile device 912A running a web browser 912B (i.e. a web client). When the user visits a website hosted by the publisher 910, the ad server 906 or the SSP 904 sends ad tags to the user's web browser 9128. The tags in turn direct the web browser 9128 to download ads from the Content Delivery Network (CDN). Further, the DSP 902 interacts with the web browser indirectly through the SSP 904. Also, the Logging server 908 may be utilized to receive information regarding the acquired viewable time for each given ad served in a given impression during the measurement of users' attentiveness. Although this reporting might degenerate the quality of measurement (since making a report to a server takes time), the measurement is taken before the reporting confirms that the impression acquired “T” seconds of viewable time and thus remaining a valid data.

FIG. 9B illustrates the interaction 920 between the various participants when the pricing models are implemented by the third party ad server 906. Here, the web client (i.e. the web browser) of the client 9128 initiates a page request with the publisher 910. The publisher 910 provides the client 9128 with the requested page. The client 9128 then sends out request for ad tags for one or more ad slots (present in the received page from the publisher 910) to the ad server 906. The ad server 906 in turn returns the ad tags (which are associated with ads to be displayed in the ad slots) with scripts to perform various functions, such as monitor user actions, measure user attention, etc. The client 9128 sends the received ad tags to the CDN to request for the ad content associated with the ad tags. The CDN responds to the request by sending the ad content associated with the ad tags to the client 912B. The client 912B displays the received ad content to the user. Further, the client 912B further measures the viewable time for the displayed ad (when the various conditions for user attention are met as discussed above). When the display of the ad content ends or the user ends the session, the measured viewable time are forwarded to the logging server that can be utilized by any of the other participants (including the third-party ad server) to implement the pricing model and determine the cost for ad delivery.

FIG. 9C illustrates the interaction 930 between the various participants when the pricing models are implemented by the SSP 904. Here, the various scripts (discussed above) are installed within the publisher's 910 websites and gather the necessary data when a user visits the websites. Also, here, the SSP 904 receives the request for ad tags (instead of the ad server 906 as before). In response to the request for ad tags, the SSP 904 in turn sends bid requests to DSP 902 for ads to be displayed in the ad slots associated with the ad tag requests. The DSP 902 sends a bid value and the ad to be displayed in the ad slot if the DSP's 902 bid is successful. The SSP 904 evaluates the various return bids and forwards the ad tag associated with the ad in winning bid to the client 912B. The rest of the functions, including measuring and storing viewable time for each displayed ad, are performed similar to those functions performed with the ad server 906 as the participant (in FIG. 9B).

FIG. 9D illustrates the interaction 940 between the various participants when the pricing models are implemented by the DSP 902. Here, the various scripts (discussed above) are provided within the ad tags forwarded to the client. In response to a bid request, the DSP 902 in turn forwards the bid request to various advertisers. The advertisers evaluate the bid request and respond back with a bid and an ad tag of the ad to be displayed in the ad slot (associated with the bid request) in the event of a winning bid. The DSP 902 evaluates the various received bids and forwards one of the bids (e.g., the one with the highest bid amount) to the SSP 904 along with the scripts. The SSP 904 in turn evaluates the bids from the various DSPs 902 and sends the ad tag of the winning bid to the client 912B. The rest of the functions, including measuring and storing viewable time for each displayed ad, are performed similar to those functions performed with the ad server 906 as the participant (in FIG. 9C).

### RTB and CPXs Bids

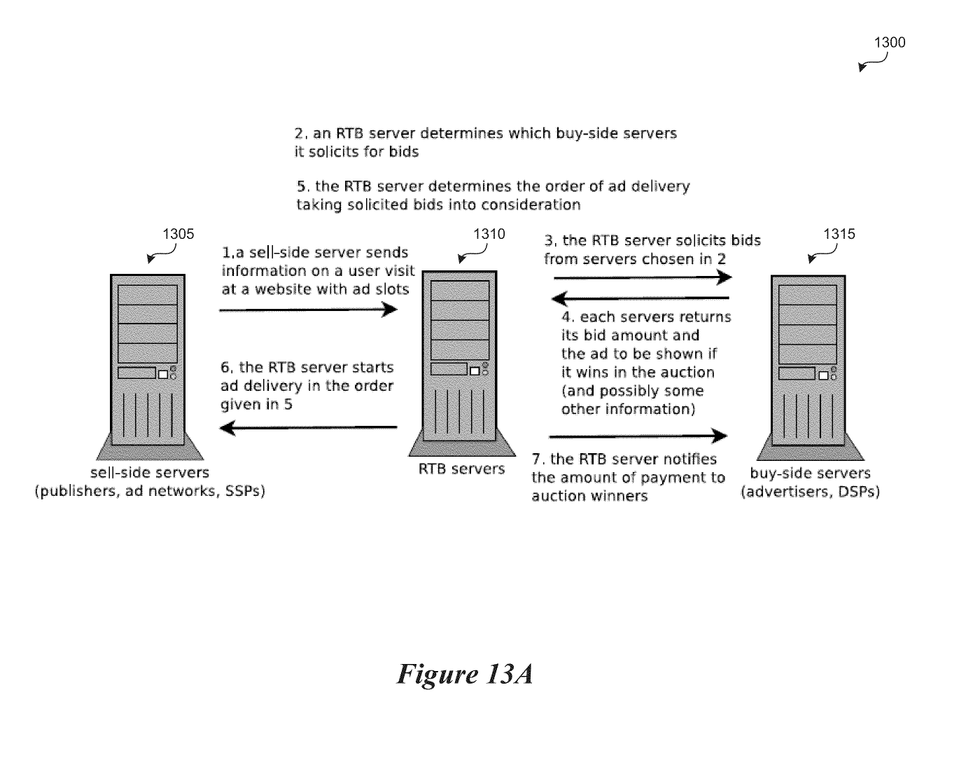

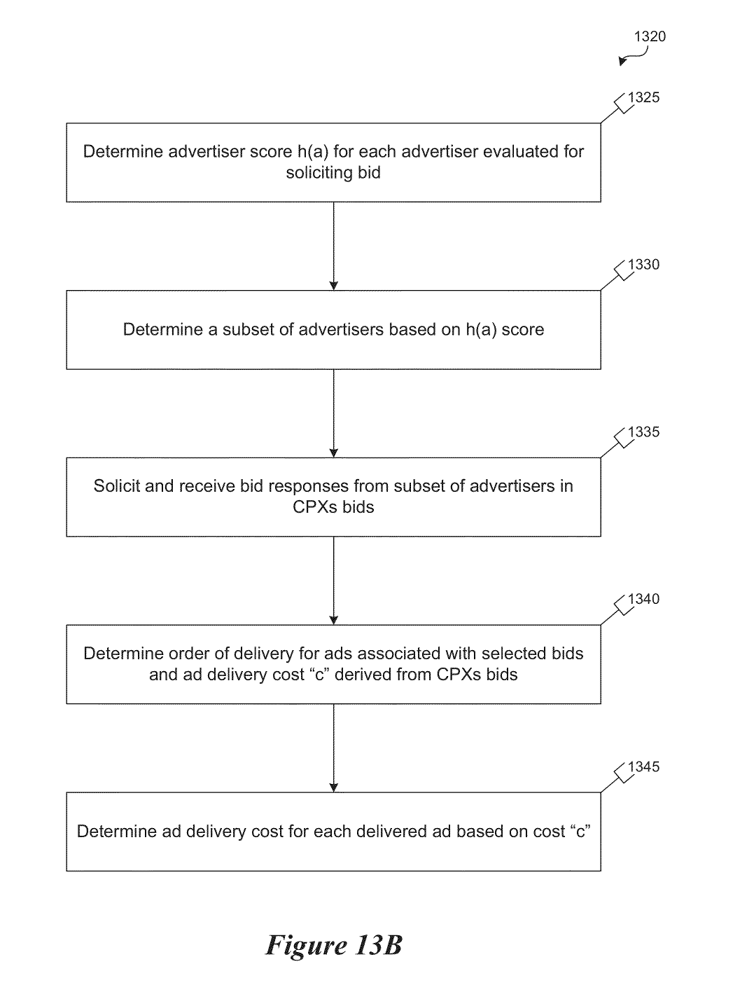

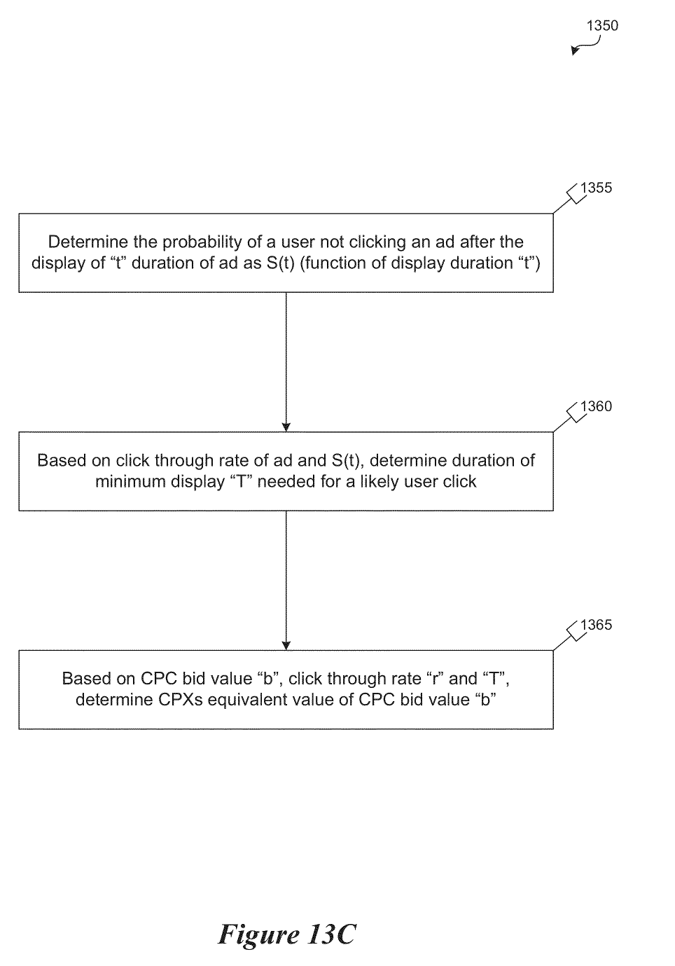

The following discussion provides an overview of an RTB (Real-time Bidding) Platform that can accept an ad bid in the form of CPXs bid and deliver ads. As discussed above, the RTB not only accepts CPXs bid but also bids based on other pricing models (e.g., CPM, CPC, etc.) and can convert the bids based on the various pricing models into a one of the pricing models when evaluating the bids based on various pricing models. FIG. 13A provides a general overview of the interactions 1300 between the various participants of the ad ecosystem when conducting the RTB auction based on CPXs bid. The following discussion provides an overview of a method used to implement RTB auction based on CPXs bid. In the method, when an ad request is received from a publisher (or SSP 1305), the RTB 1310 selects a subset of advertisers (or DSP 1315) to solicit bids for the ad request. Based on the received bids, the RTB 1310 chooses a subset of ads based on the bid amount and delivers those ads in an order based on their associated bid amount. The advertisers are charged by the RTB 1310 when their ads are displayed to the user.

### Selecting Bidders by RTB

As discussed above, an impression (i.e. a chance for ad delivery) is generated when a user u visits website m with ad frames fₘⱼ. The provider (publishers, SSPs 1305, ad networks, ad exchanges, etc.) of this impression notifies possible buyers (RTBs 1310, advertisers, DSPs 1315, etc.) of the impression with information on pairs of the user and the ad frames (u; fₘⱼ) and the lower limit b₀ⱼ on bids for each of the ad frames fₘⱼ (here, if the received information from the provider didn't set the a lower bid limit, the DSPs 1315 can set b₀ⱼ as appropriate). Let A be the set of advertisers (including DSPs 1315 or other RTBs), connected to RTB 1310 conducting auction, where A have the ads suitable for (u; fₘⱼ). Lets assume the number of advertisers to be |A|=N. The RTB 1310 solicits bid from at least n<=N advertisers. In one method, the RTB 1310 determines the subset of advertisers to request bids from based on an assessed score for each advertiser. The assessed score determines the suitability of the ad to the advertiser. In the method, a score h(a) is calculated for each advertiser “a”εA based on their bidding history. In an embodiment, score h(a) of advertiser “a” is calculated based on factors such as: (1) response rate of advertiser “a” when “a” is solicited for a bid; (2) history of “a′”s bid value; (3) win rate of “a” at auction; (4) temporal length of “a′”s ad. Based on the score, the top n advertisers are selected and solicited for bids.

Let a₁, . . . , aₙ denote selected advertisers based on h(a). When a bid is solicited from these advertisers, a bid request is sent including information on (u; fₘⱼ) and b₀ⱼ. When the advertisers want to bid for some of the ad frames, they in turn submit a bid response Dₐ that includes information such as: (1) bid value bₐ in the unit of CPXs; (2) ad length Iₐ; (3) ad content to be delivered (or indicia of the ad content, e.g., an ad tag). In some embodiments, only bids with value bₐ>b₀ are considered (i.e. at least meet the minimum suggested bid value) and others are excluded from the present auction. Of course, in another embodiment, the bids received from the advertisers can be based on other pricing models, such as CPM, CPC, etc., and the RTB 1310 will convert the bids to CPXs equivalent and evaluate the bids (further detailed provided later in the discussion).

### Deciding Order of Ad Delivery and Price

As discussed above, once the bids the received, the RTB 1310 determines an order of delivery for the ads chosen to be displayed to the user and the price to charge the advertisers for ad delivery. The delivery order is determined as a function of the bid values of advertisers a₁, . . . , aₙ. Further, while the price to charge the advertisers for ad delivery can be based on several factors, the resultant time-based cost (i.e. CPXs or CPS) is the same for each of the advertisers who ad was displayed (irrespective of their bid value).

Using information Dₐ received in bid response of advertisers a₁, . . . aₙ, the delivery order of the ads the and price (in CPXs) is determined. The order of delivery is calculated based on data Dₐ₁, . . . , Dₐₙ and each ad is delivered based on the calculated order. Here, let A_{d}={aᵢ₁, . . . , aᵢₖ} be the set of advertisers whose ad is delivered in the order calculated. In one embodiment, the order is determined such that the effect of advertising on user increases progressively. In that case, the ads are ordered in ascending value of bᵢ₁, . . . , bᵢₙ. In another instance, if it is the case that the earlier an ad is served the better the effect of the ad on the user becomes, then the ad delivery order would be the descending order of bᵢ₁, . . . , bᵢₙ values (i.e. ads with higher bids shown first).

The CPXs price “c” for the delivered ad is utilizing the received information Dₐᵢ₁, . . . , Dₐᵢₖ and the order of delivery of the ads (and the associated bid value order). So, in cases when ads are delivered in the descending order, there are at least three ways the cost “c” of the CPXs can be set: (1) if the last ad delivered (in the ad frame) belongs to k-th highest bidder, we take k+1-th highest bid as the CPXs price; (2) if the last ad delivered belongs to k-th highest bidder, we take the average of k highest bids as the CPXs price (here all advertisers are requested in advance to provide their highest possible CPXs that they are willing to pay for, where if the predicted cost will be higher than their bid, then the advertiser is excluded from delivery); (3) if the last ad delivered belongs to k-th highest bidder, we take l(<=k)th bid as the price (here, if l=2, then CPXs “c” can be determined before ad delivery). As discussed above, in any of the cases, CPXs is fixed for each advertiser participating in the present auction.

Ad Delivery Cost Based on CPXs “c”

The method charges for ad delivery using CPXs cost “c” as described above. For each advertiser whose ad was displayed, the delivery cost is computed based on the duration of ad delivery. For example, let us denote the duration of ad delivery by tᵢ₁, . . . , tᵢₖ, where tᵢₗ corresponds to the ad of aᵢₗ (i.e. the display duration for each ad associated with an advertiser in a given ad frame). Then payment Pᵢₗ is given by Pᵢₗ=c/10000·tᵢₗ (i.e. the CPXs value is converted to CPS before multiplying by the display duration to determine the delivery charge). The publisher (SSP 1305, ad network, other RTBs) that offered the impression obtains R=(Σₗ₌₁^{k}Pᵤ)−F as its revenue, where F is the fee for using the RTB 1310. In some instances, the publishers are provided predetermined amount of money while RTB 1310 retains rest of the realized revenue.

FIG. 13A provides a general environment 1300 where the CPXs based bidding can be implemented using an RTB 1310. As discussed earlier, an SSP 1305 sends a user's information and other relevant information when the user visits a webpage with ad slots. The RTB server 1310 determines which DSPs 1315 (or advertisers) to solicits bids for ads to be displayed in the ad slots. Based on the chosen DSPs 1315, the RTB server 1310 sends bid requests. The DSPs 1315 return bid responses (with bid amount and indicia of ad to display) in response to the bid request. The RTB server 1310 determines the order of delivery of the ads based on the received bids and the associated bids amount, the ad characteristics, etc. The RTB server 1310 provides the ads to be delivered in the previously determined order to the SSP 1305 to display to the user. The RTB server 1310 further notifies the DSPs 1315 of the cost of delivery when the ads are displayed to the user by the SSP 1305.

FIG. 13B provides a method 1320 that can be utilized to implement CPXs (or any other pricing model based bidding) based bidding in a RTB. In step 1325, advertisers are evaluated based on a determined advertiser score h(a) to determine which advertisers to solicit a bid for an advertisement to be displayed to a user. In step 1330, a subset of the advertisers (say, n top advertisers) are picked based on their h(a) score with high scores (where higher the score, the better the choice of the advertiser for soliciting bids). In step 1335, bids are solicited and bid responses are received from the subset of advertisers, where the received bid responses include bid amounts in CPXs based pricing. In step 1340, the order of delivery of ads associated with the received bid responses is determined and an ad delivery cost “c” (in CPXs) for the ads to be delivered is determined, where CPXs cost “c” is the same for all delivered ads irrespective of their bid amounts. In step 1345, determine the ad delivery cost for each of the delivered ads (i.e. ads displayed to user) based on CPXs cost “c”.

### CPX<=>CPC Bid Translation

In the previous discussion, it was shown how a CPM bid can be translated to CPXs bid and utilized to compare bids based on different pricing model. In the following discussion, a method is provided for accepting bids in the Cost-Per-Click (CPC) form and transforming them into their CPXs equivalent. The transformed CPXs bids can be utilized by the RTB 1310 to operate using CPXs pricing model in the existing ad ecosystem that utilizes bidding and evaluation on other pricing models such as CPM, CPC, etc.

The method used to transform (translate) CPC into CPXs bid can be equally practiced to translate other pricing models to CPXs bid. In the method, first, the possible duration of ad display that can be purchased in, say cost-per-second basis, with a given CPC bid value is determined. Based on the possible duration and the probability of attracting a user click for the displayed ad within the estimated duration, the CPC bid is accepted. Here, the RTB 1310 accepts the bid when the likelihood of attracting a click is high (for the displayed duration of ad) and hence realizing the CPC bid value as revenue. From the advertiser's point of view, they are still paying CPC bid value only when the user clicks on the ad.

Ad Length Inferred from CPC

If an advertiser bids in CPC, then the advertiser's objective is to acquire clicks. Therefore the ad length needs to be determined for which one can expect the ad to attain the desired CPC. Let “a” denote the ad to be delivered. Further let us assume that ad a has been delivered k times. Further let us assume that the result of the k deliveries consist of a binary vector (c₁, . . . , cₖ), which encodes existence of clicks, and a vector (t₁, . . . , tₖ) to shows the corresponding when the ad was clicked or when the delivery was stopped. Here, cₗ=0 denotes no click on the ad was recorded while cₗ=1 expresses that the user clicked at l-th delivery, and tₗ denotes the time of the click (when cₗ=1) or end time of the delivery (when cₗ=0).

Then the probability S(t) that the present user would not have clicked on the ad at time t can be determined using the function 28 shown below:

$$S ( t ) = {\prod }_{{t}_{l} < t} \frac{{n}_{l} - {d}_{l}}{{n}_{l}} \qquad ( 28 )$$

where, nₗ is the sum of the number of users in the data who hadn't clicked or who were still watching the ad at time tₗ, and dₗ is the number of users in the data who clicked at tₗ. In any case, note that S(t) is monotone-decreasing (i.e. as time progresses and more of the ad is displayed, more and more likely the remaining users will click on the ad). Utilizing the click through rate “r” of the ad (either provided by the advertiser or determined from gathered information), the maximal Tᵣ that might be needed to attract the user's click is set such that S(Tᵣ)>1−r, where 0<=r<=1.

In some embodiment, at each delivery of a, ad length tₐ of a is further set as shown in below function 29, where Cₐ is a constant (to add a guard band).

tₐ=Tᵣ+Cₐ (29)

Conversion of CPC Bids into CPXs Bids

The RTB mentioned above becomes able to accept CPC bids in the following manner. In one embodiment, a database is prepared from which the predicted CTR “r” can be retrieved with a query. The information used to form the query includes, but is not limited to, the information listed below: (1) information on ad a; (2) information on user u; (3) information on ad frame fₘⱼ; (4) user u's time of visit.

The CPC bid “b” can be converted into CPXs bid b_{X} using CTR r and tₐ (determined above), using the following function 30 shown below:

$${b}_{x} = \frac{b \times r \times 10000}{{t}_{a}} \qquad ( 30 )$$

In the above function, the bid “b” and CTR “r” is used to determine the likely realizable revenue from accepting the CPC bid (i.e. the bid “b” is scaled down by the CTR “r” to account for instances when ad is not clicked after a display of the ad). The realizable revenue is then averaged over the duration of display tₐ that needs to be acquired to display the ad before a click can likely be expected. The determined CPS value is then estimated over 10,000 seconds to arrive at the CPXs bid value. This enables the RTB to accept bids in the form different from CPXs and still be able to evaluate the bids based on their potential CPXs value.

FIG. 13C provides a method 1350 for converting CPC based bids into CPXs (or CPS) based bids. In method 1350, the CPC bid is converted into a time based bid (e.g., CPXs, CPS) based on a duration of display time for the ad needed before a user click of the ad is likely. In step 1355, determine the probability of the user not clicking on a given ad after the display of “t” duration of the ad. The probability is determined as a function of the number of users who viewed the ad and clicked the ad before display of “t” duration of the ad and the number of users who viewed the ad and still did not click on the ad after display of “t” duration of the ad. Based on a predicted click through rate of the ad and the probability of the user not clicking on a given ad after the display of ad for a given time period, determine the minimum duration of display time “T” needed for a likely click of the ad by the user. In step 1365, based on the CPC bid amount “b”, the click through rate “r” and minimum duration of display time “T”, determine the CPXs equivalent bid amount of CPC bid amount “b”.

### Ad Targeting

The various pricing models discussed earlier utilize the viewable time as one of the key parameters. The viewable time in turn depends on the user attention (or engagement) to the one or more displayed advertisements. The various participants in the ad ecosystem can enhance the realization under the viewable time by boosting the user attention to the displayed ad. In one instance, serving ads that are relevant to a given user can enhance engagement of the user. That is, by delivering ads that a user is likely to be interested is will increase the attention of the user to the delivered ad. In embodiments, the priority (or order) of ads being delivered to the user should be determined based on the information regarding the user, such as the user's interests, age, gender, etc. Such prioritizing of ads for enhancing user attention is called targeting.

The following discussion illustrates one such method that can be utilized to perform ad targeting. The ad targeting method is explained with the help of the following example. When a user “u” accesses a web page “m”, an impression is generated in an ad slot Fₘⱼ present on the web page “m”. The impression represents an opportunity for advertisers to display their advertisement to the user in the ad slot Fₘⱼ as the user is viewing web page “m”.

When bidding for the impression, the various participants of the ad ecosystem, such as a third-party ad server 906, DSP 902, perform targeting by modifying the cost target (or bid values) for displaying ad “a”. Factors “a”, “u”, Fₘⱼ, etc. used in targeting include, but not limited to, the followings:

Various factors associated with ad “a” that are analyzed during targeting include: (1) the extent of achievement of the campaign that ad “a” belongs to; (2) the remaining budget of the campaign containing “a”; (3) the desired bid amount of the campaign containing “a”; (4) the quality of ad a's creative; (5) whether ad “a” is the candidate for successive delivery (discussed in detail later); and (6) whether “a” is delivered to some other ad slot Fₘⱼ of web page “m”.

Various factors associated with user “u” that are analyzed during targeting include: (1) geographical location of user “u”; (2) IP address associated with user “u” internet connection; (3) cookie information from user's computing device; (4) the kind of the user's browser or OS; (5) language of the user; and (6) the referrer URL (URL of the website visited just before “m”).

Various factors associated with ad slot “Fₘⱼ” and the web page “m” that are analyzed during targeting include: (1) estimated price for the ad slot (CPM, CPS, etc.); (2) average performance of the slot (click through rate, conversion rate, etc.); (3) average viewable time; (4) the number of impressions per unit time; (5) users' average dwell time; (6) the size of the ad slot (height and width); (7) URL of web page “m”; (8) category of “m”; and (9) whether or not we obtain the other ad slots Fₘⱼ in “m” (allowing for ad-follow and other strategies as discussed later).

In the ad targeting method, the bid value for ad slot Fₘⱼ is denoted by “S”, where “S” is a function (eq. (8) shown below) of B(a, t) (a bid value of “a” without applying ad targeting) and T(a, u, Fₘⱼ) (a bid value premium based on the effect of targeting).

S(a,u,fₘⱼ)=λ·B(a,t)+(1−λ)·T(a,u,fₘⱼ) (8)

where, 0<λ<1 is a constant that determines the weight of each of the parameters of eq. (8).

In one embodiment “B” is estimated using the following method: An ad campaign's goals are generally defined in terms of certain metrics such as total number of view-completion for various ads that belong to the ad campaign, total viewable time achieved by all the ads in the ad campaign, etc. Let the achievement of the campaign corresponding to ad “a” at time “t” be denoted by 0<rₐ(t)<1 and let the expected achievement of the campaign at “t” be denoted by 0<\hat{r}_{Q} (t)<1. Using the achieved and expected goal for ad “a”, bid score B(a,t) of ad “a” at time “t” is calculated. At time “t”, comparing ad “a”'s actual achievement rₐ(t) and expected achievement \hat{r}ₐ(t), B(a, t) is computed using the function (9) shown below:

B(a,t+1)=B(a,t)−γ(F⁻¹(rₐ(t))−F⁻¹(\hat{r}ₐ(t))) (9)

where γ is a constant and F:(0,∞)→(0,1) can be any appropriate monotone-increasing function, resulting in the bid score B decreasing if ad “a” is exceeding its goal at time “t” and increasing if ad “a” is underperforming its goal at time “t”.

In one embodiment “T” is estimated using the following method: Let p(a,u) represent the probability that the delivery of ad “a” to user “u” is completed. That is, p(a, u) is the probability that the duration of delivery of ad a becomes equal to or more than l(a) (the length of ad “a”). Further, let Xᵤₘⱼ be the feature vector of user “u” and ad slot Fₘⱼ and βₐ be the feature vector of ad “a”. In one embodiment, T(a, u, Fₘⱼ) is set to \hat{p}(a, u), where \hat{p}(a, u) can be determined using function (10) as shown below:

$$\hat{p} ( a , u ) = \frac{{C}_{0}}{1 + exp ( - {β}_{a}^{′} {X}_{umj} )} \qquad ( 10 )$$

where, C₀ is some constant. Additional details of a method for ad targeting (that can be utilized in the conjunction with other ad targeting methods disclosed herein) are disclosed in, for example, commonly-assigned U.S. patent application Ser. No. 13/540,538.

### Multiple Ad Serving and Viewable Time

In the present invention, the viewable time concept can be extended to other facets of online advertising such as serving multiple ads to a given user through a given ad slot in a web page. There are some known methods to display several ads in a given ad slot. For example, one typical method is to change banner ads every few seconds, even if the ad slot is not visible. However, in the known methods, the ad delivery does not take into consideration if the ad was actually in a viewable portion of the web browser when displayed much less factors such as user attention.

The following discussion provides a method that utilizes viewable time (as a supporting evidence for users' engagement) when displaying multiple ads to a user. As discussed earlier with reference to FIG. 9, ad serving, monitoring and measurement scripts are downloaded to the user's web client (e.g., web browser) along with returned ad tags, which start measuring the viewable time of the displayed ad from the beginning of an ad serving. Here, let “a” denote the ad that is currently being displayed to the user. The amount of total viewable time tₐ acquired by ad “a” in this delivery is compared against the predefined minimum viewable time value Tₐ required for the ad “a” to be considered a successful delivery. If tₐ>Tₐ, the script requests an Ad server 906 (or a SSP 904 or any other participants of the ad ecosystem which conducts auctions of impressions) for another ad tag and obtain the next advertisement a′. When delivery of ad “a” ends, the next advertisement a′ is served to the user. However, if tₐ<Tₐ, the method continues to display the ad to the user and measure the viewable time. The method continues to iterate through the above steps of measuring achieved viewable time and requesting replacement ads when conditions are met until the user's session ends with the web page.

In some embodiments, when requesting for a replacement ad, the method may request and download a number of advertisements and rotate them in the user's web client. In one embodiment of this “download-once” method, the Display attribute of ads are change dynamically, from “none” to “inline” when wanting to show the ad and vice-versa (i.e., from “inline” to “none”) when finished displaying the ad (or excluding ad from displaying).

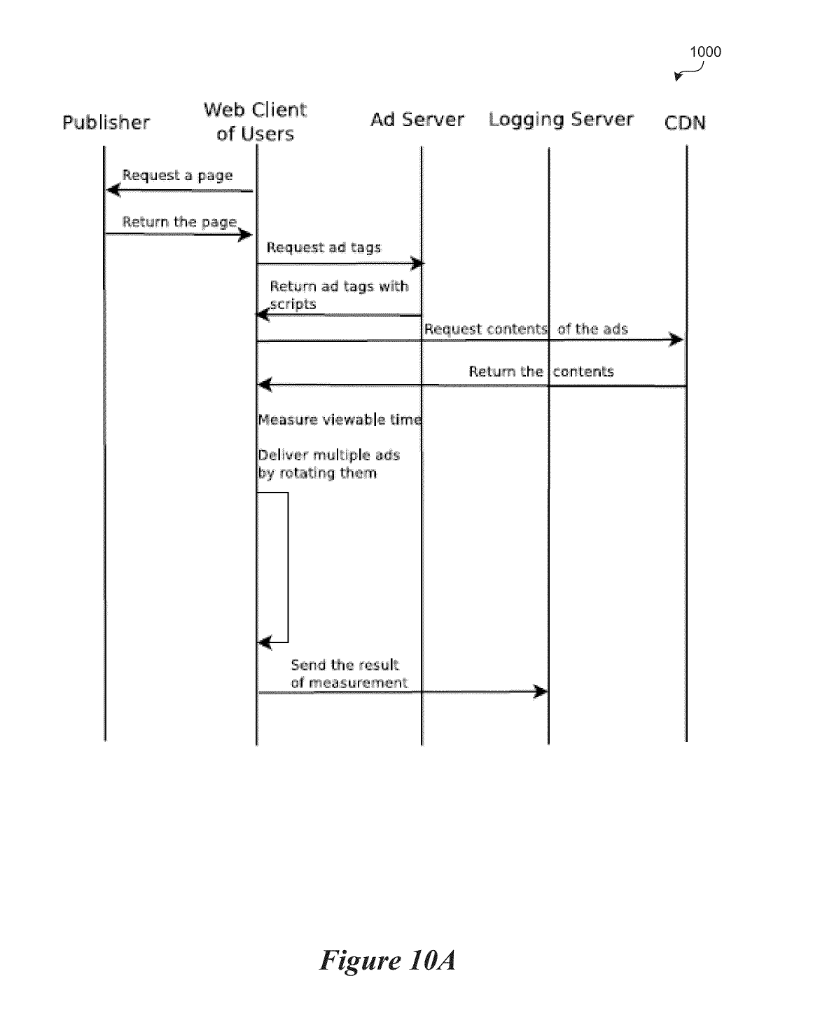

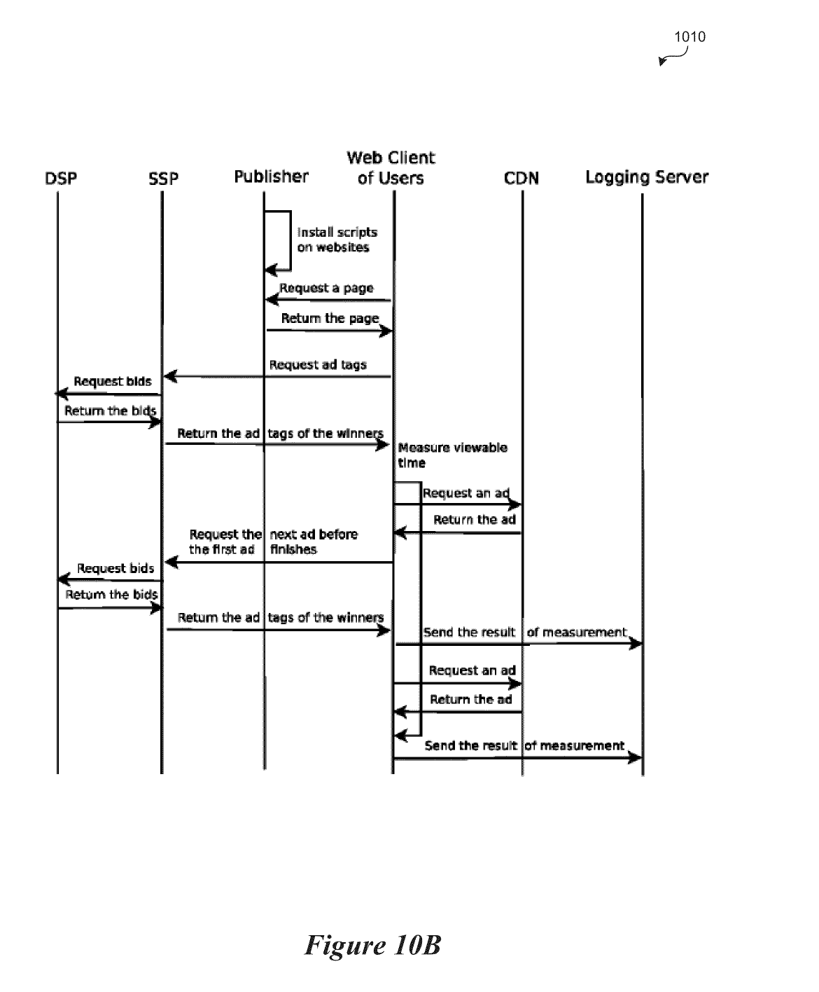

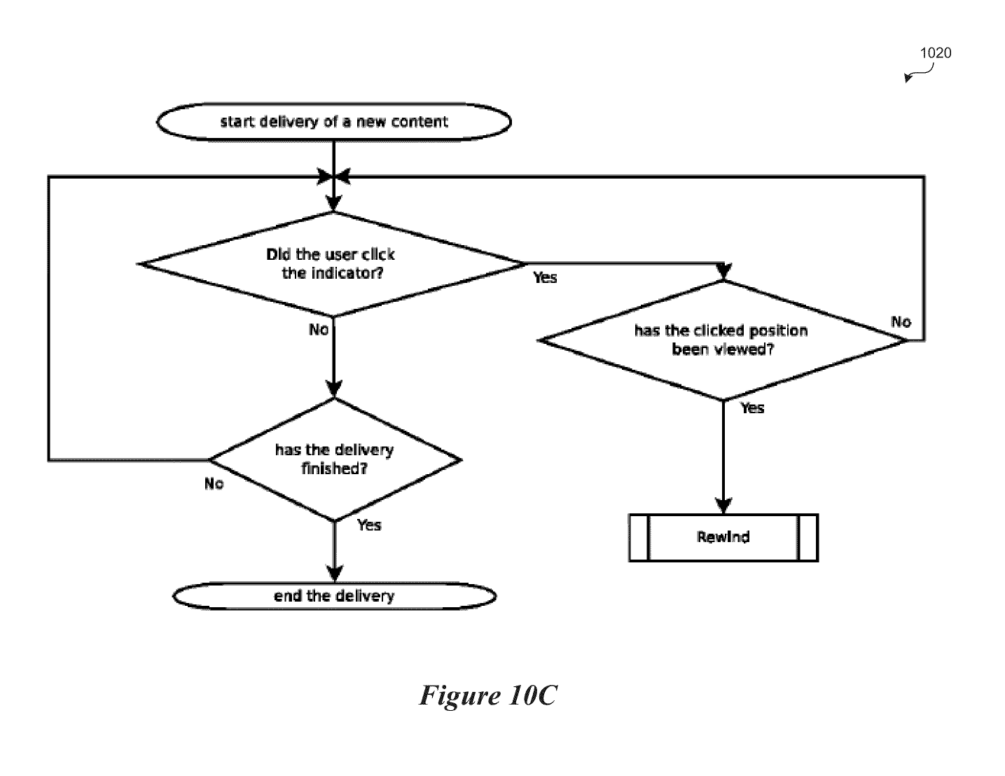

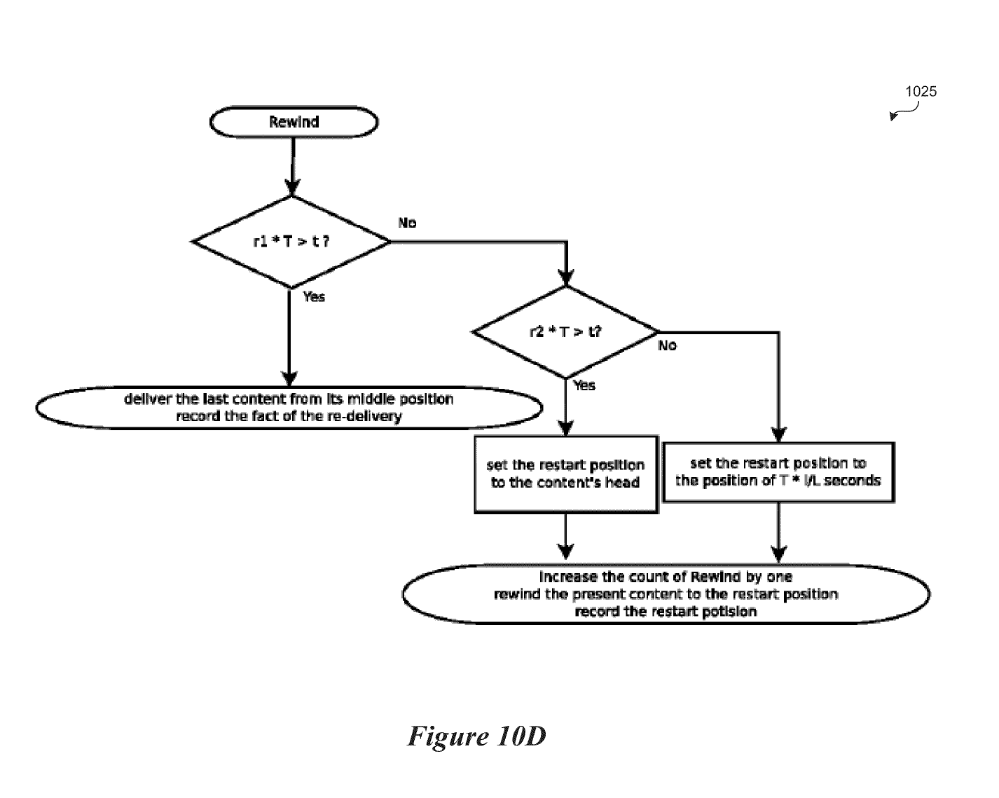

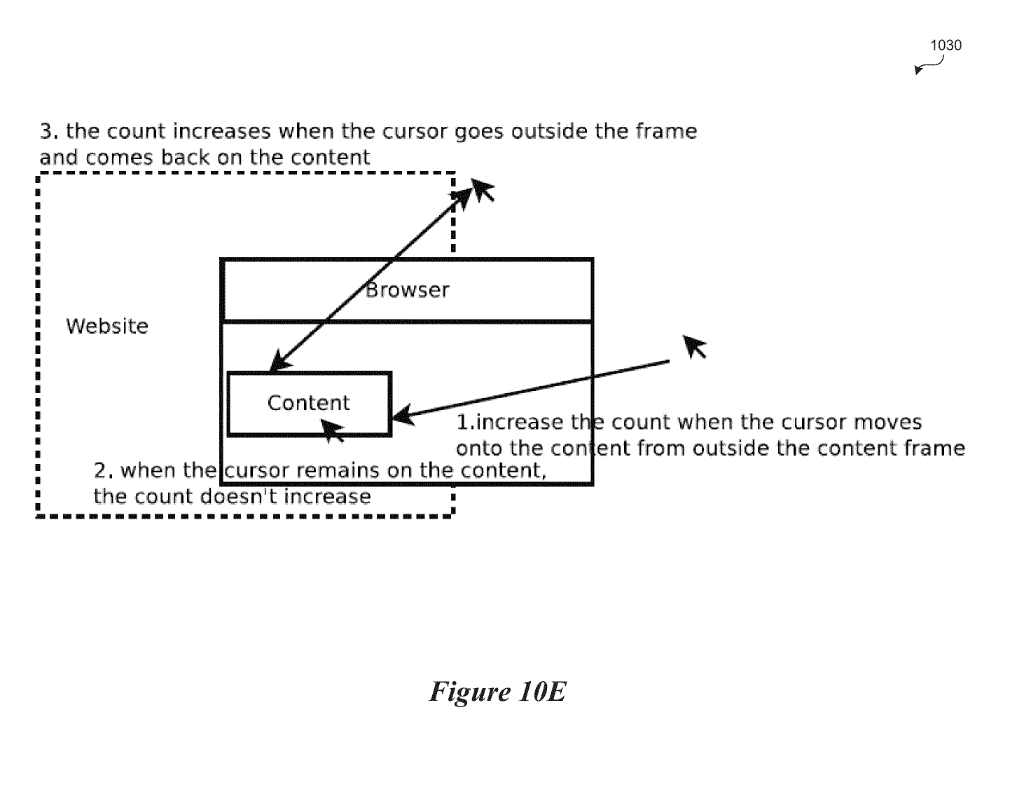

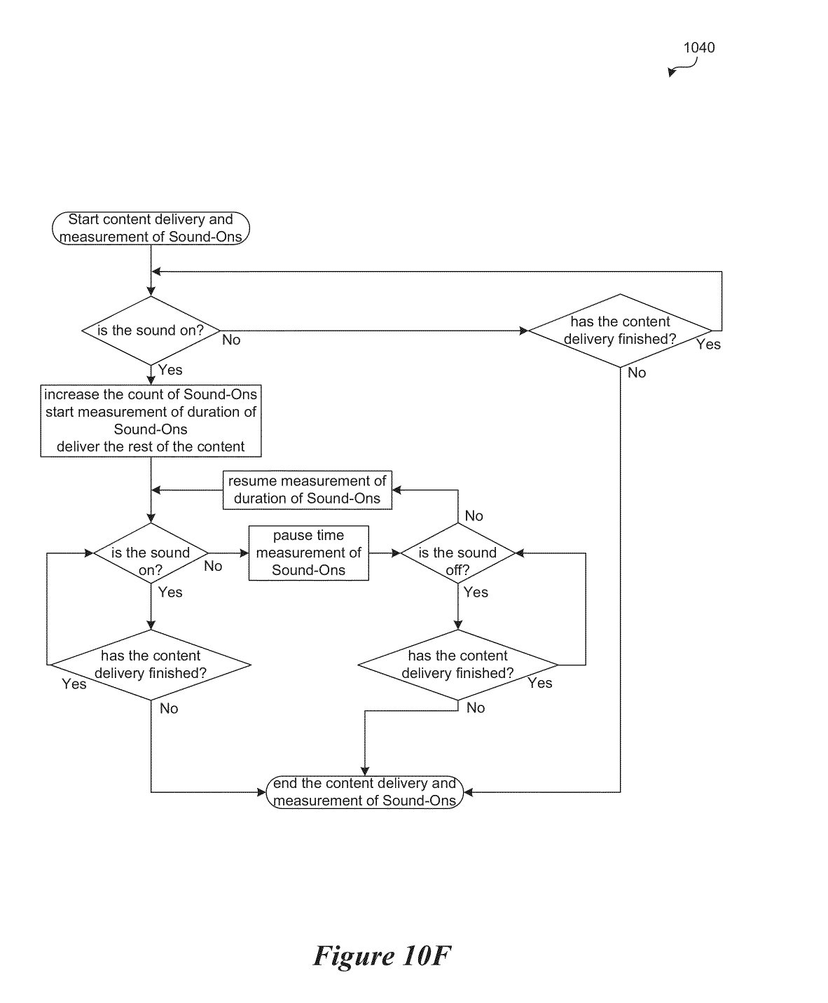

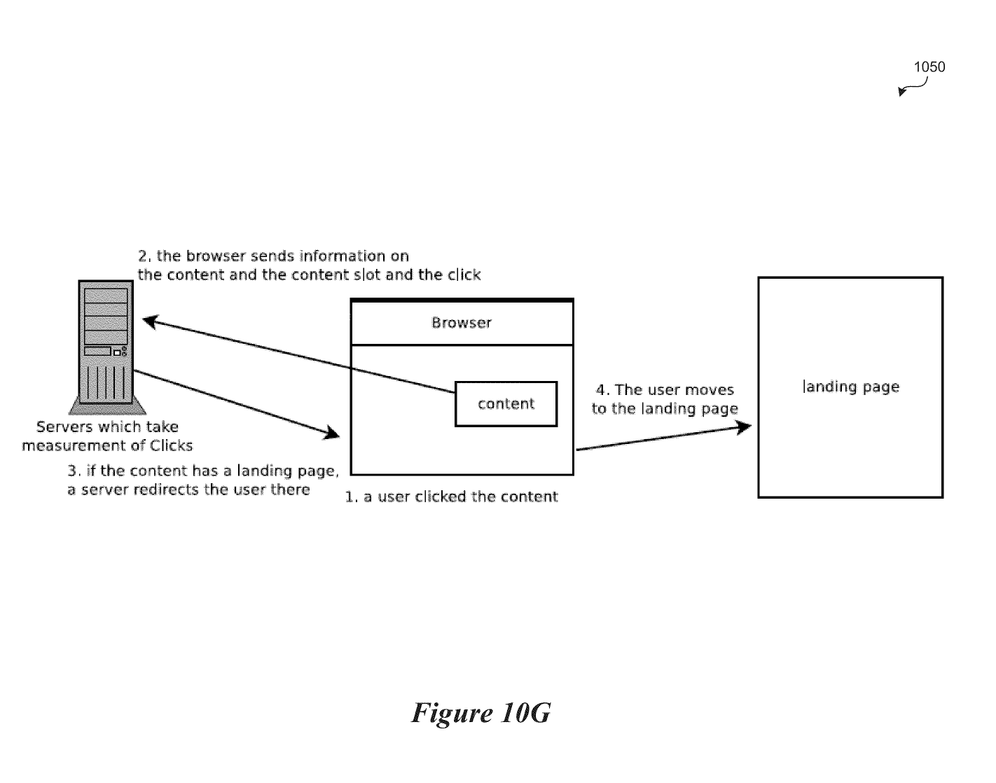

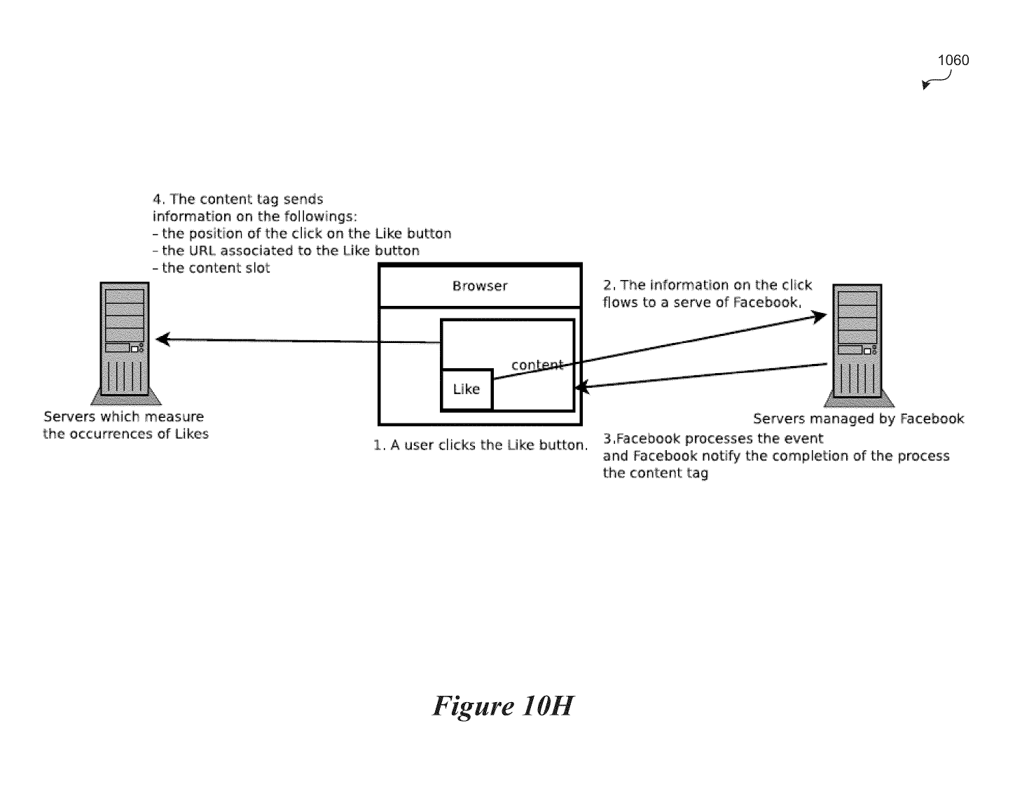

FIG. 10, which includes FIGS. 10A-10D, provide a process overview 1000, 1010 of implementing the multi-ad serving method incorporating viewable time concept. In FIG. 10A, similar to the process explained with reference to FIG. 9 and the above discussion, the web client requests multiple ads as replacement ads when the conditions are met and sends the measured viewable time for each of the displayed replacement ads to the Logging server 908.

In FIG. 10B, in addition to the original ad request, the web client requests replacement ads when the measured viewable time for the original ad meets the predetermined viewable time requirement. In some embodiments, the predetermined viewable time requirement is set to a value lower than the length of duration of original ad such that the replacement ad requests can be sent out before the original ad finishes displaying. In response to the replacement ad request, the SSP 904 and DSP 902 acquire replacement ads to be displayed to the user through a second round of auctions (in reference to the previous round of auctions for the original ad (or first ad) being displayed to the user in the current user session). The web client receives the ad tags for the replacement ads which are then utilized in the multi-ad serving process. The web client further sends the measured viewable time for each of the displayed replacement ads (and the original ad) to the Logging server 908.

### Ad Rewind and User Engagement

In many instances, when serving multiple ads, the users might be interested in viewing a previously served ad. A multi-ad serving method that also enables users to rewind or replay an ad (e.g., a video ad) while measuring the appropriate viewable time generated with the rewind/replay of the ad can help better assess the true effect of the displayed ad on the user and charge the advertisers accordingly. One such method is disclosed below with reference to FIGS. 10C and 10D. In the method 1020, let L denote the length of the ad play-time indicator (e.g., representing the playtime of the ad in percentage scale from 0 to 100) and Tₐ denote the length of ad content “a” being displayed. When a user clicks on a portion of the play-time indicator L to indicate a rewind request, the position “I” of the user click on the indicator L is used to determine if the ad can be re-wound back to the user indicated location. That is, if the ad “a” has only displayed “t” seconds of total Tₐ seconds of the ad and the position “l” indicates a portion of ad “a” that is yet to be played, then the ad cannot be re-wound (as the ad “a” has not played that portion yet). So, no action will be taken when t/Ta<=l/L. On the other hand, if the t/Ta>l/L, then the ad could be re-wound and played accordingly.

When rewinding an ad, different steps can be taken depending on the length of current ad displayed, such as rewind to a indicated position of current ad, play current ad from beginning, play a previous ad, etc. In the method 1025, let 0<r1<r2<1, where r1 and r2 represent ratios (or percentage) of a given ad content at which different functions are carried out (in response to a rewind request). For example, when the duration of ad content played is less than the r1·Tₐ (total duration of ad “a), implying the ad “a” is just about beginning (if r1 is small), then the previously displayed ad is displayed to the user in response to a rewind request. In another instance, if duration of ad content played is greater than the r1·Tₐ (total duration of ad “a) but less than r2·Tₐ, implying the ad “a” is probably played at mid-portion of the ad “a”, then the ad “a” is re-wound back to the indicated location (Tₐ·l/L) in the rewind request. However, if duration of ad content played is greater than r2·Tₐ, implying the ad “a” is almost completely displayed, then the ad “a” is re-wound back to the beginning of ad “a” in response to the rewind request.

The following is a pseudo-code that can be utilized to implement the method 1020 and the rewind function 1025 used in method 1020.

```
/////////////////////////////////////////////////////////////////////////////////////////////////////////////
// the present video content (with information related to it): presentVideo
// the previous video content (with information related to it): previousVideo
// The length of the present content: Ta, the length of the indicator: L,
// the present position: t
rewindCounter(rewindAction){
  I = rewindAction.position
  if(t/Ta > I/L){
    if(r1 * Ta >t){
      presentVideo.rewindTime(t,−1)
      // the present video is rewound and the user moves to the previous
      video
      previousVideo.rewindTime(Tb,tb)
      // the previous video is rewound from position Tb to position tb
      previousVideo.numRewind += 1
      // the number of times of the previous video's Rewind
      deliverVideo(previousVideo, tb)
    }else if(r2 * Ta > t){
      presentVideo.rewindTime(t,0)
      // the present video is rewound from position t to its head
      presentVideo.numRewind += 1
      // increase the number of times of the present video's Rewind
      deliverVideo(presentVideo, 0)
    }else{
      startAt = Ta * I/L
      presentVideo.rewindTime(t,startAt)
      // the present video is rewound from position t to an appropriate
      position
      presentVideo.numRewind += 1
      // increase the number of times of the present video's Rewind
      deliverVideo(presentVideo, startAt)
    }
  }
}
/////////////////////////////////////////////////////////////////////////////////////////////////////////////
```

### Mouse Rollovers and User Engagement

Similar to the rewind monitoring, a user's mouse rollovers may be utilized to assess the engagement of the user and charge the advertisers accordingly. One such method is disclosed below with reference to FIG. 10E. In the method 1030, the length (and time) and the number of times the mouse cursor comes upon the content (e.g., ad) is measured. The measured count can in turn be used to scale the measured viewable time reflecting the increased likelihood of user engagement with the displayed content and hence the increased likelihood of achieving the desired effect on the user.

The mouse rollover tracking is performed through the following method: (1) a tag associated with the content monitors and measures the position of mouse cursor p0 soon after web content c becomes active (e.g., come within visible portion of web browser); (2) the content tag measures position pₜ of the mouse cursor at time t, every i seconds.

In step (2), when comparing pₜ and pₜ₋ᵢ, and if pₜ₋ᵢ of mouse cursor is not on c and pₜ is on c, the tag increases the count of Mouse Rollovers by one. Moreover, if both pₜ₋ᵢ and pₜ are on c, the tag increases the time of Mouse Rollovers by i seconds. In some embodiments, when both pₜ₋ᵢ and pₜ are on c, the count is left unchanged (reflecting possible user distraction and hence not true user engagement).

Sound-ons and user engagement

Similar to the mouse rollover monitoring, a user's sound-ons/offs may be utilized to assess the engagement of the user with the displayed content and charge the advertisers accordingly. One such method is disclosed below with reference to FIG. 10F. In the method 1040, the length (and time) and the number of times the user turned the sound on is measured. The measured count can in turn be used to scale the measured viewable time reflecting the increased likelihood of user engagement with the displayed content and hence the increased likelihood of achieving the desired effect on the user.

This is performed through the following procedure: (1) when web content c becomes active, the content tag turns the sound off (requiring an active user action to turn the sound on and indicating user interest in the displayed content); (2) when the user turns the sound on, the tag increases the count of Sound-Ons by one. Further, the tag begins measurement of the duration of sound-ons; (3) when the user turns the sound off, the tag pauses the measurement of the length of sound-on; (4) When the user next turns the sound off and later turns on again, the tag doesn't increase the count, but reactivates the measurement of the duration. Here, the measured duration of time when Sound was on can be considered an equivalent measurement of viewable time (capturing the possible duration of user engagement with the displayed content). On the other hand, the count is used to scale the measured viewable time and is accordingly increased conservatively (i.e. no count increase every time the user turns the sound off and on).

### Total Dwell Time and User Engagement

The Total Dwell Time is the sum of the duration of Mouse Rollovers and that of Sound-Ons. The user is expected to focus on the web content during the time and the total dwell time can be referred to as an indicator of the extent of how much the content draws users' attention. Total Dwell Time metric can be measured content-wise or campaign-wise, according to the client's request.

### Clicks and User Engagement

Similar to the mouse rollover monitoring, a user's clicks may be utilized to assess the engagement of the user with the displayed content and charge the advertisers accordingly. The clicks measurement incorporates both the spatial and temporal position of the user's present engagement in the content with the existing and widespread measure of the number of clicks. Using the clicks measurement, it can be accurately determined which part of the content is effective to users.

One such method is disclosed below with reference to FIG. 10G. In the method 1050, when the user clicks the content, the user's browser makes connection to a server which takes measurement of Clicks. The browser sends information which may include, but not limited to, the following: (a) the spatial position of the click in the content frame (e.g., ad slot); (b) the temporal position of the click in the content; (c) the URL of the landing page for the content (if it exists). The server that receives the gathered information organizes the information content-wise on record and redirects the user to the landing page when necessary.

### Facebook Likes and User Engagement

Similar to the mouse rollover monitoring, a user's indication of an interest in a content (e.g., through a Like click) may be utilized to assess the engagement of the user with the displayed content and charge the advertisers accordingly. In the instance of Facebook, the Like counts of a content, which represents the number of times the Facebook Like button was clicked for the content, can be utilized to determine both a given user's interest and the extent of user interest with the content. A user's interest can be used to scale the measured viewable time of the content to show not only the increased chance of having achieved the desired effect on the user, but also the guarantee that the user had a positive association with the content (indicated through the Like click).

The monitoring of Likes can be performed using the method disclosed in FIG. 10H. In the method 1060, when a user clicks the Facebook Like button in the content being delivered, the Like button sends information to a server of Facebook, which increases the number of Likes of the corresponding content by one. The server of Facebook then notifies the content tag (associated with the content) of the increment. The tag in turn communicates the Like count to a measurement server, where the server receives and stores information including, but not limited to, the followings: (a) the temporal position of the click on the Like button; (b) the URL that the Like button has; (c) the information on the content.

### Ad Follow

As discussed earlier, the various pricing models discussed earlier utilize the viewable time as one of the key parameters. The viewable time in turn depends on the user attention (or engagement) to the one or more displayed advertisements. The various participants in the ad ecosystem can enhance the realization under the viewable time by boosting the user attention to the displayed ad. In one method, user attention to the displayed ad can be booted by ensuring the user watches the displayed ad from beginning to end. Further, the effect of viewing a complete ad on the user is far more valuable to the advertisers than just the effect achieved from the user viewing only a portion of the displayed ad.

The following discussion provides a method that can be utilized by participants of the ad ecosystem to implement an ad-follow system that displays an ad to the user across web pages (when possible) until the ad is completely displayed. In the method, when a new impression i₀ is generated for user “u” in the middle of an ad serving of advertisement a₀ to “u” (and the present one loses visibility), the new impression i₀ is evaluated for acquisition when possible. A new impression i₀ can be generated for user “u” in many ways, including when the user migrates to a different web page, or to a different portion of the current web page with a new ad slot, etc. If i₀ is offered by the publisher (or acquired through an auction) whose web page generated the impression and the offered impression i₀ meets conditions associated with displaying the ad “a₀” (e.g., targeting conditions, advertiser requirements, etc.), the ad a₀ is displayed to the user “u” from the point that the delivery of a₀ stopped at the previous ad slot it was being displayed in.

The various conditions associated with displaying the ad “a₀” in new impression i₀ includes, but not limited to, one or more of the following: (1) the appropriateness of a₀ for i₀ in quality, category, etc.; (2) the predetermined viewable time to achieve for ad is still unmet (determined based on the difference between the last time viewable time was measured for “u” and the time point 6 was generated); (3) whether the page that generates i₀ is different from the page that a₀ is currently being displayed to “u” in; (4) whether the ad slot that is currently serving a₀ is not visible.

Further, when utilizing ad-follow method, the ad “a₀” is chosen such that it maximizes the realization for the participants when another ad slot needs to be acquired to meet the display conditions required for ad “a₀”. Here, let a₀; a₁; . . . ; aₙ represent the group of ads that are appropriate for i₀. Further, let vⱼ(j=0; . . . ; n) denote the bid value (say in CPV) of corresponding ad “aⱼ” and let pⱼ denote the probability that the full bid value is earned (i.e. CPV is fully realized by meeting the minimum viewable time required) when aⱼ is delivered for i₀.

Moreover, let α1(a) be the probability that user “u” generates another impression i₁ that aⱼ can be served in within time/after the ad delivery to i₀.

In the method, a score S(aⱼ) is calculated for each aⱼ with the function (11) as shown below:

S(aⱼ)=vⱼ·(pⱼ+(1−pⱼ)·α₁(αⱼ) (11)

The ad aⱼ with the highest score represents the highest chance for realizing the full value of the bid amount by meeting all the display conditions required for ad aⱼ. So, the ad “a” to be delivered to user is a=argmaxS(aⱼ). The probabilities can be calculated using the appropriate method used with the pricing model as discussed earlier. For example, for CPV, the probability is determined as a function of the predetermined viewable time to be achieved for the ad aⱼ and the history of the impression achieving those viewable time. Of course, this method to compute the score is just an example and the participants can utilize other machine learning method to calculate the score of each ad when evaluating the best ad to serve the user.

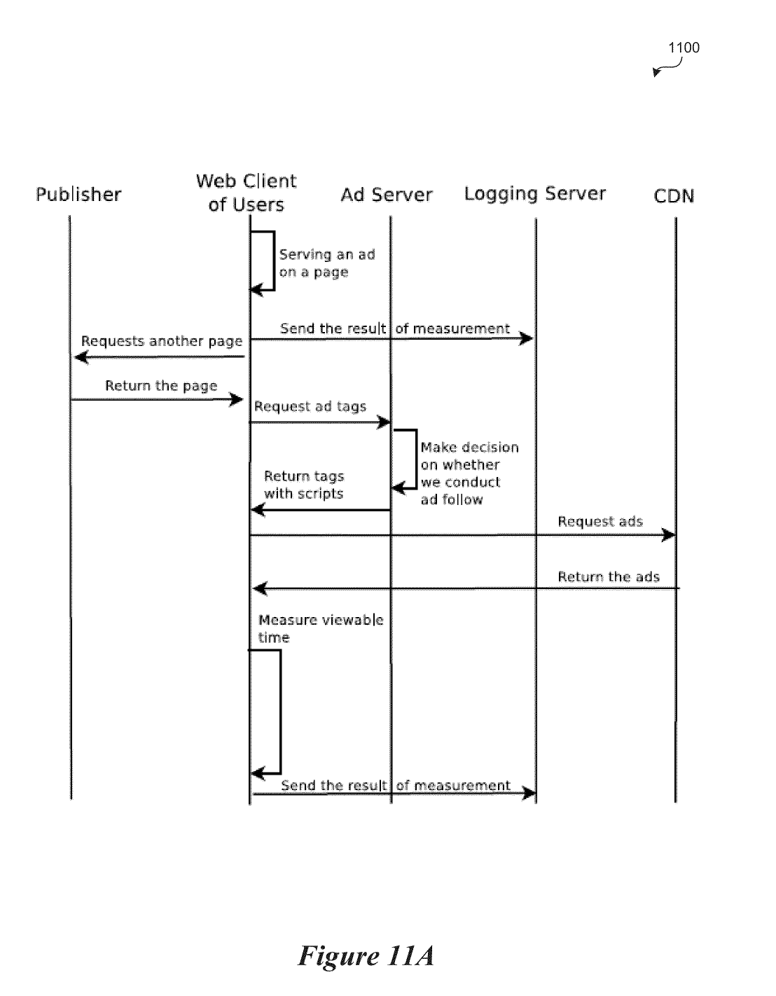

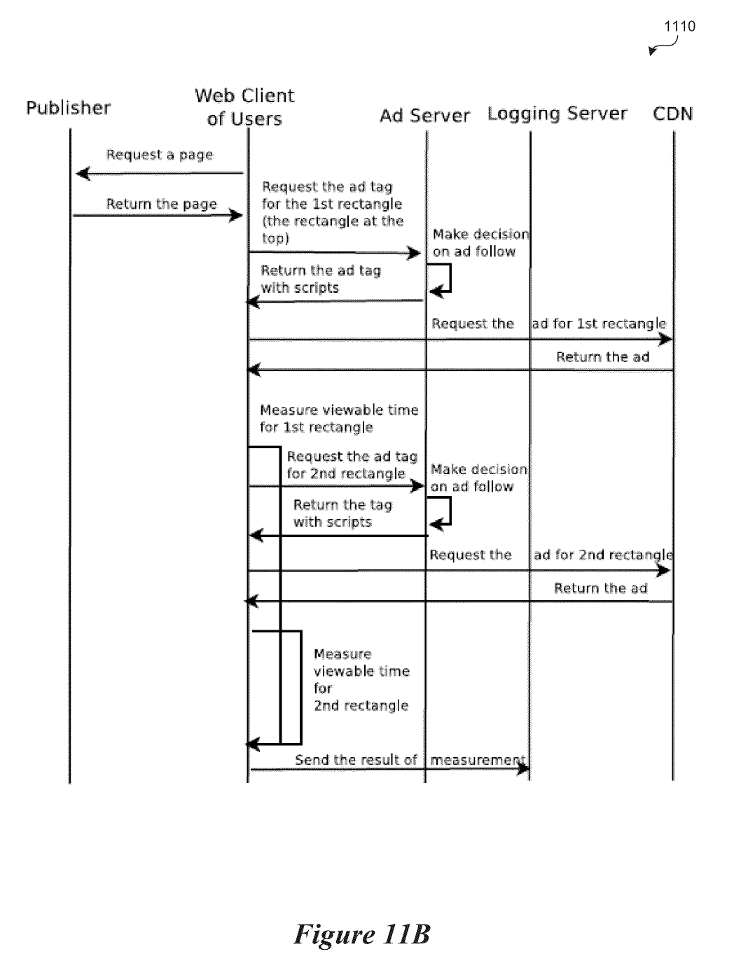

As discussed above, the method of ad-follow thus facilitates one to complete serving an ad even if the user moves to another page in the middle of the ad delivery. FIG. 11A shows a process diagram 1100 for a use case where one ad is delivered across two pages. FIG. 11B shows another sequence diagram 1110 for a use case where one ad that was delivered in a first ad slot (also referred to as “ad rectangle”) was later served in a second ad slot as the user scrolled away from first ad slot. Here, the Ad server decides which ads to serve the user when an ad request for the user is received (in the form of ad tag requests). The Ad server evaluates the previously served ad and decides whether to provide a new ad or continue to display the present ad (using monitored playtime information of the previous ad display) to the user in the second ad slot (associated with the ad tag request).

Also, in the process 1110, if the ad displayed in first ad slot is continued in second ad slot, the measured viewable time of first ad slot and second ad slot represents the total viewable time achieved for displayed ad. The rest of the process of monitoring and logging viewable time is similar to process discussed in FIG. 9. In the above described methods and processes, the user's identity is administered by a logging server that stores the user ID stored in cookies of the browser, or it is administered by sessionStorage, functionality offered by JavaScript. However, we may use some other method to confirm users' identity, such as the unique user_id number provided by RTB in each ad bid request.

### Measurement of Effectiveness of Ad Campaign

In the present invention, the impact of an ad campaign (which includes one or more ads displayed to one or more users over a period of time across web pages) on users can be measured using the measured viewable time of each of the one or more ads of the ad campaign that were displayed to the users. One common metric used to measure impact in the marketing industry is the Gross Rating Point (GRP) achievable for an ad campaign through television. An equivalent GRP (eGRP) metric for online advertising that allow marketers (and advertisers) to easily compare and assess the value of an ad campaign and its impact on the users will be very valuable. The following discussion provides a brief background on calculating GRP and how an eGRP can be calculated using the measured viewable time of the various ads of the ad campaign.

As discussed above, GRP is an effectiveness metric used in TV advertising, and takes into consideration the frequency of the ad being broadcasted and the reach of the delivery (defined as the ratio of the total number of viewers to the size of the advertisement's target). GRP can be computed using the below function (12):

$$GRP = 100 \times \frac{r}{R} \times f \qquad ( 12 )$$

where, R is the total number of latent targets for the ad, r is the realized number of viewers who are targets, and f is the frequency of the delivery.

In an embodiments, when the viewable time for the ads served to the users can be measured (at least for a material subset), the notion of viewable time can be incorporated into GRP and used to calculate it for web content c (such as web pages) using function (13) shown below:

$$GRP 100 \times \frac{{\sum }_{u ∈ Uc} ( {\sum }_{v ∈ Vu} r ( {t}_{v} ) )}{{R}_{c}} \qquad ( 13 )$$

where R_{c} is the number of latent targets for content c, Vᵤ is the set consisting of time of deliveries of content c to user u, tᵥ is the length of engagement (viewable time) when user u is viewing content c in opportunity v, and r(t) is the (normalized) effect of the content when it is viewed until time t. Here, 0<r(t)<1 (i.e. a weight).

In addition, the modified version of the GRP metric can be compared to GRP metric of TV advertising. In embodiments, the modified version effective GRP (eGRP) can be derived using the function (14) shown below:

$$eGRP = 100 \times \frac{{\sum }_{m ∈ M} {\sum }_{u ∈ Um} {\sum }_{v ∈ = Vu} w ( m , u ) r ( {t}_{v} )}{R ( M )} \qquad ( 14 )$$

where, M is the set of media to which the content (e.g., an ad, an advertiser owned web page, etc.) is delivered, Uₘ is the set of users who visited medium m, Vᵤ is the set consisting of measured viewable time for each delivery of a corresponding content delivered to user u, and R(M) is the total reach of M.

Further, w(m, u) is a function of (m, u) and its value determines the weight of (m, u). Since online advertising is different from TV advertising, the true effect of online advertising on the users is augmented accordingly. In one embodiment, by setting w(m, u)=1 (a weight to augment the true impact of online ad campaign), the value of online ad delivery is considered to be the same as that of TV ad campaign. On the other hand, by setting w(m, u)=0 when user u visited web page m through clicking an online ad, at least a portion of overestimation of the size of the advertisement's reach (i.e. by not double counting a user's viewing of an ad and an associated web page arrived through the ad) can be avoided.

Further, for a given bid value (based of any of the pricing models discussed earlier), an achievable eGRP can be estimated. In embodiments, the eGRP achievable for a CPXs based bid of “b” value from an advertise can the determined using function (15) as shown below:

$$eGRP = 100 \times \frac{{\sum }_{m ∈ M ( T )} {\sum }_{u ∈ {U}_{m} ( T )} w ( m , u ) W ( m , u , b ) {f}_{m} ( u ) \hat{r} ( m , u )}{R ( M ( T ) )} \qquad ( 15 )$$

where, T is the content's targeting attribute, and M(T) and Uₘ(T) are the set of media and users with the specified attributes T respectively. Further, W(u, m, b) is the probability of winning an impression with attribute (m, u) by means of bid value “b”, and fₘ(u) is the estimated number of times user u visits m, and 0<=\hat{r}((m, u)<=1 is the estimated effect of one ad delivery to (m, u) (i.e. the effect of online media m on user u). By plugging in the reach of the TV advertising campaign into R(M(T)), the GRP of TV advertising can be compared with that of online advertising eGRP.

Estimation of eGRP for a Given Ad Campaign

In calculating eGRP for a campaign C, the actual form of w and r need to be specified. The function (15) used to calculate eGRP shows that we can calculate it by giving the estimated size of reach R(M) of M. Further, the effective reach rₑ(m, u, v)=w(m, u)·r(tv) obtained through visit v by user u at medium m. Also, the reach R_{TV} of TV advertising can be utilized as R(M) when comparing the reach of TV advertising to online advertising. Here, the reach of TV advertising includes but not limited to: (1) the number of households which have a chance to be exposed to the TV ad; and (2) the number of people who have a chance to be exposed to the TV ad estimated from the above estimated number of households.

In addition, let tv=L_{TV} for r(tv), where L_{TV} is the length of TV advertisement. Here, both R_{TV} and L_{TV} are given by the advertiser of campaign C. Finally, w(m; u) is set as the ratio of the sum of area of ad slots which deliver ads concerning C to the area of the user's browser (effectively capturing the divided attention of the user in proportion to the relative display area of ad content). Further, r(tv) can be restricted to value less than 1 (to ensure conservative estimate of ad campaign's impact), but may permit the violation of this condition (say, r(tv)=1 when r(tv)>1, if necessary). Utilizing the above described assumptions and values, in one instance, the following method can be utilized to determine eGRP. In the method, for a user u who visits a web page m, the ads of campaign C are delivered in ad slots (also referred to as frames) {fₘⱼ}ⱼ₌₁^{k}.

Here, let S_{b}(t) be the visible area of the user's browser to the user at time t. Further, let S(t) be the sum of area of ad frames {fₘⱼ}ⱼ₌₁^{k} visible at time t. Also, let S be the average size of S(t) over time interval (t; t+i), where i is some constant determined in advance. That is, S can be defined as:

$$S = \frac{1}{i} {\int }_{t}^{t + i} S ( t ) d t \qquad ( 16 )$$

Further, the average visible area is considered since there are rich media which have ad frames that can be expanded by the user's mouse-over on the ad. Here if the averaged time intervals are sufficiently small, then the value of S can be expected to identical to S(t) (muting the averaging process). Similarly, the average of the browser size S_{b}(t) can be calculated and denote as S_{B}. Also, the effective viewable time vₑ(t) at time t=0 is set to 0 (vₑ(0)=0). The vₑ(t) is updated periodically applying the following formula (17):

$${v}_{e} ( t + i ) = {v}_{e} ( t ) + \frac{S}{{S}_{B}} i \qquad ( 17 )$$

Here it is assumed that at least one of {fₘⱼ}ⱼ₌₁^{k} is in viewable state during interval (t; t+i). Further, when the user scrolls past a current displayed ad “m” when measuring viewable time for the displayed ad, the measurement is paused if the ad “m” is outside the visible region of the user's browser. If another ad “mₐ” belonging to the ad campaign enters the visible region of the user's browser, the measurement of viewable time for the new ad in visible region is started as vₑ(mₐ, u, v).

Similarly, when the user moves to owned media mₐ through clicking one of ads delivered to {fₘⱼ}ⱼ₌₁^{k}, the measurement of vₑ(m, u, v) on m is ended and the measurement of vₑ(mₐ, u, v) is started. Also, vₑ(mₐ, u, v) is update based on OMVT (Owned Media Viewable Time as discussed earlier). Since mₐ occupies the whole browser, the effect of OMVT is not weighted lower and vₑ increases at the same rate as OMVT does. The online viewable time vₑ(m, u, v) or vₑ(mₐ, u, v) of u is gathered when u leaves m or mₐ (and ends session). Further, unlike the GRP, the eGRP based purely on viewable time captures the reduced effect of displaying the same ad multiple times to the same user. For example, the viewable time assessed every time a given ad is displayed to the user reduces as the ad is redisplayed to the user and the user pays less and less attention with every redisplay of the ad.

However, in GRP, such repeated displays of an ad are still counted as a complete viewing by the user. That is, the GRP estimated for a TV ad campaign overestimates GRP by counting any viewer (watching or sleeping) in front of TV as having viewed the ad. Further, as discussed above, in online ad, the later delivery of the same ad might have lower viewable time if the user had already seen the ad before.

So, to compensate eGRP and make it comparable to the (overestimated) GRP, we add a factor Pᵣ·L. In one embodiment, value Pᵣ·L_{TV} (0<=Pᵣ<=1) is added to viewable time vₑ(m, u, v) for a given ad every time a user watches an ad of campaign C after the first display of the given ad.

For example, if Pr=0.5, it can be interpreted in the following manner: If an ad is delivered twice to a user, one delivery captures the user's attention and the ad is consumed completely; and in the other delivery, the user focuses on other contents than the ad and the advertising effect is possibly proportional to the display time (which can be further weighted according to the relative size of the ad to the browser). So, eGRP using vₑ(m, u, v) obtained above can be defined as shown in following function (18):

$$eGRP = 100 \times \frac{{\sum }_{m ∈ M} {\sum }_{u ∈ Um} {\sum }_{v ∈ Vu} ( {v}_{e} ( m , u , v ) + {P}_{r} \cdot {L}_{TV} )}{{R}_{TV} \cdot {L}_{TV}} \qquad ( 18 )$$

That is, eGRP is equal to the total online viewable time acquired divided by the product of the reach of TV advertising and the length of the TV ad (plus the additional point, Pᵣ times the total number of impressions of a given ad). If the ad length of the online ad is same as that of the TV ad, then this metric is a comparison between the reach of the TV ad and the total number of viewers of online ads. Even if the lengths differ, the GRP and eGRP can be compared by multiplying eGRP by some appropriate factor (to scale for the differing lengths). Further, it should be noted that for an ad campaign with multiple ads, in one embodiment, eGRP can be computed using function (18) for each ad of the ad campaign separately and the total sum of the eGRP of all the ads would represent the overall eGRP of the ad campaign.

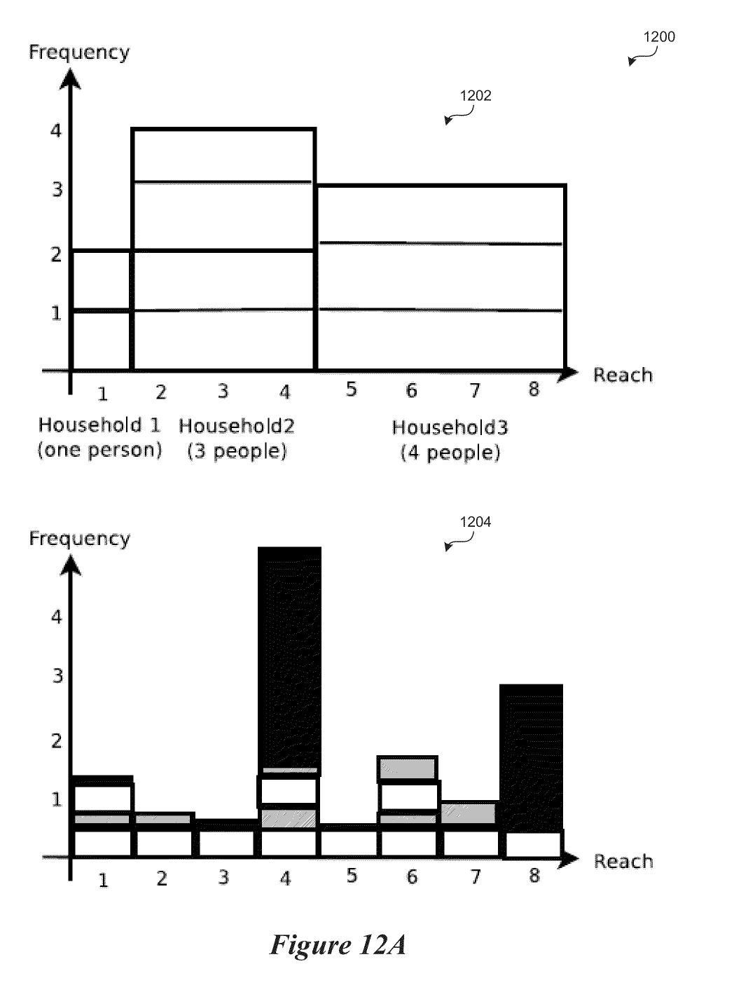

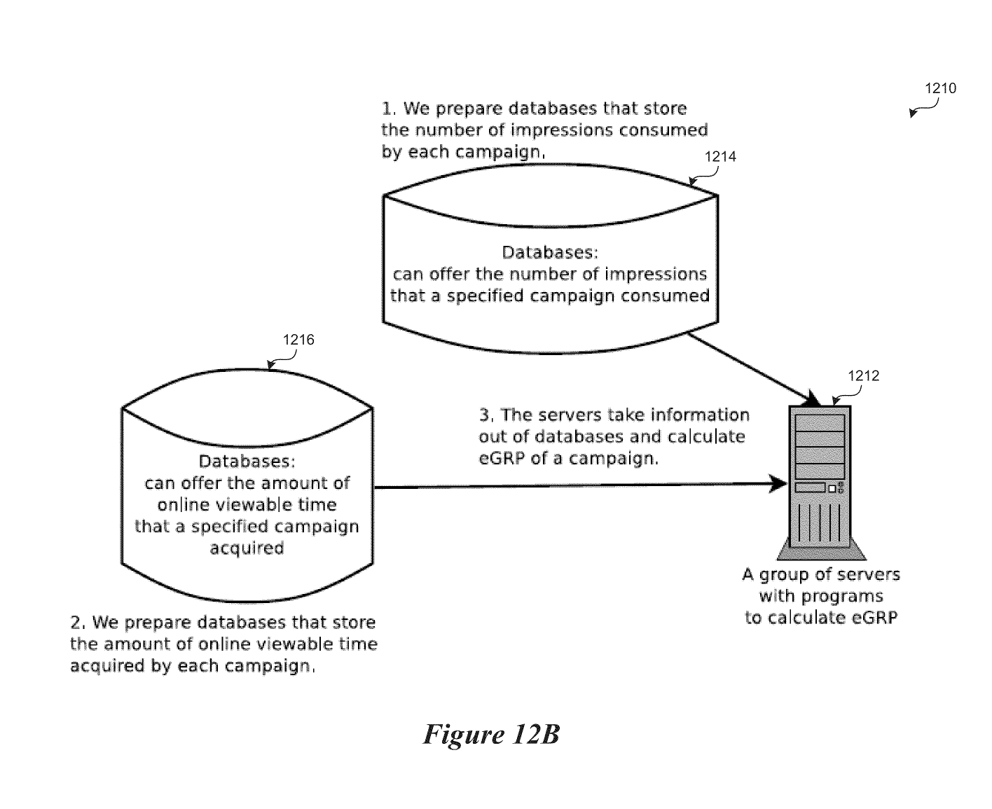

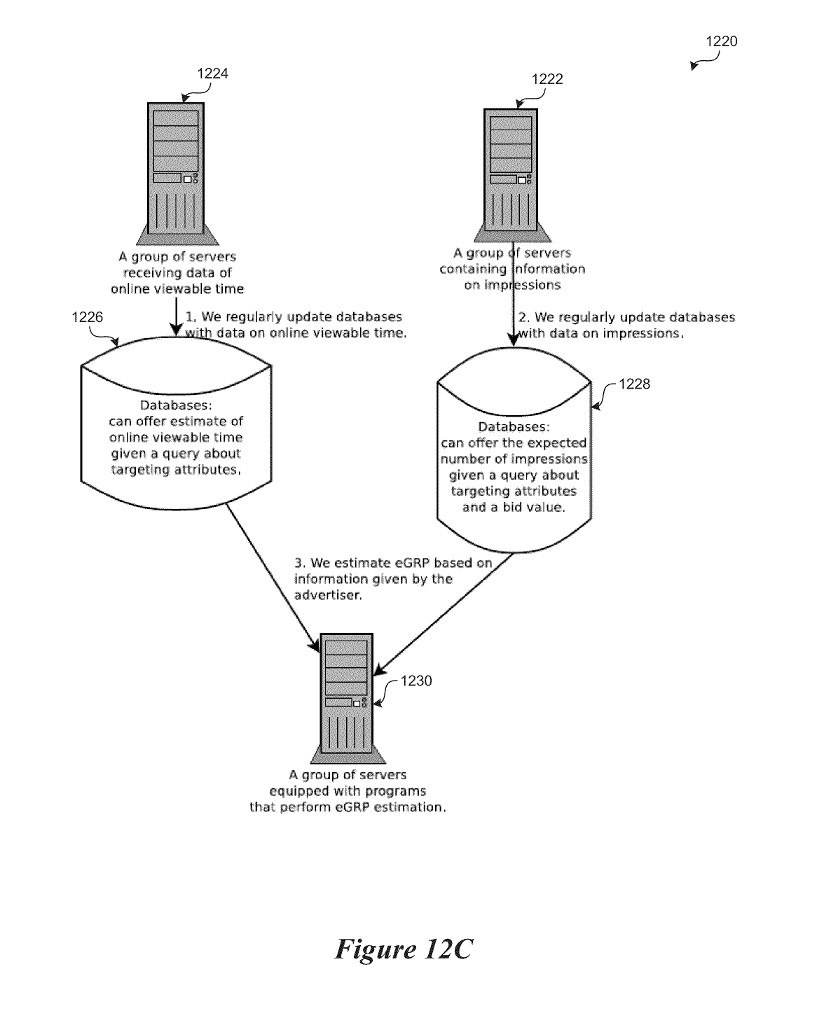

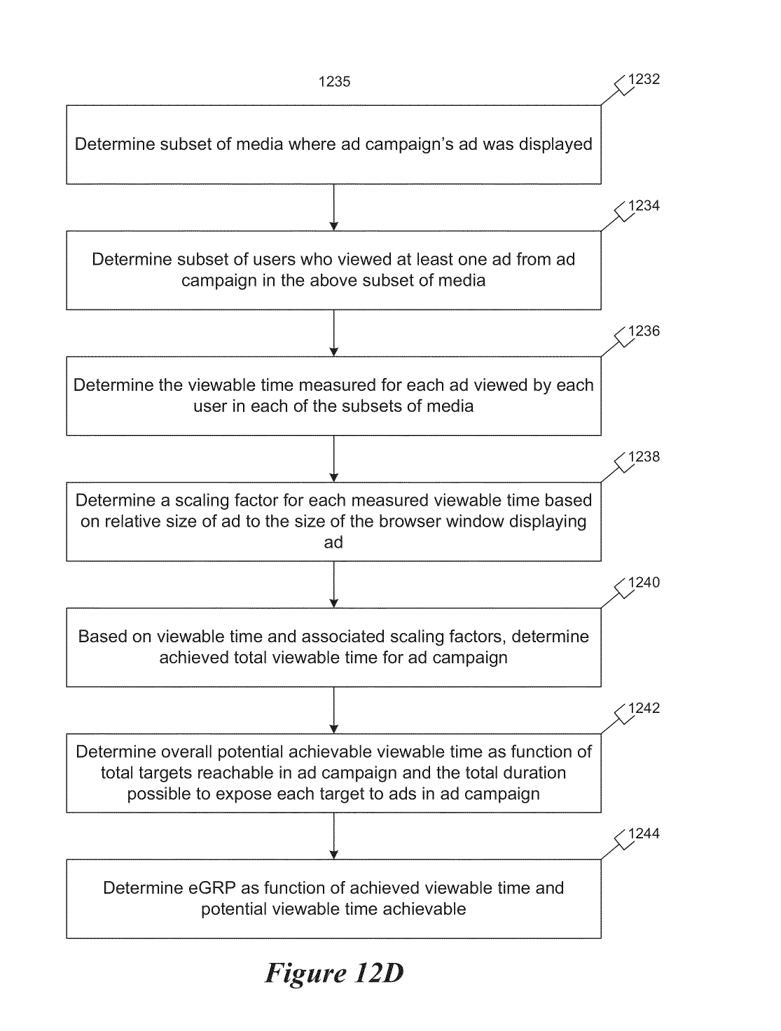

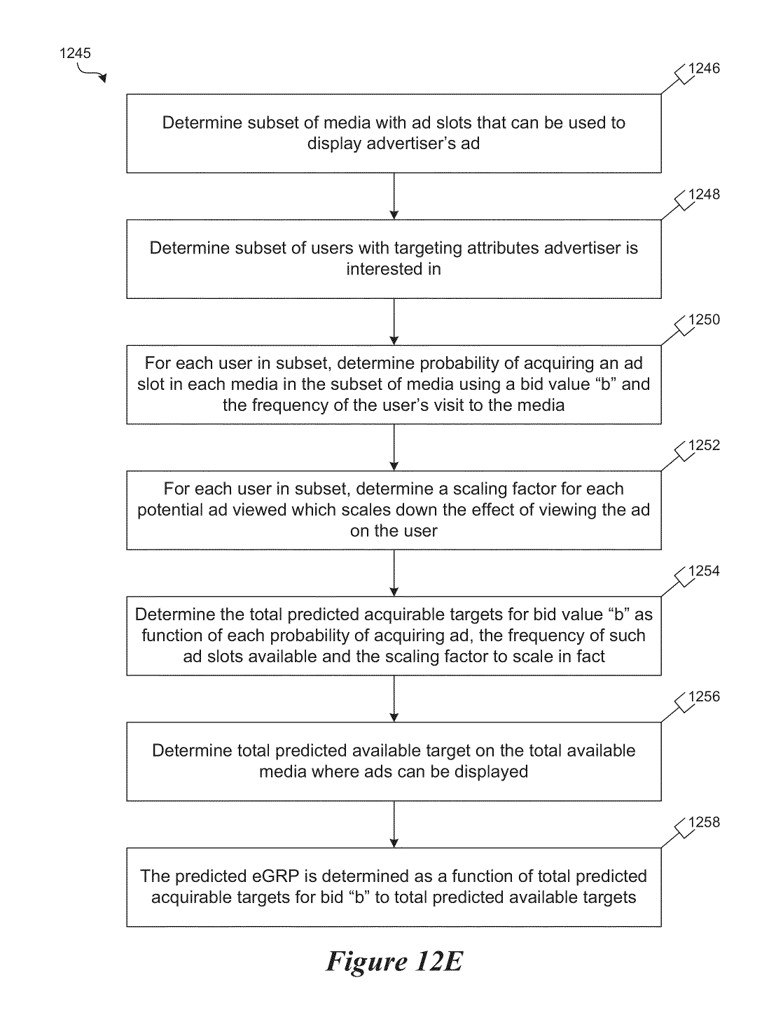

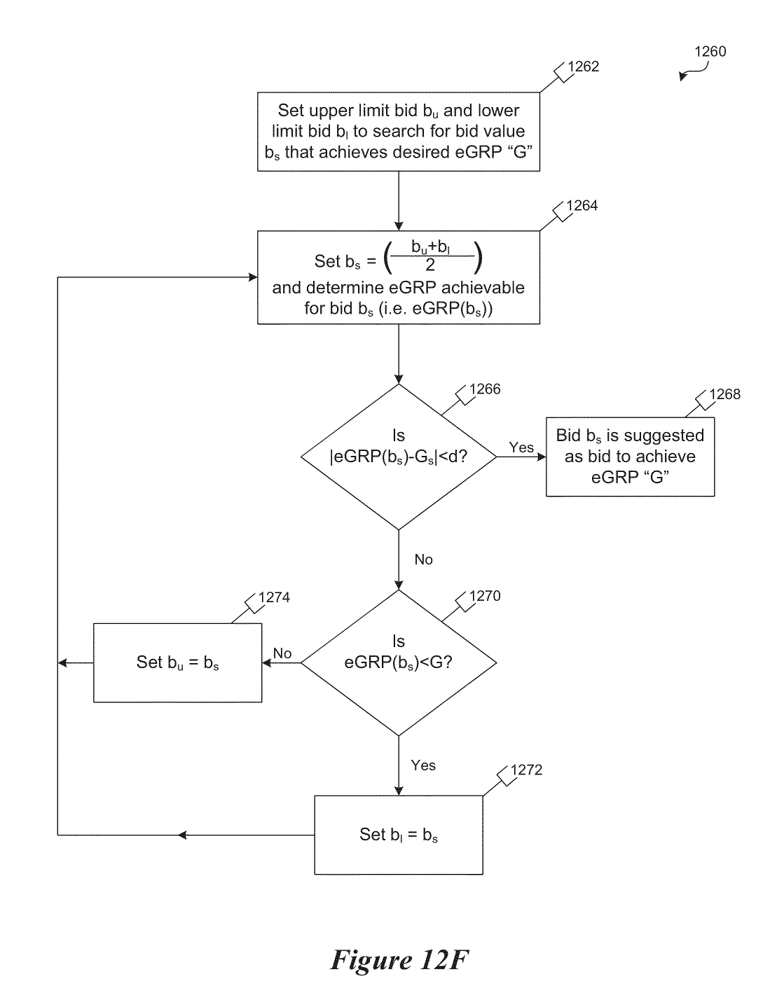

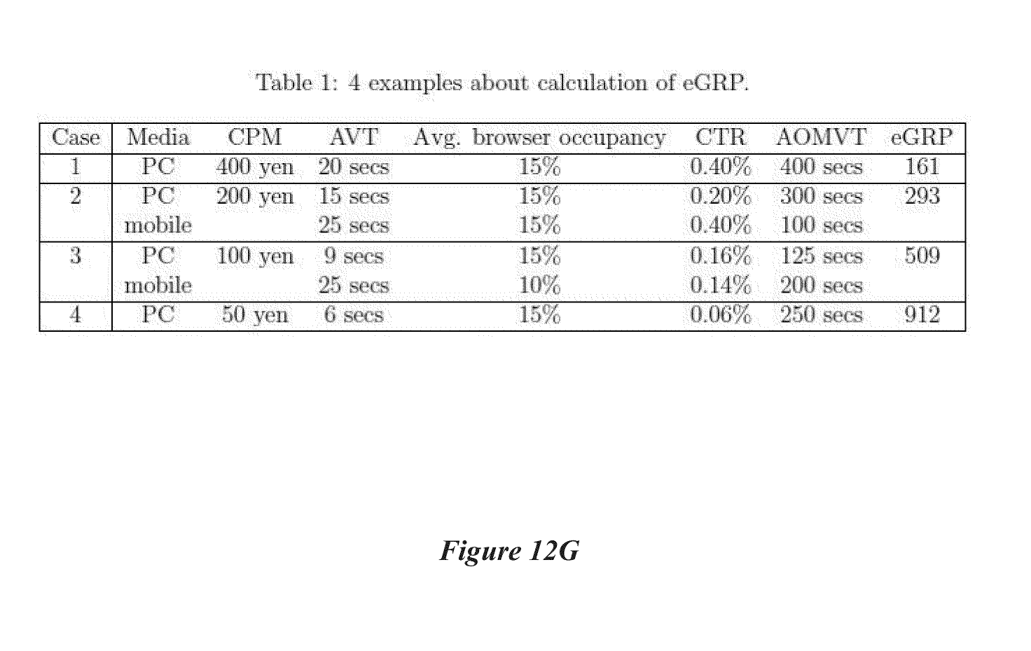

FIG. 12A provides a comparison 1200 between GRP of TV ad campaign and the eGRP of an online ad campaign. The top graph 1202 illustrates the GRP achieved from the TV ad campaign for a given market, and the bottom graph 1204 illustrates the eGRP achieved from the online ad campaign. The horizontal axis in each graph corresponds to the number of available unique targets (i.e. number of people available in the given market you can be reached by an ad campaign) and the vertical axis represents the effective number of times each person in the available targets are exposed to an ad from the ad campaign. Here, the white boxes denote the contribution that one ad delivery makes to increase of frequency of exposure to the ad. One exposure of a viewer to a TV advertisement increases the frequency of exposure by one, but one exposure to an online advertisement increases it by 0.5 (in FIG. 12A). In graph 1204, the grey boxes indicate the contribution attributed to the length of a user's exposure to the ad to the achieved increase in frequency of exposure to ad. In graph 1204, the black boxes account for the time spent on a site owned by the advertiser. While GRP measures the frequency of exposure on a per household basis, but eGRP measures the reach on a per-person basis.

FIG. 12B provides a general overview of a system 1210 that can be used to estimate the eGRP achieved by an ad campaign. The system 1212 interacts with databases 1214 and 1216 to gather information related to the impressions utilized by the ad campaign to advertise the ad campaign's ads and the viewable time achieved by each displayed ad. As discussed above, the total measured viewable time achieved by the displayed ads and the total viewable time achievable by the ad campaign is used to determine the eGRP of the ad campaign.

FIG. 12C provides a general overview of a system 1220 that can be used to predict an eGRP that can be achieved for a given ad spend. Additional details of such a system and a method used to predict eGRP are provided in later discussions.

FIG. 12D provides an illustrative method 1235 that can be utilized to estimate eGRP achieved by an ad campaign. In step 1232 of the method 1235, a subset of media where the ads of the ad campaign were displayed is selected. In step 1234 of the method 1235, a subset of users who each viewed at least one ad from the ad campaign in the above identified subset of media is selected. This subset of users who were reached through the subset of media represents the total target for exposure to the ad campaign. The portion of this total target that were effectively exposed to the ad campaign (e.g., through the display of an ad associated with the ad campaign) represents the exposure actually achieved by the ad campaign. As discussed earlier, this achieved exposure as a percentage of the total available target is utilized to determine the achieved eGRP of the ad campaign.

In step 1236 of the method 1235, the viewable time measured for each ad viewed by each user (in the subset of users) within the subset of media is determined. For example, by accessing the logging server 908, the viewable time can be determined. In step 1238 of the method 1235, a scaling factor for each measured viewable time in step 1236 is determined. In one embodiment, the scaling factor for a measured viewable time is based on the relative size of the ad (for which the measured viewable time) to the size of the web browser window when displaying the ad to the user. The scaling factor estimates the probable effect of the ad on the user based on the area of displayed ad (relative to the web browser) which was utilized to expose the user to the ad campaign.

In step 1240 of the method 1235, based on the viewable time determined in step 1236 and the associated scaling factor determined in step 1238, the total achieved viewable time for the ad campaign is determined. In one embodiment, the sum of all the measured viewable time determined in step 1236, with each measured viewable time scaled by the associated scaling factor determined in step 1238, determines the total achieved viewable time for the ad campaign. In step 1242 of the method 1235, the overall potential achievable viewable time is determined as a function of total targets reachable in the ad campaign (i.e., the total number of times every user in the subset of users was exposed to an ad from the ad campaign) and the total duration of possible exposure achievable with each exposure of ad (i.e. the total length of ad displayed in the media, irrespective of whether the user viewed it or not) from the ad campaign to the total reachable targets. In step 1244 of the method 1235, the eGRP (a measure of the overall exposure achieved for the ad campaign) is measured as a function of the achieved viewable time and the potential viewable time achievable (i.e. total duration of possible exposure achievable). Equation (14) provides one example of eGRP calculation function.

Prediction OF eGRP

As discussed earlier, eGRP can be estimated for a given bid value b of an advertiser. In one embodiment, a bid “b” in the form of CPXs can be converted to achievable eGRP using the following function (15), (19):

$$eGRP = 100 \times \frac{{\sum }_{m ∈ M ( T )} {\sum }_{u ∈ {U}_{m} ( T )} w ( m , u ) W ( m , u , b ) {f}_{m} ( u ) \hat{r} ( m , u )}{R ( M ( T ) )} \qquad ( 19 )$$

where, W, f, \hat{r}ₑ are to be estimated (discussed in detail later). In addition, <u> is a subset of Uₘ which contains users of the same targeting attribute T.<Uₘ> is a partition of Uₘ by <u>, i.e., a collection of <u>. The function (19) can then be redefined as shown below in function (20):

$$eGRP = 100 \times \frac{{\sum }_{m ∈ M} {\sum }_{〈 u 〉 ∈ 〈 {U}_{m} ( T ) 〉} W ( m , 〈 u 〉 , b ) {f}_{m} ( 〈 u 〉 ) ( {\hat{v}}_{e} ( m , 〈 u 〉 ) + {P}_{r} \cdot {L}_{TV} )}{{R}_{TV} \cdot {L}_{TV}} \qquad ( 20 )$$

where, (\hat{v}ₑ(m, [symbol] u [symbol] ) is the estimated online viewable time for a user with attribute (m, <u>). In the method, W is calculated using the following process. In the process, divide M(T) into two disjoint parts: M(T)=M′∪Mₐ. Here Mₐ is the set of media which is owned by the advertiser (e.g., webpage associated with the advertiser), and M′ is the other media (e.g., an ad of the advertiser). For each medium m in M′, calculate Win the following way: Estimate the probability W(m, <u>, b) of acquiring an impression of a user with targeting attribute <u> by bidding b. Gather data for the k impressions (with targeting attribute <u>) which were generated from m. The gathered data include information such as (1) the highest bid value {bᵢ}_{I=1}^{k} for each impression k and the binary values {aᵢ}_{I=1}^{k} where aᵢ takes value 1 if the i-th impression was won with bid value bᵢ. In one instance, an RTB that conducts auction of impressions might be a source of such data. Then W can be estimated using function (21) shown below:

$$W ( m , 〈 u 〉 , b ) = \frac{{\sum }_{i = 1}^{k} {1}_{\{ b \geq {b}_{i} \}} \cdot {p ( {b}_{i} )}^{1 - {a}_{i}}}{k} \qquad ( 21 )$$

where, 0<=p(bᵢ)<=1 is some constant that is dependent on bᵢ and 1_{{b≧b}_{ᵢ}_{}} is a function which takes 1 if b>=bᵢ and 0 otherwise. Here, W was calculated for each targeting attribute separately, but averaged over <u>. Further, although it was assumed that databases specifying media and targeting attributes are searched, a similar method can be applied even if the searches are performed only campaign-wise.

For each media m in Mₐ, the product of elements Wand fₘ is estimated. The following discussion provides a method for calculating fₘ and \hat{v}ₑ(m, [symbol] u [symbol] ). The estimate is on the basis of vₑ measured for each user in the previous subsection. One technique for estimating fₘ(<u>) is the following: Let D be the length of some period, such as the duration of the campaign under consideration. Further let Uₘ be the set of users who visit site m during a period of length D, and vᵤ be the number of visits by user uε<u>. Then fₘ(<u>) can be estimated as:

fₘ( [symbol] u [symbol] )=min{f_{c}, f̅} (22)

where, f_{c} is the frequency cap for this ad and f̅ can be one of, but not limited to, the average Σ_{uε} [symbol] ᵤ [symbol] vᵤ/|Uₘ| of vᵤ or the median of vᵤ. Further, \hat{v}ₑ(m, [symbol] u [symbol] ) can be estimated as the weighted average of vₑ(m; u) over uε<u> as shown in function (23) below:

$${\hat{v}}_{e} ( m , 〈 u 〉 ) = {\sum }_{u ∈ 〈 v 〉} \frac{{v}_{u}}{V} {\sum }_{v ∈ {v}_{u}} {v}_{e} ( m , u , v ) \qquad ( 23 )$$

where, V=ΣΣ_{uε} [symbol] ᵤ [symbol] vᵤ is the total number of visits by users belonging to <u>. Further, vᵤ in defined in two meanings: the number of visits of user u or the set of visits of user u. Further, we can derive fₘ and \hat{v}ₑ as averaged with respect to <u>. Further, although it was assumed that databases specifying media and targeting attributes are searched, a similar method can be applied even if the searches are performed only campaign-wise.

Using the above estimated values, the product of Wand fₘ corresponding to each mₐ in Mₐ can be estimated using function (24):

$$P ( {m}_{a} , 〈 u 〉 , b ) = W ( {m}_{a} , 〈 u 〉 , b ) \cdot {f}_{{m}_{a}} ( 〈 u 〉 ) = {\sum }_{m ∈ {M}^{′}} {c}_{m} W ( m , 〈 u 〉 , b ) \cdot {f}_{m} ( 〈 u 〉 ) \qquad ( 24 )$$

where, cₘ is the click-through rate (CTR) of medium m. The sum is taken over m, where several ads on m are linked to mₐ (i.e. linked to owned media). If the average of each of W, fm and \hat{v}ₑ is taken with respect to <u>, the prediction formula can be defined as shown in function (25):

$$eGRP = 100 \times \frac{\begin{matrix}{\sum }_{m ∈ {M}^{′}} W ( m , b ) ( {v}_{m} + {P}_{r} \cdot {L}_{TV} \cdot {n}_{m} ) + \\ {\sum }_{m ∈ {M}_{a}} P ( m , b ) ( {\hat{v}}_{e} ( m ) + {P}_{r} \cdot {L}_{TV} )\end{matrix}}{{R}_{TV} \cdot {L}_{TV}} \qquad ( 25 )$$

where, vₘ is the predicted total online viewable time of medium m and nₘ is the expected number of impressions generated from medium m.

FIG. 12C provides a general overview of a system 1220 that can be used to predict an eGRP that can be achieved for a given ad spend. The server 1230 predicts the eGRP based on data available through databases 1226, 1228. The database 1226 is maintained by server 1224 that gathers measured viewable time for various ads served across various ad slots in various web pages. Utilizing the gathered data, the database 1226 can be utilized to determine viewable achievable by displaying ads to users of certain targeting attributes in various media with certain targeting attributes (desired by an ad campaign for example). Similarly, database 1228 is maintained by server 1222 that gathers data regarding various impressions (i.e. a given ad display for a given ad slot). Utilizing the gathered data, the database 1228 can be utilized to determine data regarding prior impression such as the bid value the impression was sold for, the attributes associated with the impression, etc. As discussed above, server 1230 can predict eGRP based on the gathered data from database 1226 and 1228.

FIG. 12E provides an illustrative method 1245 that can be utilized to predict possible eGRP that can achieved for an ad campaign based on a given bid amount. In the method 1245, the potential ad slots that can be purchased and utilized to deliver an ad from the ad campaign to one or more targets (i.e. users) is identified. Using the identified ad slots as the basis, then, similar to the method of estimating achieved eGRP in method 1235, a predicted achievable and a predicted achieved overall exposure is used to compute the predicted eGRP that can be achieved for a given bid amount “b”.

In step 1246 of the method 1245, a subset of media where ads of the ad campaign can be displayed are selected. The selection can be based on attributed associated with the media, such as content, nature, demographic appeal, etc., that are desired by the ad campaign. In step 1248 of the method 1245, a subset of users who each viewed at least any ad (associated with any campaign) in the above identified subset of media. In some embodiments, the subset of users can be further filtered to only include that subset of users who have one or more attributes of the viewers the ad campaign desires to reach.

In step 1250 of the method 1245, for each user in the subset of users, determine the probability of acquiring an ad slot in each media of the subset of media using a given bid value “b” (for displaying an ad from the ad campaign) and the frequency of the user's visit to each media of the subset of media. In one embodiment, the probability of acquiring an ad slot in a certain media for a given bid amount can be determined based on the prior selling prices of the ad slot.

In step 1252 of the method 1245, for each user in the subset of users, a scaling factor for each potential ad view that scaled down the effect of the viewed ad on the user (when computing the overall exposure) is determined. In step 1254 of the method 1245, the total predicted achievable target for bid value “b” is determined as a function of the probabilities of acquiring ad slots determined in step 1250, the frequency of ad slots available (based on frequency of user's visit as determined in step 1250), and the scaling factors determined in step 1252. In step 1256 of the method 1245, determine the total predicted available target on the identified available media, where the ads from the ad campaign could have been displayed. In step 1258 of the method 1245, the predicted eGRP (a measure of the predicted overall exposure achievable for the ad campaign for given bid amount “b”) is measured as a function of the total predicted acquirable targets and the total predicted available targets. Equation (15) provides one example of predicted eGRP calculation function.

Bidding in the form of cost per desired eGRP

As discussed earlier, advertisers can place bid for ads based on desired eGRP. The following discussion provides a method for determining a bid value “b” necessary to achievable a desired eGRP. As shown in function (19), eGRP is generally defined as:

$$eGRP = 100 \times \frac{{\sum }_{m ∈ M ( T )} {\sum }_{u ∈ {U}_{m} ( T )} w ( m , u ) W ( m , u , b ) {f}_{m} ( u ) \hat{r} ( m , u )}{R ( M ( T ) )} \qquad ( 26 )$$

In the above function 26, b is a bid value in the form of CPXs, where W is monotone-increasing function with respect to b (i.e., if we increase b, win rate W stays same or increases regardless of (m, u)). In embodiments, an appropriate eGRP for a given b can be determined by binary-searching eGRP(b) using the following method. In the method, determine a sufficiently large upper limit bᵤ of b. Let bₛ denote the present candidate bid value and let bₗ=0. Further, let G denote eGRP that the advertiser desires. In the method, calculate bₛ=(bₗ+bᵤ)/2 and eGRP(bₛ). If eGRP(bₛ)<G then we put bₗ:=bs. Otherwise we set bᵤ:=bₛ.

The above step of resetting the bounds are repeated until |eGRP(bₛ)−G|<d holds for predefined d (a tolerance value). The bid value bₛ arrived in the last iteration is the suggested bid value to achieve the desired eGRP, where the last iteration is the step at which the difference between desired and determined GRP is less than the tolerance d. Further, since R_{TV} and L_{TV} are constant in eGRP calculated with function 18, this suggested bid value “b” is the equivalent suggested bid value for achieving a desired online viewable time. Further, if the size of ad frames is not taken into consideration in the prediction of online viewable time, the suggested bid value “b” can be considered to be derived from the desired viewable time obtained from media including the owned media.

In another embodiment, the cost (in CPXs form) per desired eGRP can be derived as shown in function (27):

$$b = \frac{G \times 100}{L \times R} \times 10000 \qquad ( 27 )$$

where, G denote the desired cost per GRP, L the temporal length of the ad to be delivered, R the total reach of all the media conforming to the targeting attribute that the advertiser specified.

FIG. 12F provides a method 1260 that can be utilized to determine the cost for achieving a desired eGRP for an ad campaign. Further, using the method 1260, advertisers (and campaign managers) can bid in the form of desired eGRP, which can then be converted into cost that can be utilized to achieve the desired eGRP. In method 1260, a binary search of the eGRP prediction function (discussed above) is performed till a cost value at which the predicted eGRP value is close to the desired eGRP value is identified. The cost value is then equal to the cost needed to achieve the desired eGRP. In step 1262, an upper and lower limit bid amount (i.e. cost needed to achieve the desired eGRP) is determined and the search for the bid amount that is needed to achieve the desired eGRP is searched within this limit.

In step 1264, the average of the upper and lower limit is taken and the average bid value is used to determine the predicted eGRP achievable for the average bid value. In step 1266, if the desired eGRP and the predicted eGRP differ by less than tolerance value “d”, then, in step 1268, the average bid value is equal to the cost needed to achieve the desired eGRP. If not, in step 1270, determine if predicted eGRP is over achieving (i.e., exceeds desired eGRP) for the average bid value. If it is, then, in step 1274, set the upper limit bid amount to the average bid value and repeat step 1264. If not, then, in step 1272, set the lower limit bid amount to the average bid value and repeat step 1264.

FIG. 12G provides examples of computed eGRP based on various parameters described above. Table 1 shows the considered case and the resultant eGRP, where AVT is short for average viewable time and AOMVT is for average owned media viewable time. Here, the number of TV viewers defines the reach of TV, where the reach of TV is estimated by (the number of viewing households)×(viewers per viewing household). In the following, the number of viewing households is set to 15 million (the number of households in Kanto region), and viewers per viewing household is set to 2.5. Thus the estimated number of TV viewers is 37.5 million. The ad length of the TV ad is set to 15 seconds and cost per GRP of TV advertising is set to 0.1 million yen. Thus the advertiser acquires 1000 GRP in TV advertising (for a 100 million yen budget). The budget of online advertising is 30 million yen. The purchased impressions are equally distributed to each medium. Let Pr be set to 0.5. Here, Pᵣ is not added when a user visits a site owned by the advertiser by click-through and only add Pᵣ only when an ad is delivered to a user.

### Example for CPV Model

In the following discussion, a brief analysis of CPV pricing. In this example, lets assume the following conditions for discussion purposes: (1) if less than one second of viewable time is achieved in one ad serving, zero seconds of viewable time is recorded. p₀ denotes the probability that an impression with less than one second of viewable time is generated.

If k seconds of viewable time (say, k−0.5 to k+0.5 seconds) is obtained, then k seconds of viewable time has been acquired. pₖ denotes the probability that an impression with about k seconds of viewable time is generated. In addition, its assumed that each page has only one ad slot and that a user moves among the pages. Further, its assumed that ad follow can be conducted every time the user moves to another page.

Under these conditions, the actual values for pₖ is determined using function (31) shown below:

$${p}_{0} = 0.11 , \\ {p}_{k} = ( 1 - {p}_{0} ) \cdot \frac{{r}^{k - 1}}{{\sum }_{m = 1}^{60} {r}^{m - 1}} ( k = 1 , … , 60 , r = 0.885 ) \\ {p}_{l} = 0 ( l \geq 61 ) . \qquad ( 31 )$$

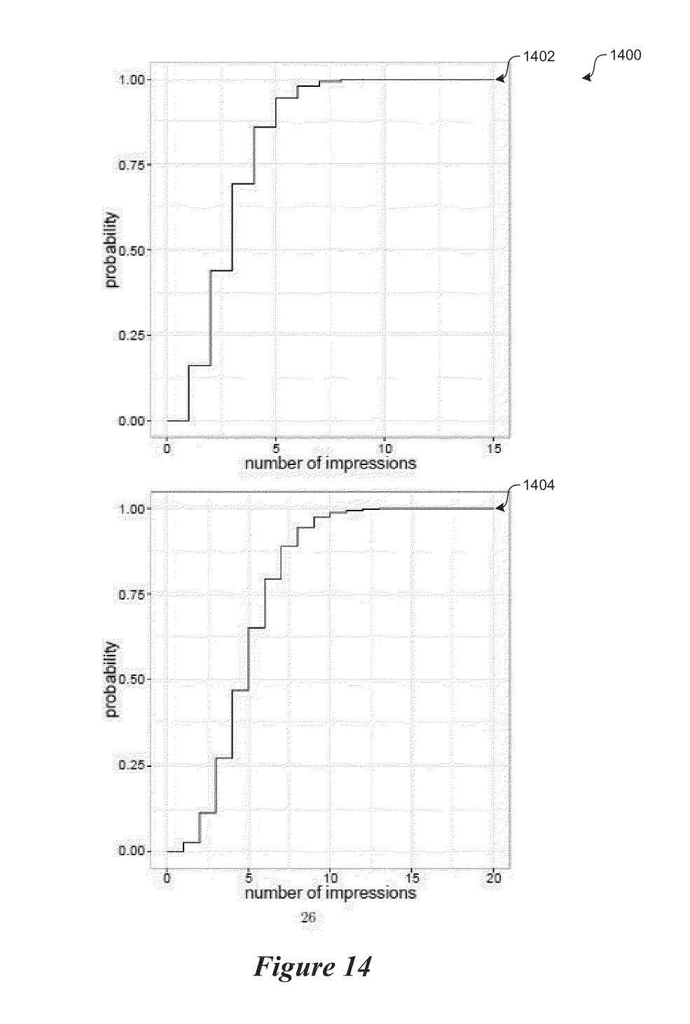

In FIG. 14, the probability of obtaining the number of impressions necessary 1400 to obtain more than “T” seconds of viewable time is shown. The distribution is plotted for T=15 (1402) and 20 (1404). When T=15, the mean of the distribution is 2.93, and when T=30, it is 4.88. In reality, there are cases where ad follow cannot be conducted. Based on the distribution 1400, CPV is more than three times as high as plain CPM when T=15, and the CPV realization is more than 5 times higher.

### Effectiveness Metrics For Online Content

The following Table 2 provides definitions and general overview of the various effectiveness metrics measured for online content to determine the exposure (with respect to the online users) achieved by online content.

TABLE 2
Table of effectiveness metrics for online contents

| Category | Metric | Explanation | Formula |
|---|---|---|---|
| SERVED | Impressions | the number of ad | |
| | | delivery | |
| | GRP | product of the | |
| | | number of times | |
| | | the content is | |
| | | viewed and the | |
| | | content's reach | |
| VIEWABLE | Viewable | the number of | |
| | Impressions | impressions | |
| | | which became | |
| | | visible (e.g., 50% | |
| | | of the area of the | |
| | | impression is | |
| | | shown for more | |
| | | than 1 second) | |
| | Viewable Rate | ratio of viewable | (Viewable |
| | | impressions to all | Impressions) ÷ |
| | | impressions | (Impressions) |
| | Total Viewable | the number of | |
| | Time | seconds in which | |
| | | the content was | |
| | | viewable | |
| | Average | average viewable | (Total Viewable |
| | Viewable Time | time of one | Time) ÷ (Viewable |
| | | viewable | Impressions) |
| | | impression | |
| COMPLETION | View | the number of the | |
| | Completions | content delivery | |
| | | completion | |
| | View | ratio of view | (View Completions) ÷ |
| | Completions | completions to | (Viewable |
| | Rate | viewable | Impressions) |
| | | impressions | |
| DWELL | Mouse | the number of | |
| | Rollovers | mouseovers on | |
| | | the content | |
| | Mouse | ratio of mouse | (Mouse Rollovers) ÷ |
| | Rollover | rollovers to | (Viewable |
| | Rate | viewable | Impressions) |
| | | impressions | |
| | Sound-Ons | the number of | |
| | | times the sound | |
| | | was turned on | |
| | Sound-On Rate | ratio of the | (Sound-Ons) ÷ |
| | | number of sound- | (Viewable |
| | | ons to viewable | Impressions) |
| | | impression | |
| | Total Dwell | the total time of | |
| | Time | duration of | |
| | | mouseover or | |
| | | sound-on | |
| | Average Dwell | average dwell | (Total Dwell Time) ÷ |
| | Time | time per viewable | (Viewable |
| | | impression | Impressions) |
| ACTION | Clicks | the number of | |
| | | clicks | |
| | CTR | click through rate | (Clicks) ÷ |
| | | | (Impressions) |
| | vCTR | CTR for viewable | (Clicks) ÷ (Viewable |
| | | impressions | Impressions) |
| | Facebook Likes | the number of | |
| | | times the | |
| | | Facebook Like | |
| | | button was | |
| | | clicked | |
| | Facebook Like | ratio of Facebook | (Facebook Likes) ÷ |
| | Rate | Likes to viewable | (Viewable |
| | | impressions | Impressions) |
| | Conversions | the number of | |
| | | conversions | |
| | Conversion | ratio of | (Conversions) ÷ |
| | Rate | conversions to | (Clicks) |
| | | the number of | |
| | | times users came | |
| | | to the landing | |
| | | page of the | |
| | | content by | |
| | | clicking it | |
| | Rewind | the number of | |
| | | times users | |
| | | rewind the video | |
| | | content | |
| COST | Average CPM | Average CPM | |
| | Total Cost | total cost | (Average CPM) • |
| | | | •Impressions ÷ 1,000 |
| | Average Cost | cost required to | (Total Cost) ÷ (Dwell) |
| | per Dwell | obtain one Dwell | |
| | Average Cost | cost required to | (Total Cost) ÷ |
| | per Click | obtain one click | (Clicks) |
| | Average Cost | cost required to | (Total Cost) ÷ (Likes) |
| | per Like | obtain one Like | |
| | Average Cost | average cost of | (Total Cost) ÷ (Total |
| | per Second | one viewable | Viewable Time) |
| | | second | |
| | Average Cost | average cost per | (Average Cost per |
| | per 10,000 | 10000 viewable | Second) × 10,000 |
| | seconds | seconds | |

### Architecture of Platform Server

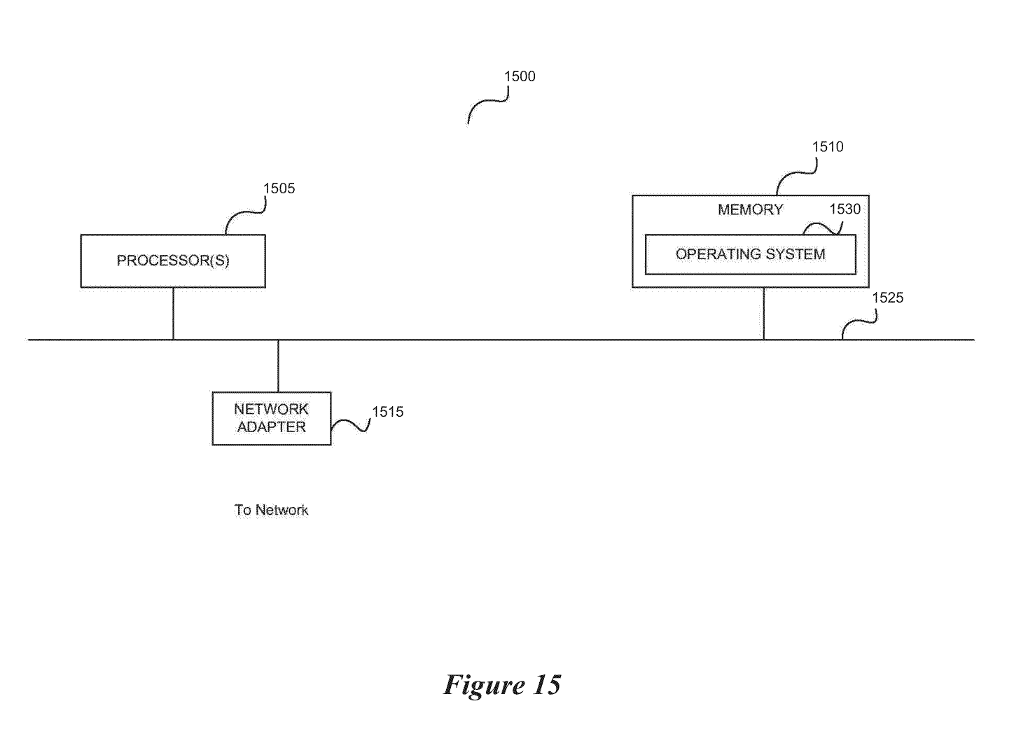

FIG. 15 is a high-level block diagram showing an example of the architecture for a computer system 1500 that can be utilized to implement, for example, a platform server (e.g., 114 from FIG. 1), a web server (e.g., 125 from FIG. 1), or any other computing device identified in the above disclosure. The computer system 1500 includes one or more processors 1505 and memory 1510 connected via an interconnect 1525. The interconnect 1525 is an abstraction that represents any one or more separate physical buses, point to point connections, or both connected by appropriate bridges, adapters, or controllers. The interconnect 1525, therefore, may include, for example, a system bus, a Peripheral Component Interconnect (PCI) bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 694 bus, sometimes referred to as “Firewire.”

The processor(s) 1505 may include central processing units (CPUs) to control the overall operation of, for example, the host computer. In certain embodiments, the processor(s) 1505 accomplish this by executing software or firmware stored in memory 1510. The processor(s) 1505 may be, or may include, one or more programmable general-purpose or special-purpose microprocessors, digital signal processors, programmable controllers, application specific integrated circuits (ASICs), programmable logic devices (PLDs), or the like, or a combination of such devices.

The memory 1510 is or includes the main memory of the computer system 1500. The memory 1510 represents any form of random access memory (RAM), read-only memory (ROM), flash memory (as discussed above), or the like, or a combination of such devices. In use, the memory 1510 may contain, among other things, a set of machine instructions which, when executed by processor 1505, causes the processor 1505 to perform operations to implement embodiments of the present invention.

Also connected to the processor(s) 1505 through the interconnect 1525 is a network adapter 1515. The network adapter 1515 provides the computer system 1500 with the ability to communicate with remote devices, such as the storage clients, and/or other storage servers, and may be, for example, an Ethernet adapter or Fiber Channel adapter.

Unless the context clearly requires otherwise, throughout the description and the claims, the words “comprise,” “comprising,” and the like are to be construed in an inclusive sense (i.e., to say, in the sense of “including, but not limited to”), as opposed to an exclusive or exhaustive sense. As used herein, the terms “connected,” “coupled,” or any variant thereof means any connection or coupling, either direct or indirect, between two or more elements. Such a coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above Detailed Description of examples of the invention is not intended to be exhaustive or to limit the invention to the precise form disclosed above. While specific examples for the invention are described above for illustrative purposes, various equivalent modifications are possible within the scope of the invention, as those skilled in the relevant art will recognize. While processes or blocks are presented in a given order in this application, alternative implementations may perform routines having steps performed in a different order, or employ systems having blocks in a different order. Some processes or blocks may be deleted, moved, added, subdivided, combined, and/or modified to provide alternative or sub-combinations. Also, while processes or blocks are at times shown as being performed in series, these processes or blocks may instead be performed or implemented in parallel, or may be performed at different times. Further any specific numbers noted herein are only examples. It is understood that alternative implementations may employ differing values or ranges.

The various illustrations and teachings provided herein can also be applied to systems other than the system described above. The elements and acts of the various examples described above can be combined to provide further implementations of the invention.

Any patents and applications and other references noted above, including any that may be listed in accompanying filing papers, are incorporated herein by reference. Aspects of the invention can be modified, if necessary, to employ the systems, functions, and concepts included in such references to provide further implementations of the invention.

These and other changes can be made to the invention in light of the above Detailed Description. While the above description describes certain examples of the invention, and describes the best mode contemplated, no matter how detailed the above appears in text, the invention can be practiced in many ways. Details of the system may vary considerably in its specific implementation, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

While certain aspects of the invention are presented below in certain claim forms, the applicant contemplates the various aspects of the invention in any number of claim forms. For example, while only one aspect of the invention is recited as a means-plus-function claim under 35 U.S.C. §112, sixth paragraph, other aspects may likewise be embodied as a means-plus-function claim, or in other forms, such as being embodied in a computer-readable medium. (Any claims intended to be treated under 35 U.S.C. §112, ¶ 6 will begin with the words “means for.”) Accordingly, the applicant reserves the right to add additional claims after filing the application to pursue such additional claim forms for other aspects of the invention.

What is claimed is:

1. A method, comprising:
receiving, by a platform server having a processor, an advertisement to be displayed in an advertising section of a publisher's webpage, wherein the advertisement is intended to be displayed for a predefined duration of time within the advertising section;
transmitting, by the platform server, the advertisement for display within the advertising section of the publisher's webpage;
measuring, by the platform server, a total attention duration of a user to the advertisement displayed in the advertising section of the publisher's webpage, the total attention duration of the user measured as a function of a duration of time the attention of the user was focused on the displayed advertisement, wherein the total attention duration of the user to the displayed advertisement is less than or equal to the predefined display duration of the advertisement; and
determining, by the platform server, a cost incurred for displaying the advertisement as a function of the total attention duration of the user to the displayed advertisement.

2. The method of claim 1, wherein the cost incurred for displaying the advertisement is based on a cost-per-view (CPV) billing model, the CPV billing model determining the cost for displaying the advertisement as a function of both the total attention duration of the user to the displayed advertisement and a predefined minimum duration of display time, wherein the cost incurred for displaying the advertisement is zero when the measured total attention duration of the user is less than the predefined minimum duration of display time.

3. The method of claim 1, wherein the cost incurred for displaying the advertisement is based on a cost-per-second (CPS) billing model, the cost-per-second (CPS) billing model determining the cost for displaying the advertisement as a function of the total attention duration of the user to the displayed advertisement.

4. The method of claim 1, wherein the platform server determines the attention of the user to the displayed advertisement based on one or more criteria, the one or more criteria including:
a proportion of the displayed advertisement visible to the user through the web browser, wherein the attention of the user is focused on the displayed advertisement when the visible proportion of the displayed advertisement is greater than a minimum predefined threshold;
a proportion of the given web browser, displaying the advertisement to the user, visible to the user; or
an interaction of the user with the given web browser, the interaction occurring at least once within each of an one or more predetermined time period.

5. The method of claim 4, wherein the cost incurred for displaying the advertisement is further computed as a function of a given user interaction with a given portion of the displayed advertisement, the cost computed as an effective CPS (eCPS) value, the eCPS value being a function of a predetermined value associated with the given user interaction.

6. The method of claim 5, wherein the given user interaction includes one or more of:
a mouse roll-over over the advertisement;
a user click of the advertisement;
a user input of a like of the advertisement;
a rewinding of the advertisement;
a pausing of the advertisement;
a playing of the advertisement;
a muting of an audio content with the advertisement; or
an un-muting of the audio content with the advertisement.

7. The method of claim 5, wherein the predetermined value associated with the given user interaction is computed as a function of both a preference score associated with the given user interaction and a probability of occurrence of the given user interaction when displaying the given portion of the advertisement.

8. The method of claim 7, wherein the preference score associated with the given user interaction is computed as a function of a desirability of the given user interaction to a given advertiser when displaying the given portion of the advertisement, the given advertiser being associated with a given advertisement displayed to the given user.

9. The method of claim 7, wherein the probability of occurrence of the given user interaction when displaying the given portion of the advertisement is computed based on the nature of content included in the given portion of the advertisement.

10. The method of claim 9, wherein the probability of occurrence of the given user interaction when displaying the given portion of the advertisement is further computed based on the number of occurrences of the given user interaction when displaying the given portion of the advertisement.

11. A method, comprising:
transmitting, by a platform server having a processor, an advertisement to be displayed to a user, wherein the advertisement is displayed in an advertising section of a publisher's webpage, wherein the webpage of the publisher is being viewed by the user; and
receiving, by the platform server, a cost incurred for displaying the advertisement to the user, the received cost computed as a function of a total attention duration of the user to the displayed advertisement, the total attention duration measured as a function of a duration of time the attention of the user was focused on the displayed advertisement.

12. The method of claim 11, wherein the cost incurred for displaying the advertisement is based on a cost-per-view (CPV) billing model, the CPV billing model determining the cost for displaying the advertisement as a function of both the total attention duration of the user to the displayed advertisement and a predefined minimum duration of display time, wherein the cost incurred for displaying the advertisement is zero when the measured total attention duration of the user is less than the predefined minimum duration of display time.

13. The method of claim 11, wherein the cost incurred for displaying the advertisement is based on a cost-per-second (CPS) billing model, the cost-per-second (CPS) billing model determining the cost for displaying the advertisement as a function of the total attention duration of the user to the displayed advertisement.

14. The method of claim 11, wherein the attention of the user to the displayed advertisement is determined based on one or more criteria, the one or more criteria including:
a proportion of the displayed advertisement visible to the user through the web browser, wherein the attention of the user is focused on the displayed advertisement when the visible proportion of the displayed advertisement is greater than a minimum predefined threshold;
a proportion of the given web browser, displaying the advertisement to the user, visible to the user; or
an interaction of the user with the given web browser, the interaction occurring at least once within each of a one or more predetermined time period.

15. The method of claim 13, wherein the cost incurred for displaying the advertisement is further computed as a function of a given user interaction with a given portion of the displayed advertisement, the cost computed as an effective CPS (eCPS) value, the eCPS value being a function of a predetermined value associated with the given user interaction.

16. The method of claim 15, wherein the given user interaction includes one or more of:
a mouse roll-over over the advertisement;
a user click of the advertisement;
a user input of a like of the advertisement;
a rewinding of the advertisement;
a pausing of the advertisement;
a playing of the advertisement;
a muting of an audio content with the advertisement; or
an un-muting of the audio content with the advertisement.

17. The method of claim 15, wherein the predetermined value associated with the given user interaction is computed as a function of both a preference score associated with the given user interaction and a probability of occurrence of the given user interaction when displaying the given portion of the advertisement.

18. The method of claim 17, wherein the preference score associated with the given user interaction is computed as a function of a desirability of the given user interaction to a given advertiser when displaying the given portion of the advertisement, the given advertiser being associated with a given advertisement displayed to the given user.

19. The method of claim 17, wherein the probability of occurrence of the given user interaction when displaying the given portion of the advertisement is computed based on the nature of content included in the given portion of the advertisement.

20. The method of claim 19, wherein the probability of occurrence of the given user interaction when displaying the given portion of the advertisement is further computed based on the number of occurrences of the given user interaction when displaying the given portion of the advertisement.

21. A system, comprising:
at least one memory storing computer-executable instructions; and
at least one processor configured to access the at least one memory and execute the computer-executable instructions to perform a set of acts, the acts including:
receiving an advertisement to be displayed in an advertising section of a publisher's webpage, wherein the advertisement is intended to be displayed for a predefined duration of time within the advertising section;
transmitting the advertisement for display within the advertising section of the publisher's webpage;
measuring a total attention duration of a user to the advertisement displayed in the advertising section of the publisher's webpage, the total attention duration measured as a function of a duration of time the attention of the user was focused on the displayed advertisement, wherein the total attention duration of the user to the displayed advertisement is less than or equal to the predefined display duration of the advertisement; and
determining a cost incurred for displaying the advertisement as a function of the total attention duration of the user to the displayed advertisement.

22. The system of claim 21, wherein the cost incurred for displaying the advertisement is based on a cost-per-view (CPV) billing model, the CPV billing model determining the cost for displaying the advertisement as a function of both the total attention duration of the user to the displayed advertisement and a predefined minimum duration of display time, wherein the cost incurred for displaying the advertisement is zero when the measured total attention duration of the user is less than the predefined minimum duration of display time.

23. The system of claim 21, wherein the cost incurred for displaying the advertisement is based on a cost-per-second (CPS) billing model, the cost-per-second (CPS) billing model determining the cost for displaying the advertisement as a function of the total attention duration of the user to the displayed advertisement.

24. The system of claim 21, wherein the attention of the user to the displayed advertisement is measured based on one or more criteria, the one or more criteria including:
a proportion of the displayed advertisement visible to the user through the web browser, wherein the attention of the user is focused on the displayed advertisement when the visible proportion of the displayed advertisement is greater than a minimum predefined threshold;
a proportion of the given web browser, displaying the advertisement to the user, visible to the user; or
an interaction of the user with the given web browser, the interaction occurring at least once within each of a one or more predetermined time period.

25. The system of claim 24, wherein the cost incurred for displaying the advertisement is further computed as a function of a given user interaction with a given portion of the displayed advertisement, the cost computed as an effective CPS (eCPS) value, the eCPS value being a function of a predetermined value associated with the given user interaction.

26. The system of claim 25, wherein the given user interaction includes one or more of:
a mouse roll-over over the advertisement;
a user click of the advertisement;
a user input of a like of the advertisement;
a rewinding of the advertisement;
a pausing of the advertisement;
a playing of the advertisement;
a muting of an audio content with the advertisement; or
an un-muting of the audio content with the advertisement.

27. The system of claim 5, wherein the predetermined value associated with the given user interaction is computed as a function of both a preference score associated with the given user interaction and a probability of occurrence of the given user interaction when displaying the given portion of the advertisement.

28. The system of claim 27, wherein the preference score associated with the given user interaction is computed as a function of a desirability of the given user interaction to a given advertiser when displaying the given portion of the advertisement, the given advertiser being associated with a given advertisement displayed to the given user.

29. The system of claim 27, wherein the probability of occurrence of the given user interaction when displaying the given portion of the advertisement is computed based on the nature of content included in the given portion of the advertisement.

30. The system of claim 29, wherein the probability of occurrence of the given user interaction when displaying the given portion of the advertisement is further computed based on the number of occurrences of the given user interaction when displaying the given portion of the advertisement.

31. A method, comprising:
detecting, by a platform server having a processor, a first request from a user to view a first webpage associated with an advertisement, the first webpage further being associated with an advertiser of the advertisement, the advertisement being displayed within a portion of a second webpage, wherein the first user request for the first webpage is provided through an action of the user within a portion of the displayed advertisement;
measuring, by the platform server, a first total attention duration of the user to the first webpage displayed through a web browser, the first total attention duration of the user measured as a function of a duration of time the attention of the user was focused on the displayed first webpage, wherein the user utilizes the web browser to view the displayed first webpage;
determining, by the platform server, a cost for displaying the advertisement as a function of the first measured total attention duration of the user to the displayed first webpage.

32. The method of claim 31, wherein the platform server determines the attention of the user to the displayed first webpage based on one or more criteria, the one or more criteria including:
a proportion of content of a given webpage displayed through a given web browser, wherein the attention of the user is focused on the given webpage when the displayed proportion of content of the given webpage is greater than a minimum predefined threshold;
a proportion of the given web browser, displaying content of the given webpage to the user, visible to the user; or
an interaction of the user with the given web browser, the interaction occurring at least once within each of a one or more predetermined time period.

33. The method of claim 32, wherein the platform server measures a duration of time the one or more criteria for determining the attention of the user to the displayed first webpage is satisfied, the measured duration of time being the first total attention duration of the user to the displayed first webpage.

34. The method of claim 33, wherein the platform server pauses measurement of the duration of time when none of the one or more criteria for determining the attention of the user to the displayed first webpage is satisfied.

35. The method of claim 34, wherein the platform server resumes measurement of the duration of time when one or more criteria for determining the attention of the user to the displayed first webpage is satisfied.

36. The method of claim 33, wherein the cost for displaying the advertisement is based on a cost-per-second (CPS) billing model, the cost-per-second (CPS) billing model determining the cost for displaying the advertisement as a function of the first measured total attention duration of the user to the displayed first webpage.

37. The method of claim 32, wherein the interaction of the user includes one or more of:
a mouse roll-over over the given webpage displayed by the given web browser;
a user click of an advertisement within the given webpage;
a rewinding of the advertisement;
a pausing of the advertisement;
a playing of the advertisement; or
a entering of information into one or more forms provided within the given webpage.

38. The method of claim 31, further comprising:
detecting, by the platform server, a second request from the user to view a third webpage associated with the advertiser, wherein the second user request for the third webpage is provided through an action of the user within a portion of the first webpage;
measuring, by the platform server, a second total attention duration of the user to the third webpage displayed through the web browser, the second total attention duration of the user measured as a function of a duration of time the attention of the user was focused on the displayed second webpage; and
determining, by the platform server, the cost for displaying the advertisement further as a function of the second measured total attention duration of the user to the displayed second webpage.

39. The method of claim 38, wherein the cost for displaying the advertisement is based on a cost-per-second (CPS) billing model, the cost-per-second (CPS) billing model determining the cost for displaying the advertisement as a function of both the first measured total attention duration of the user and second measured total attention duration of the user.
